(19) United States
(12) Patent Application Publication
(10) Pub. No.: US 2009/0076841 A1
(43) Pub. Date: Mar. 19, 2009

(54) RULES-BASED SOFTWARE AND METHODS FOR HEALTH CARE MEASUREMENT APPLICATIONS AND USES THEREOF

(76) Inventors: Geoffrey B. Baker, San Francisco, CA (US); Amanda Prail, Livermore, CA (US); Joel Garcia, San Francisco, CA (US); Cindy Truong, San Francisco, CA (US); Chris Hanson, San Rafael, CA (US); Renxian Scott Lin, Pacifica, CA (US)

Correspondence Address: BUCHALTER NEMER, 18400 VON KARMAN AVE., SUITE 800, IRVINE, CA, 92612, US

(21) Appl. No.: 11/952,656

(22) Filed: Dec. 7, 2007

Related U.S. Application Data
(60) Provisional application No. 60/873,628, filed on Dec. 7, 2006.

(51) Int. Cl. G06Q 50/00

(52) U.S. Cl. 705/2

(57) ABSTRACT

A rules based software user interface application and environment, comprising: a) a clinical quality measure library database schema, b) a clinical quality measure specification database schema, c) a rules library, d) a clinical business rule (CBR) editor, e) a key performance indicator (KPI) or clinical quality measure specification editor, f) a clinical quality runtime configuration module, g) a cost of care runtime configuration module and h) a runtime manager module and, in some embodiments, i) a measure testing module. In some embodiments, rules-based software applications comprise a component for delivery of clinical measure description libraries as a web or Internet application. In other embodiments, rules-based software applications comprise a component for measure testing which include a test data generator module which generates a test database with a known target measure result and an audit detail component for inspecting test results. In yet other embodiments, rules-based software applications comprise both a component for delivery of clinical measure description libraries as a web or Internet application and a measure testing component to support the development of measures. Methods of converting health-based input source data into measures of clinical quality or cost of care comprise: a) providing a source code application, b) providing a collection of source data that comprises health-related source data, and c) transforming the source data into at least one evidence-based care measure using the source code application. In some embodiments, contemplated care measures comprise quality of care measures, care of cost measures or combinations thereof.

This application is based on U.S. Provisional Application Ser. No. 60/873,628 filed on Dec. 7, 2006, which is commonly-owned and incorporated by reference in its entirety.

### FIELD OF THE SUBJECT MATTER

The field of the subject matter is rules-based software applications and methods for transforming claims, administrative information, chart and survey results and other health care source data into evidence-based quality of care and cost of care measures. The field of the subject matter also includes other interactive and executable software applications related to the primary software applications.

### BACKGROUND

Health plans generally have strategic initiatives requiring measures of patient quality of care and cost of care. For example, these measures are used to: a) support physician pay for performance measurements, public reporting, disease management and initiatives, b) identify gaps in care and support for quality improvement, c) identify opportunities for improvements in efficiency, and d) enable transparency of provider performance for consumer selection.

As payers, health plans have large volumes of administrative and clinical source data available for analysis including, for example: a) member enrollment data, b) provider directory and participation data, c) claims data from providers requesting payment for clinical services provided to patients, d) lab results and other electronic patient health record data collected from providers and e) transformed claims data results such as episodes of care or patient health risk scores

The practical aspects of using this data in the design and implementation of the strategic initiatives is a difficult task Analyzing administrative claims or other clinical source data to create clinical quality or cost of care measures typically involves complex programming that is error prone, requires development and testing time and is difficult to maintain. Solutions developed “in-house” may allow for customization, but they can also be costly, take a long time to develop and are difficult to maintain given frequent coding updates and changing standards of medical care.

The current alternative to an in-house concept and design is to utilize an “off-the-shelf” commercial software product such as Ingenix's EBMConnect or IHCIS Impact Analysis. Existing commercial solutions eliminate the need to design and develop a package in-house, but do have the disadvantage of containing non-editable “black box” type of measures, which means that the user must wait for the vendors to develop new measures or update the measures. The user can only get the measures as designed by the vendor and cannot engage with their provider network to design, refine or communicate measures appropriate to their needs. Thus, there is a significant gap between market need and current commercial vendor and health plan in-house capability.

Given this gap, there is a compelling market need for an executable and interactive software application that: a) is rules-based in order to facilitate rapid creation and customization of clinical quality measures without the need for programming, b) easily transforms source data into evidence-based quality of care measures and cost of care measures, c) can be rapidly deployed by a health plan provider or other health care establishment/entity, d) has regular maintenance and easy update advantages of commercial software applications, and e) can publish measure descriptions and measures results for provider collaboration, comment and education. Further, it would be ideal to support the engagement of the health plan's network of physicians (herein referred to as “providers”) in the review, selection and customization of measures in order to increase acceptance and adherence.

### BRIEF DESCRIPTION OF THE FIGURES

FIG. 1 shows a contemplated software application as described herein that provides the listed functionality and components.

FIG. 2A shows an embodiment of a contemplated measure within the web application.

FIG. 2B shows an embodiment of a contemplated measure within the web application.

FIG. 3 shows a contemplated software interface or webview 300 that a user (not shown) would view when starting the software applications and methods described herein.

In one embodiment, one clicks on the folder for CBRs 330 to see a list of specialties, then click on the specialty to see a list of measures, and right click on the measure and choose CBR to get the measure description in the workspace area 400, as shown in FIG. 4.

FIG. 5 shows a contemplated workspace area 500 for viewing and editing a measure description in the measure library.

FIG. 6 shows a screenshot 600 comprising a contemplated workspace area 620 when the user has clicked on the “Cardiology” KPI set 602 and then on KPI measure 605 with reference number CV-1 and selected the Denominator tab 607 for viewing or editing.

FIG. 7 shows a screenshot 700 comprising a contemplated workspace area 720 when the user has clicked on the “Cardiology” KPI set 702 and then on KPI measure 705 with reference number CV-1 and selected the Numerator tab from FIG. 6 (not shown in FIG. 7) for viewing or editing.

FIG. 8 a screenshot 800 comprising a contemplated workspace area 820 when the user has clicked on the “Cardiology” KPI set 802 and then on KPI measure 805 with reference number CV-1 and selected the Provider Attribution tab from FIG. 6 (not shown in FIG. 8) for viewing or editing.

FIGS. 9-11 show samples of screen shots (900, 1000 and 1100 respectively) displaying contemplated reports (910, 1010 and 1110, respectively) that can be generated for the KPIs and measures.

FIGS. 12-13 show a screen shot (1200 and 1300, respectively) where the user (not shown) is working in the “Audit KPI” tab (1240 and 1340, respectively) of contemplated software applications, environments and methods.

The “Audit Detail Dialog” 1400 shown in FIG. 14 allows the user (not shown) to select different types of audit presentations.

FIG. 15 shows a screen shot 1500 of a denominator specification for a new KPI (not shown) and illustrates the specification panel for the denominator 1510 and shows the empty denominator global set 1520 awaiting definition.

To begin the specification process a ‘global set’ is opened by double clicking on the set 1530, which as shown by the screen shot 1600 in FIG. 16, which shows an example set definition dialog, brings up a set definition dialog 1630 and specification can begin.

FIG. 17 shows contemplated measure period parameters.

A service code rule references a set of service codes (shown in Table 13) in a service table 1820 where parameters 1830 for service code rules are shown in the screen shot 1800 of FIG. 18.

The ICD9 DX rule is currently the only exception, as shown in FIG. 19. In this Figure, a screen shot 1900 of the ICD9 DX service code rule parameters 1925 are shown.

FIG. 20 shows a screen shot 2000 of an example list 2005 of service tables 2015. The workspace area 2020 is shown on the right of screen shot 2000.

FIG. 21 shows a contemplated Rx Claims rule screen shot.

FIG. 22 shows a contemplated Rx Claims rule screen shot.

FIG. 23 shows a set of contemplated parameters for a define set rule.

FIG. 24 shows a set of contemplated parameters for a look same claim rule.

FIG. 25 shows a set of contemplated parameters for a look back rule.

FIG. 26 shows a set of contemplated parameters for a look back active Rx History.

FIG. 27 shows a set of contemplated parameters for an Event Count rule.

FIG. 28 shows a contemplated example for an event count usage.

FIG. 29 shows a contemplated example for an event count usage.

FIG. 30 shows a contemplated example for an event count usage.

FIG. 31 indicates logically what the COT Event rule is doing through an example 3100.

FIG. 32 shows a set of contemplated parameters for a COT Event rule.

FIG. 33 shows a set of contemplated parameters for a Member Age/Sex rule.

### SUMMARY OF THE SUBJECT MATTER

A rules based software user interface application and environment, comprising: a) a clinical quality measure library database schema, b) a clinical quality measure specification database schema, c) a rules library, d) a clinical business rule (CBR) editor, e) a key performance indicator (KPI) or clinical quality measure specification editor, f) a clinical quality runtime configuration module, g) a cost of care runtime configuration module and h) a runtime manager module and, in some embodiments, i) a measure testing module. In some embodiments, rules-based software applications comprise a component for delivery of clinical measure description libraries as a web or Internet application. In other embodiments, rules-based software applications comprise a component or module for measure testing which include a test data generator module which generates a test database with a known target measure result and an audit detail component for inspecting test results. In yet other embodiments, rules-based software applications comprise both a component for delivery of clinical measure description libraries as a web or Internet application and a measure testing component to support the development of measures.

Methods of converting health-based input source data into measures of clinical quality or cost of care comprise: a) providing a source code application, b) providing a collection of source data that comprises health-related source data, and c) transforming the source data into at least one evidence-based care measure using the source code application. In some embodiments, contemplated care measures comprise quality of care measures, care of cost measures or combinations thereof.

### DETAILED DESCRIPTION

Surprisingly, few if any software applications and methods have been developed, until now, that: a) are rules-based in order to facilitate rapid creation and customization of clinical quality measures without the need for programming, b) easily transform source data into evidence-based quality of care measures and cost of care measures, c) can be rapidly deployed by a health plan provider or other health care establishment/entity, d) have regular maintenance and easy update advantages of commercial software applications, and e) can publish measure descriptions and measures results for provider collaboration, comment and education.

Contemplated software applications, environments and modules support the engagement of the health plan's network of physicians (herein referred to as “providers”) in the review, selection and customization of measures in order to increase acceptance and adherence. Further, the software applications and methods described herein support the business process of engagement with providers on selecting and defining measures, which is necessary to increase physician acceptance and adherence. Contemplated software applications provide a complete development environment for creating, editing and testing clinical quality and cost of care measures.

By rapidly producing and reporting metrics on clinical practice, the software applications and methods disclosed can provide information to narrow the gap between existing clinical practices and best demonstrated practices using evidence-based care standards, which will improve the health care quality and efficiency of providers and improve the health plan value to members.

The rules based software user interface application and environment contemplated herein comprises: a) a clinical quality measure library database schema, b) a clinical quality measure specification database schema, c) a rules library, d) a clinical business rule (CBR) editor, e) a key performance indicator (KPI) or clinical quality measure specification editor, f) a clinical quality runtime configuration module, g) a cost of care runtime configuration module and h) a runtime manager module and, in some embodiments, i) a measure testing module. In some embodiments, rules-based software applications comprise a component for delivery of clinical measure description libraries as a web or Internet application. In other embodiments, rules-based software applications comprise an audit detail component for testing versions of measure specifications. In yet other embodiments, rules-based software applications comprise both a component for delivery of clinical measure description libraries as a web or Internet application and a component for measure testing which include a test data generator module which generates a test database with a known target measure result and an audit detail component for inspecting test results.

Methods of converting health-based input source data into measures of clinical quality or cost of care comprise: a) providing a source code application, b) providing a collection of source data that comprises health-related source data, and c) transforming the source data into at least one evidence-based care measure using the source code application. In some embodiments, contemplated care measures comprise quality of care measures, care of cost measures or combinations thereof.

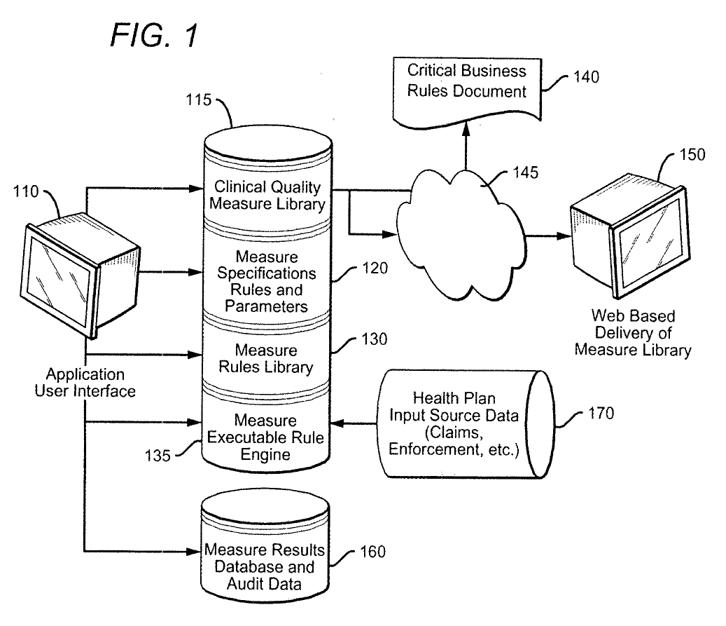

The contemplated software application described herein provides the following functionality and the components, which are also shown in FIG. 1. In this Figure, a software user interface application environment 100 is shown that comprises an application user interface 110 and that supports: viewing, editing and creating clinical quality measure descriptions in a clinical quality measure library 115 including viewing, creating and editing service code tables (not shown) and the review of comments from the measure comment system (not shown); viewing, editing and creating of clinical quality and cost of care measure specifications as parameters for selected rules in a measure specification repository or database schema 120; viewing and editing parameters for a clinical quality index, clinical quality configuration module or composite measure scores; viewing and editing of parameter values for a cost of care index, cost of care configuration module or composite score and cost of care measures; defining a measure run, which includes selecting the measures to run, selecting the target source data sets for the measures, and specifying global parameters including specialties to profile; viewing of audit data; and viewing results data using pre-defined reports in a report library.

A clinical quality measure library database schema 115 is shown, which is pre-populated with clinical quality measure information or data. Automated change tracking (not shown) is provided for measure descriptions. Information can be transmitted and sent to be formatted in several acceptable methods, the collection of which is generally shown by reference number 145. Software based reporting formats 140 are shown which enable the publication of the measures in the measure library in document format for external review, including the publication of change logs. An optional additional software component application 150 for the delivery of the clinical measure library as a web application for physician engagement and measure comment.

A clinical quality measure specification database schema 120, which stores the definition of each measure as parameter values for selected rules for each clinical quality measure is shown. The measure specification database schema or repository 120 is also pre-populated with the complete rule specifications for the measures in the measure library 115. A measure rules library 130 is provided, which is a software library of stored procedures for each rule supported by the application. A software interpreter program (not shown) to automatically generate runtime executable software for each measure specification and to generate a test database in the measure specification database 120 is provided and shown in FIG. 1. A measure rules engine 135 is shown, which contains the complete set of executable software for all specified clinical quality measures and cost of care measures in the clinical quality measure library. Automatic version control for measure specifications and measure executable procedures (not shown) is provided as part of the measure executable rules engine 135. A set of audit detail tables 160 is also provided to track the results of each step in a measure executable. Pre-defined audit procedures and views are provided to support measure auditing. Pre-defined reports are also provided for viewing and analyzing measure results.

### Clinical Quality Measure Library

Evidence-based quality of care is used herein to describe a “best practice” or a provider “service” that is either indicated or contra-indicated for a specific combination of presenting patient criteria. The best practice is determined by reviewing evidence from medical research, is developed with reference to the evidence by a trusted source of clinicians or clinical quality organizations, and provides references to emerging medical evidence Table 1 lists some of the public domain source organizations who have accredited best practices or even published text-based descriptions for evidence-based quality of care measures as shown in Table 1.

Contemplated software applications described herein include an extensive base library of clinical quality measures that have been developed from guidelines and measures sourced from the accredited reference bodies above. This extensive base library of clinical measures and their descriptions is referred to as the “clinical quality measure library”. The clinical quality measure library embodied within the software application is a database schema which contains: 1) the attributes which describe the clinical logic of a measure; 2) the attributes which classify a measure and cross reference a measure; and 3) the service code tables that define the clinical criteria for a measure. Specifically, a clinical quality measure library comprises a plurality of attributes that describe the clinical logic of a measure, a plurality of attributes that classify a measure, a plurality of service code tables that define a set of clinical criteria for a measure, or a combination thereof. A user of the application can choose to use the existing clinical quality measure library or can choose to edit and customize measures or can choose to create completely new clinical quality measures.

Specifically, each of the quality of care measures disclosed herein, also called Key Performance Indicators (KPIs) describe the “adherence” or “compliance” of actual clinical practice with the recommended “best practice”. Also, a new type of measure is included and will be described in detail herein—a “Course of Treatment” type measure. Measures comprise a “unit of observation”, wherein the unit of observation may be a patient or may be a patient's course of treatment (the same patient might have multiple opportunities to be in receipt of the best practice during a measurement period, for example). The measure is presented as a ratio or percentage having a numerator and a denominator. The “denominator”, as used herein, is the measure of the total count of “opportunities” for the best practice. The “numerator”, as used herein, describes the total count of “delivered” best practice within the denominator set. The clinical logic or clinical business rules (“CBRs”) define the criteria by which a patient qualifies for the denominator or the numerator. In some embodiments, additional business logic can be implemented that describes how patients are assigned to provider(s) to enable the calculation of the metric by the provider.

As contemplated, a CBR editor or editor module may be used to view, edit and/or create at least one clinical quality measure description that can be consolidated into the clinical quality measure library. A KPI editor or editor module may be used to view, edit and/or create at least one clinical quality measure specification as at least one parameter for at least one rule in a clinical quality measure specification repository or database schema. A clinical quality configuration module is utilized to view and/or edit at least one parameter for a clinical quality index. A cost of care configuration module is utilized to view and/or edit parameter values for a cost of care index and at least one cost of care measure. Contemplated software applications and application environments also include a manager module that performs at least one of several functions, including a) selecting the measure or measures to run, b) selecting the target source data sets for the measures, and c) specifying global parameters including specialties to profile, or combinations thereof, for example.

Whether a patient meets a particular clinical criteria or parameter may be defined in at least one service code table, which is described in detail through examples in the Examples Section. A service code table lists the service code values that define the criteria. If the measure finds a match for the service code value in the service code table in the source data set for the measure then the patient or member meets the criteria.

Table 2 shows how a contemplated measure in the measure library might be presented in a GBR review document. The reference number identifies the specific measure within the measure library. The KPI Description describes the best practice. The Denominator column describes the criteria for patients to be included in the denominator set including a listing of service code tables for the criteria. Exclusions and exclusion service code tables refer to instances or codes of instances which are excluded from the CBR. The Numerator column describes the criteria for patients to be included in the numerator set and lists the numerator service code tables.

A clinical measure basically counts the number of patients who meet the denominator criteria and then counts the number of patients who also meet the numerator criteria. The above CV_1_MV measure when run might produce the population based results shown in Table 3. Table 4 shows contemplated measure specification components or global sets.

### Measure Description Attributes

Table 5 lists the measure description attributes provided in the Measure Library schema. (Note: this list is not a description of the database schema but a simple list of the available descriptive attributes)

Measure Classifications and Cross Reference Attributes

The measure library database includes a large set of measure classifications and cross references.
Source Organization and source External measure. Every measure is cross referenced to one or more source organizations as listed in Table 1 and also cross referenced to the specific external measure where an external measure exists.
References (Citations). Every measure is cross referenced to the published literature which provides the evidence for the ‘evidence-based’ recommended best practice.
Conditions and Interventions and Care Alert messages. Every measure is cross referenced to one or more Conditions or specific Surgeries or Procedures and also to consumer or MD oriented care alert messages.
Measure Class. Each measure is classified as belonging to one or more of an extensible set of measure classes including the following:
   Preventative Care
   Secondary Prevention
   Chronic care
   Medication Management
   Coordination of Care
   Acute Care
   Patient Safety
   Utilization Related
PCP flag. Indicates if the measure is also a primary care measure.
Specialty. Measures are cross referenced to a specialty.

Service Code Tables

Service codes describe the specific service provided to a member by a health care provider and these service codes are used by health care providers in administrative data such as claims or patient records. Many of the clinical business rules in a clinical quality measure include the identification of the service codes that embody or define the criterion.

A service code table has a number by which all the code values can be referenced, a code type as described above and a set of code values, together with a description for the code value as shown in Table 6. The software application provides an extensible code table architecture which can support any service code type. Table 7 describes some example service code types within the Clinical Measure Library.

The software application described herein provides a user interface to create, view and edit an underlying data driven description of each clinical quality or cost of care measure, including the service codes. This database description of the measure allows for easy publishing of the measure in multiple formats including presentation in a web-based measure comment system.

The software application described herein includes an application to a) publish the Measure Library to a web based comment system b) receive and store reviewer comments on the measure components and c) generate and publish reports based on comments and survey questions on each measure.

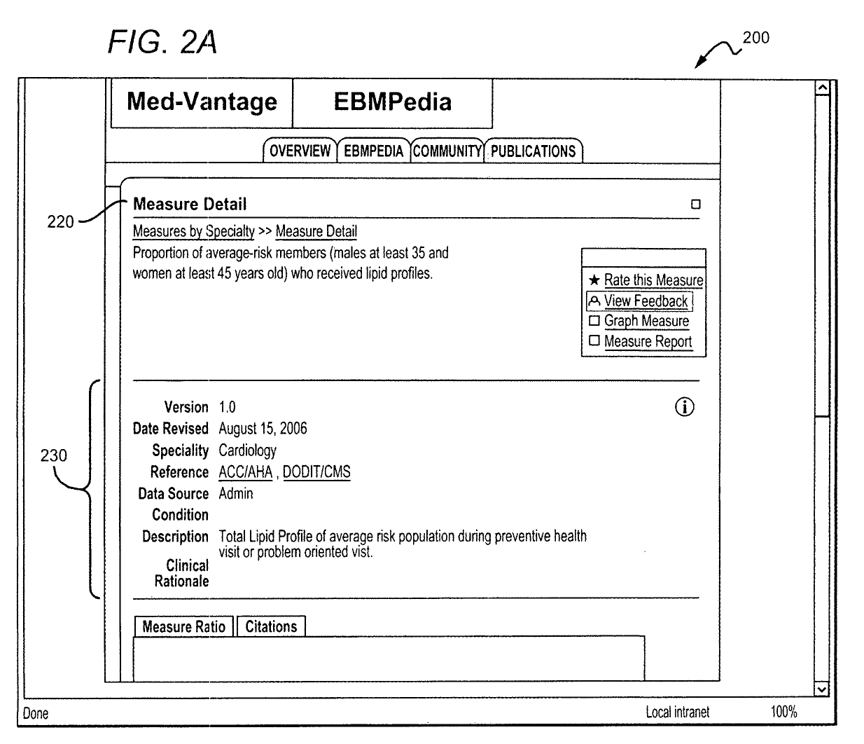

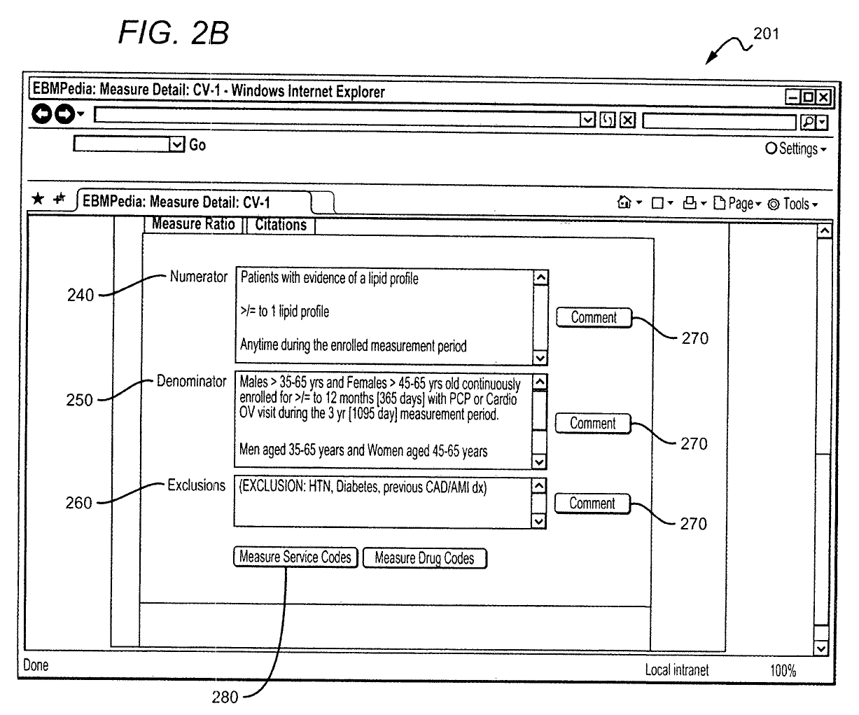

FIGS. 2A and 2B show an embodiment of the measure within the web application and illustrates the opportunity for user comment. Specifically, a captured shot 200 and 201 of a contemplated web environment is shown in FIGS. 2A and 2B, respectively, where FIG. 2B is a continuation of FIG. 2A. Note that as part of the measure detail 220, there are a series of specifics 230 regarding the measure and then numerator 240, denominator 250 and exclusion 260 information. In addition, there are comment tabs 270 where users can provide comments. A measure service code tab 280 is also provided at the bottom of the screen shot for the user.

### Measure Rules Library

The software application described herein provides a user interface for the specification of a measure as a set of parameterized rules stored in a library format or database schema (the “Rules Library”). These rules are used to drive the automatic generation of the executable code for the measure. In essence, each rule creates a patient group or defined set and the software application provides a user interface to both create sets of interest and define the rules for how the sets are combined to identify the specific set of patients meeting all required criteria.

Examples of contemplated rules are shown in Table 8 for illustration purposes, which is further described in the Examples Section. The D,E,N labels indicate whether the rule is available for Denominator, Exclusion or Numerator component of the measure and these labels define the “global set”. The global set definition is combined with other criteria to determine the final set of patients who qualify for the measure component: a) measurement period offsets, b) continuous enrollments, c) age periods, and d) other miscellaneous patient eligibility criteria. A set is defined by a combination of rules. A complex set can be a combination of nested set rules that when combined together form the set definition.

Contemplated rules can be added, edited or deleted from a measure specification, which is described herein and also in the Examples section. To add a new rule, a rule type is selected from a drop down list of rule types, “add” is then selected. A dialog box with all parameters for that rule type will automatically appear. The rule specification is then “completed”. One can then go back to the denominator and define more new rules. To edit a rule, one clicks in the rule window and the dialog box with all of the parameters for that rule type will automatically appear. The rule specification can be edited. One can then go back to the denominator and define more new rules. Finally, a rule can be deleted by selecting the rule, clicking on the delete button and allowing the rule to disappear from the rule window.

Contemplated rules-based software applications provide a simple to use interface, wherein a user can review, create or edit a measure specification. This advance over conventional software applications and methods clearly shows the novelty and non-obviousness of the embodiments disclosed herein. Another advantage, which was previously described, is the inclusion of a comprehensive base library of pre-built, master KPI measures that are immediately ready to use.

In some embodiments, another interactive “communication” feature is added in order to further assist the user and/or the developer, such as the KPI Measure Communication Application described herein. This feature allows for 1) publication of the Measure Library into a web application that supports viewing of the Measure Library content and also enables collection and reporting of measure feedback in the form of ratings and detailed comments, 2) physicians to collaborate and exchange views and opinions in community forums and 3) discussion postings can be categorized for relevance to KPIs and subject matter for later view, listings and search. For example, an entire network of physicians can be engaged in reviewing and scoring the clinical quality measures and also in reviewing the ratings and comments provided by other physicians. The feedback collected is itself a part of the Measure Library and immediately available to a measure designer who can then edit and instantly republish a modified version of the measure.

### EXAMPLES

### Example 1

### A Cardiology Measure

A contemplated software application, such as a KPI Measure Builder Application, and method of development and use is described in this example, however, it should be understood that the Figures used in this Example show one embodiment of the interface and is not meant to be limited as to how the software application and interface can be set up.

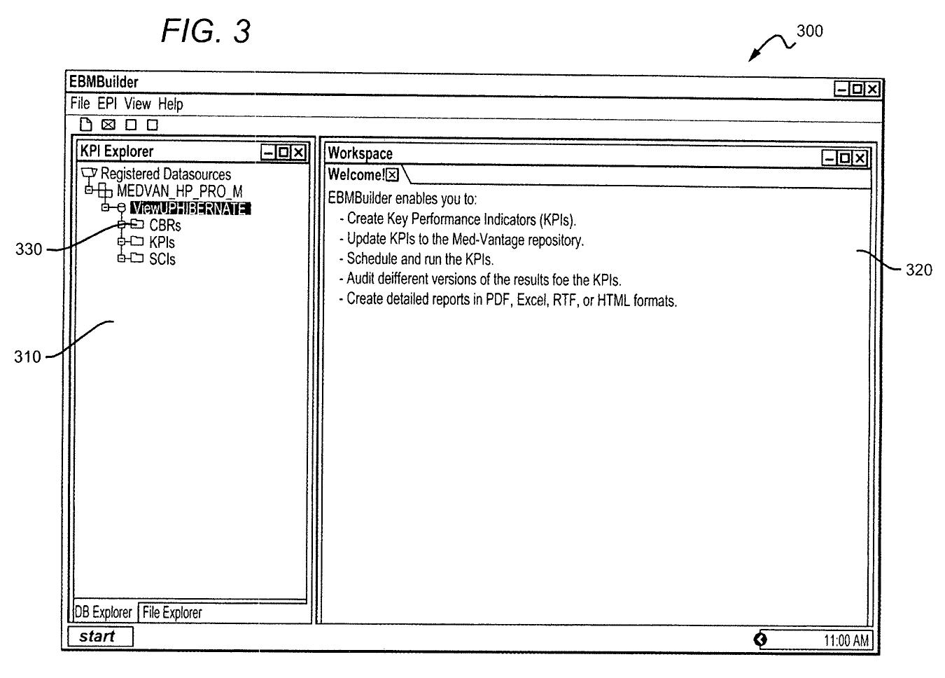

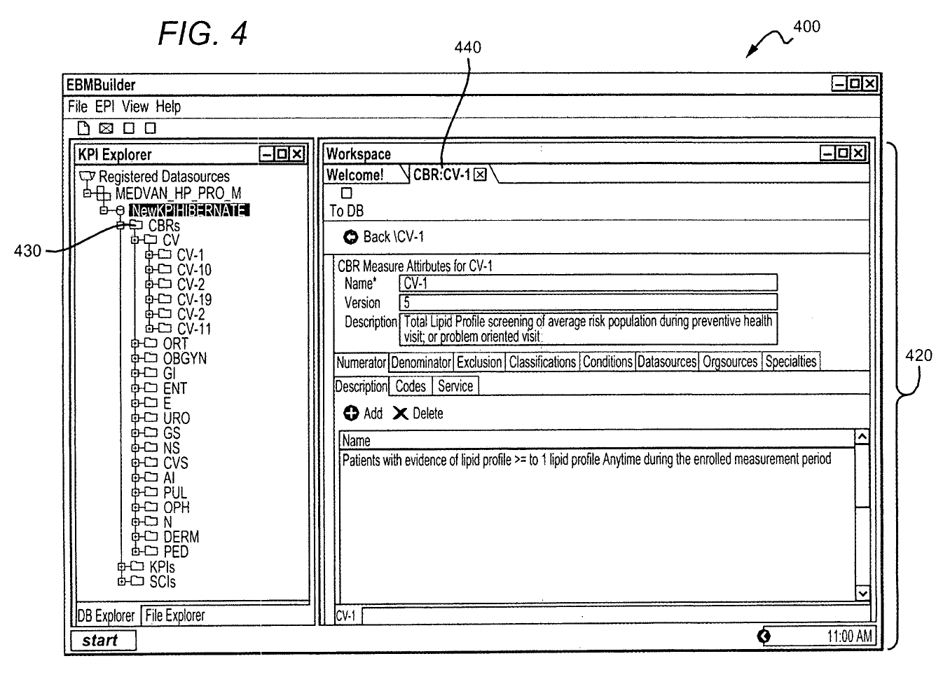

FIG. 3 shows a contemplated software interface or webview 300 that a user (not shown) would view when starting the software applications and methods described herein. Once connected to the database, the workspace lists the objects available for editing. As shown, the left hand side of the screen lists the objects 310 that may be viewed and edited which include 1) the measure descriptions in the measure library (CBRs), 2) the clinical quality measure specifications (KPIs) and 3) the cost of care measure specifications (CCIs) while an interface window or workspace area 320 is displayed on the right. In one embodiment, one clicks on the folder for CBRs 330 to see a list of specialties, then click on the specialty to see a list of measures, and right click on the measure and choose CBR to get the measure description in the workspace area 400, as shown in FIG. 4. Notice that the CBR folder 430 is open on the left hand side of the screenshot 400 and the workspace area 420 shows the CBR detail 440,

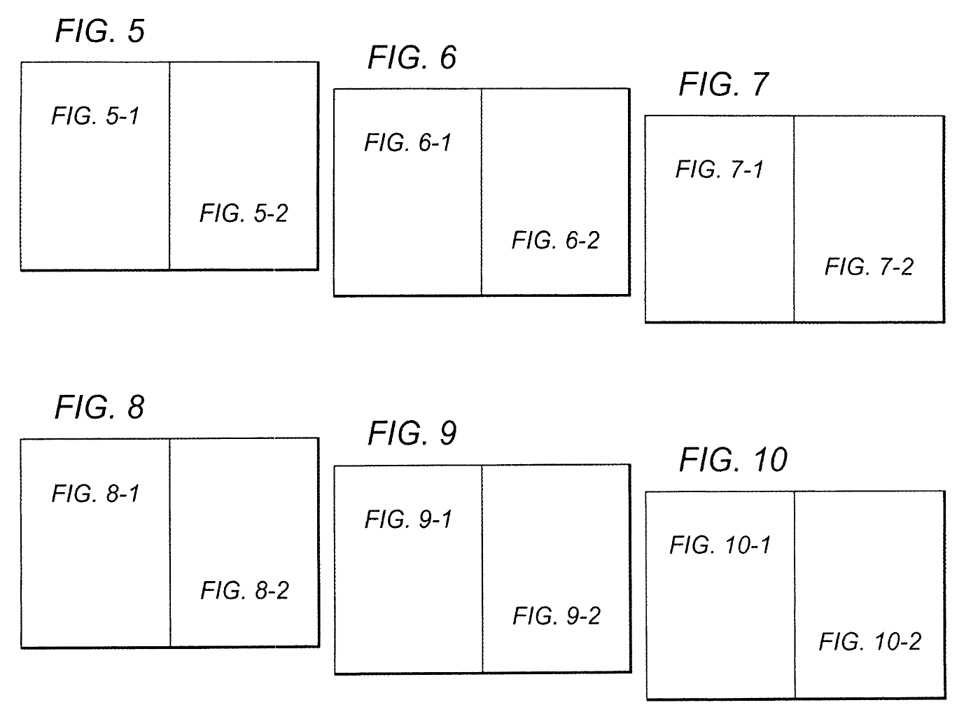

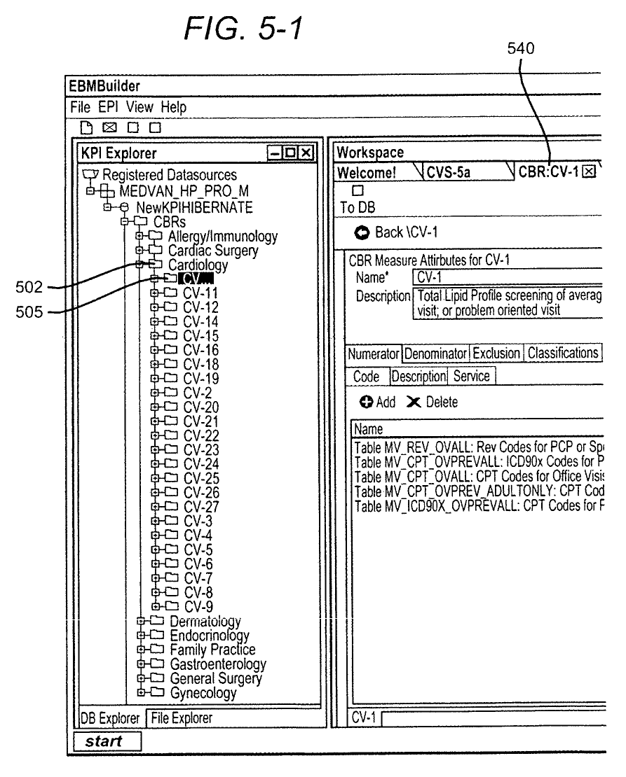

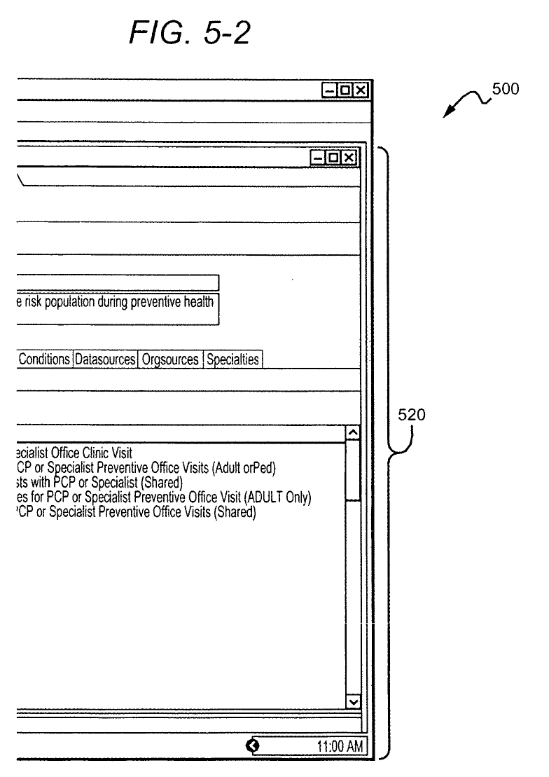

FIG. 5 shows a contemplated workspace area 500 for viewing and editing a measure description in the measure library. In this Figure, KPI CV-1 505 is shown on the left hand side of the screen as the selected description under “Cardiology” 502. The right hand side of the screen or workspace area 520 shows the details regarding CBR: CV-1 540. Tables 2 and 9 show the specific KPI Descriptions and CPT Codes for KPI CV-1 as developed for this Example. Note that Table 9 is referred to in Table 2 under the “Numerator” heading.

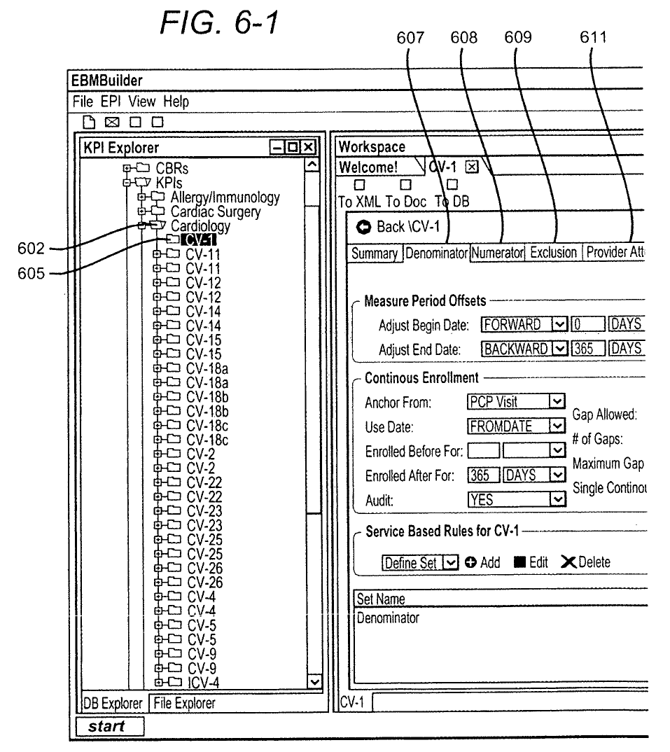

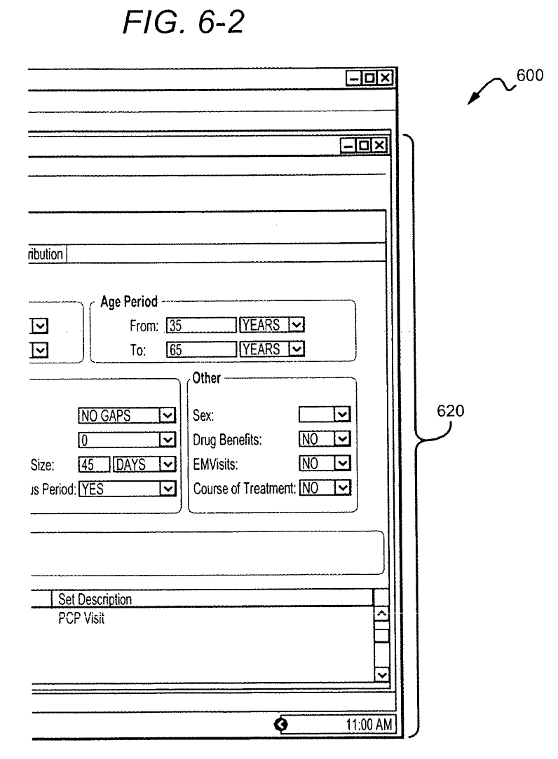

FIG. 6 shows a screenshot 600 comprising a contemplated workspace area 620 when the user has clicked on the “Cardiology” KPI set 602 and then on KPI measure 605 with reference number CV-1 and selected the Denominator tab 607 for viewing or editing. Note that the user may also click on tabs for the “Numerator” 608, the “Denominator” 607, the “Exclusion” 609 and the “Provider Attribution” 611.

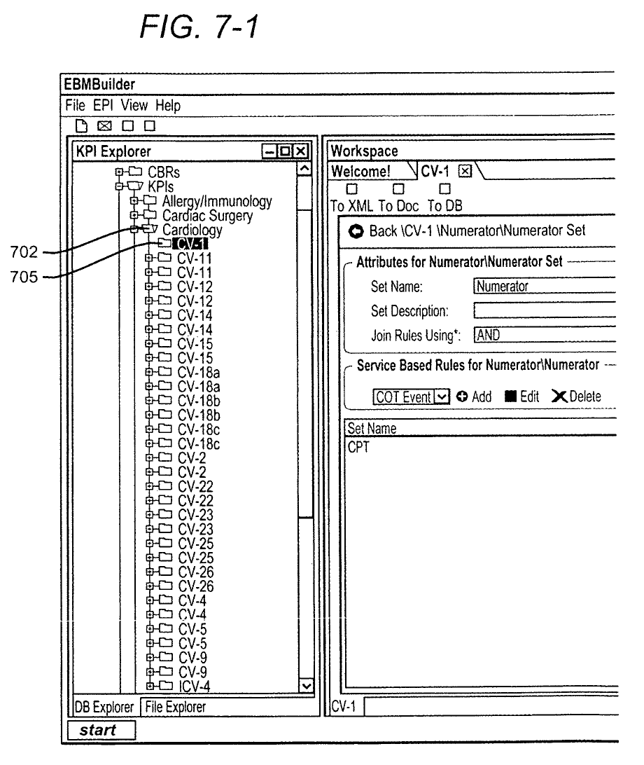

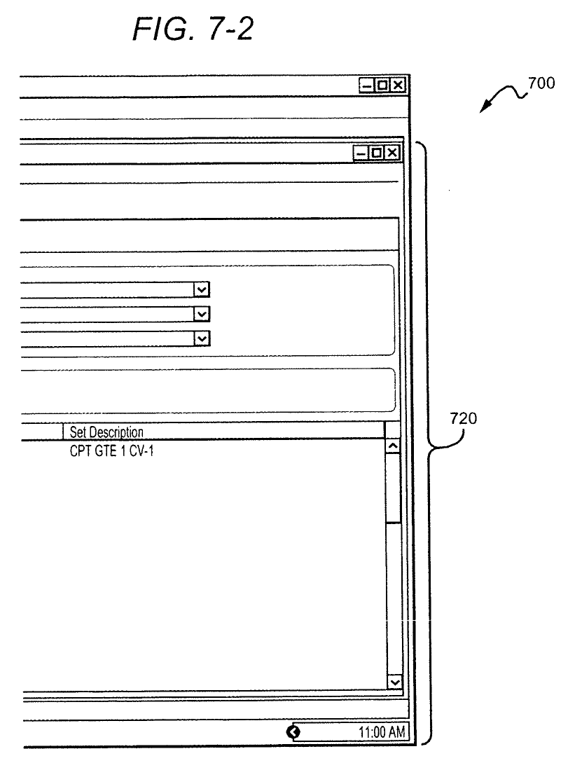

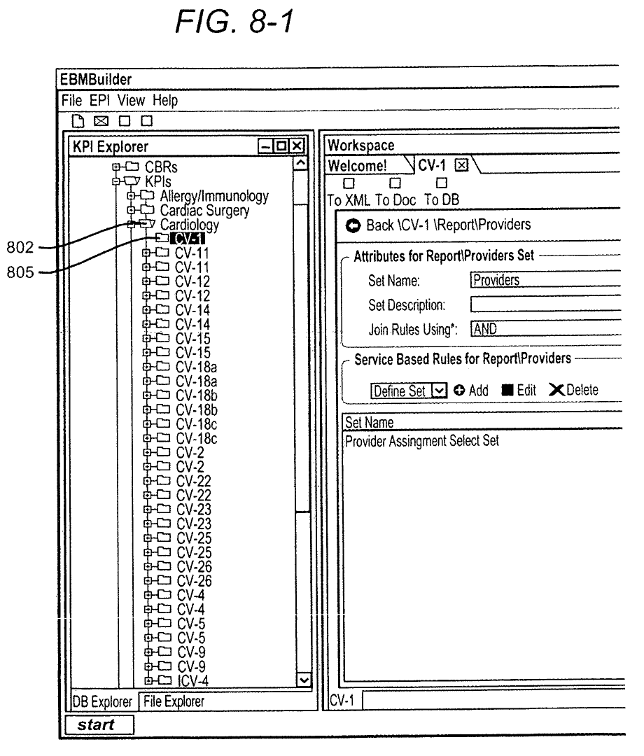

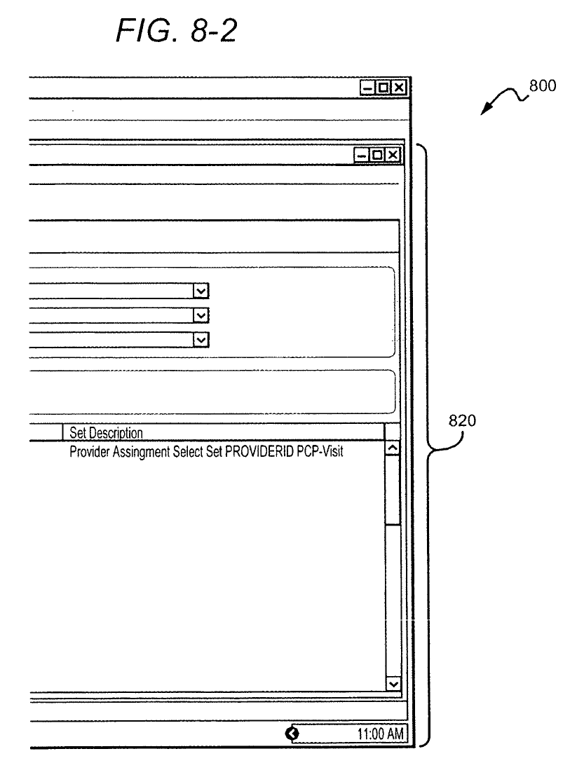

FIG. 7 shows a screenshot 700 comprising a contemplated workspace area 720 when the user has clicked on the “Cardiology” KPI set 702 and then on KPI measure 705 with reference number CV-1 and selected the Numerator tab from FIG. 6 (not shown in FIG. 7) for viewing or editing. Note that many of the options are easily updateable and editable by the user. FIG. 8 shows a screenshot 800 comprising a contemplated workspace area 820 when the user has clicked on the “Cardiology” KPI set 802 and then on KPI measure 805 with reference number CV-1 and selected the Provider Attribution tab from FIG. 6 (not shown in FIG. 8) for viewing or editing.

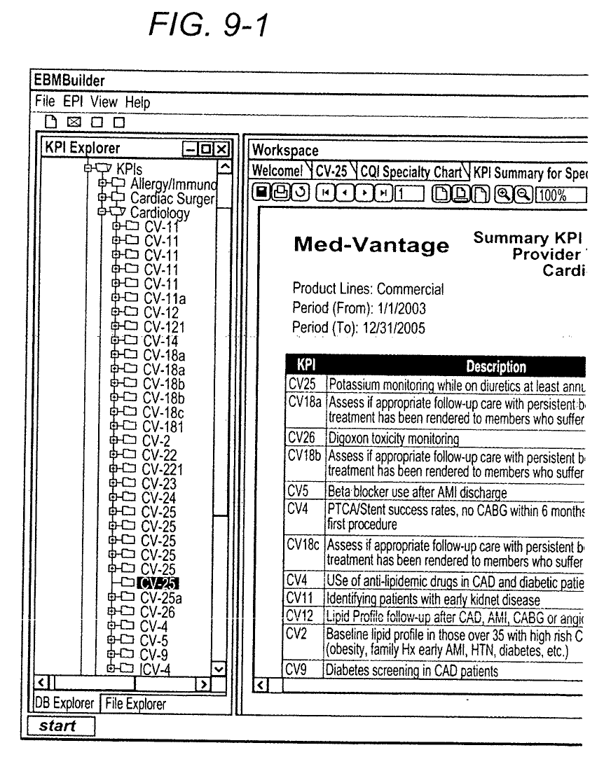

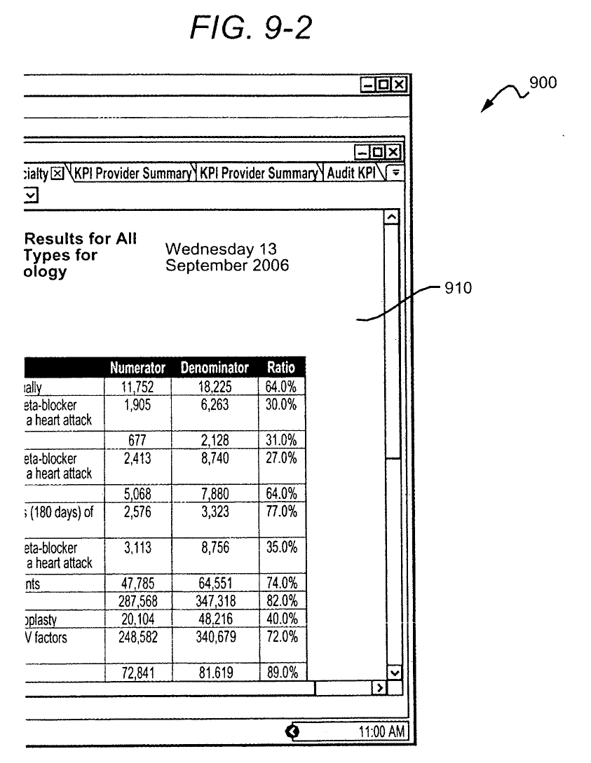

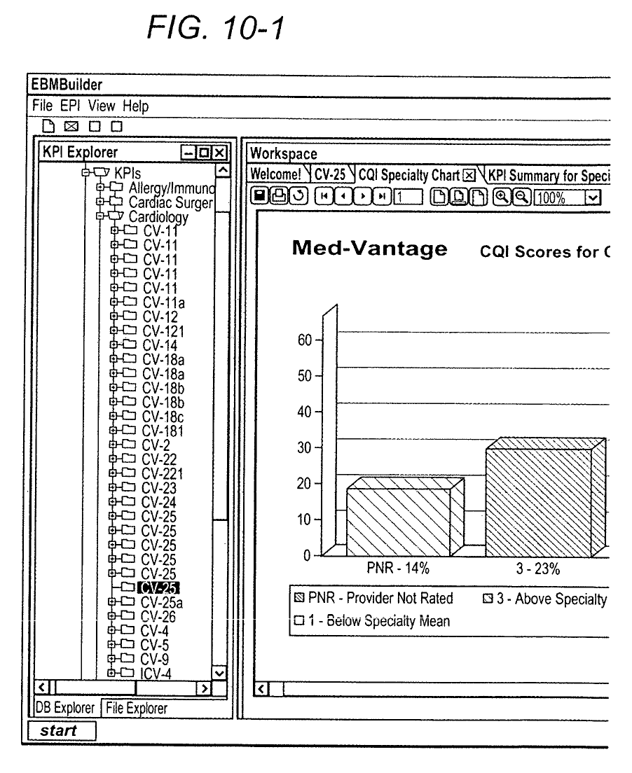

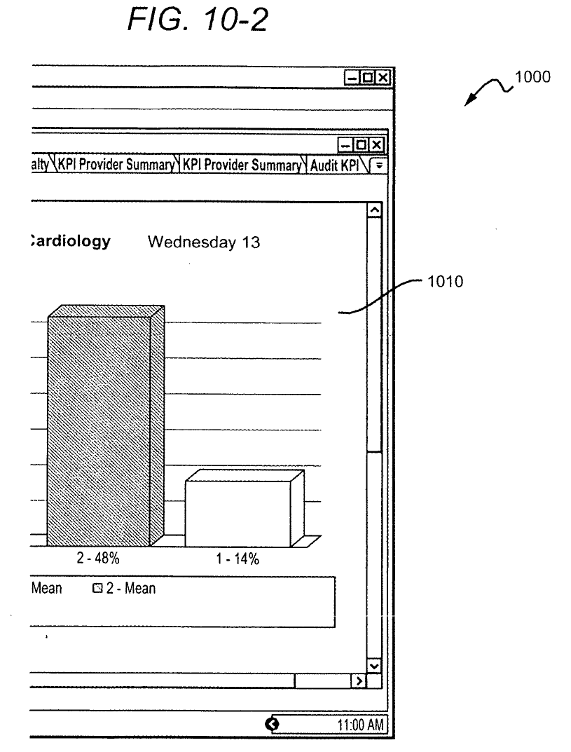

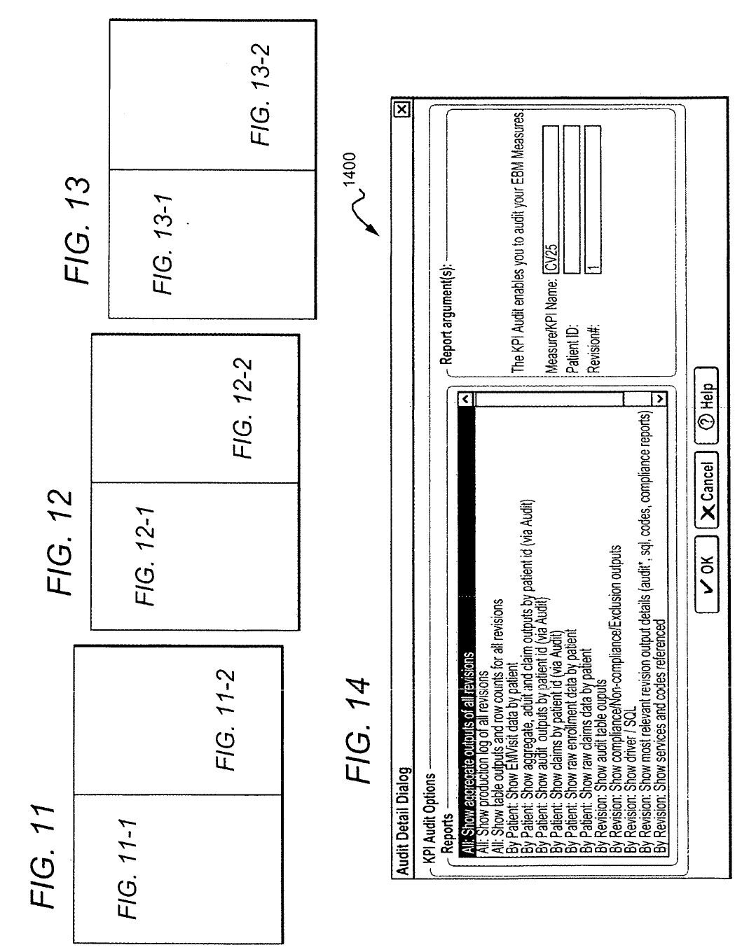

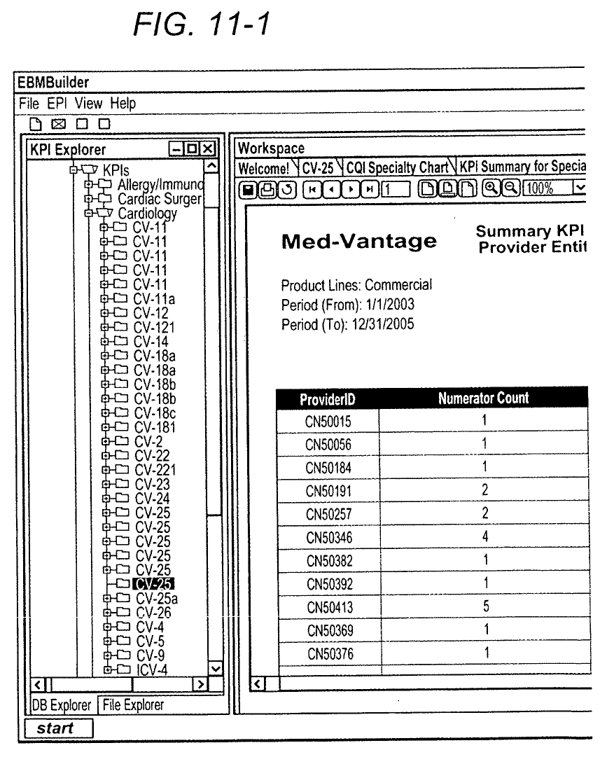

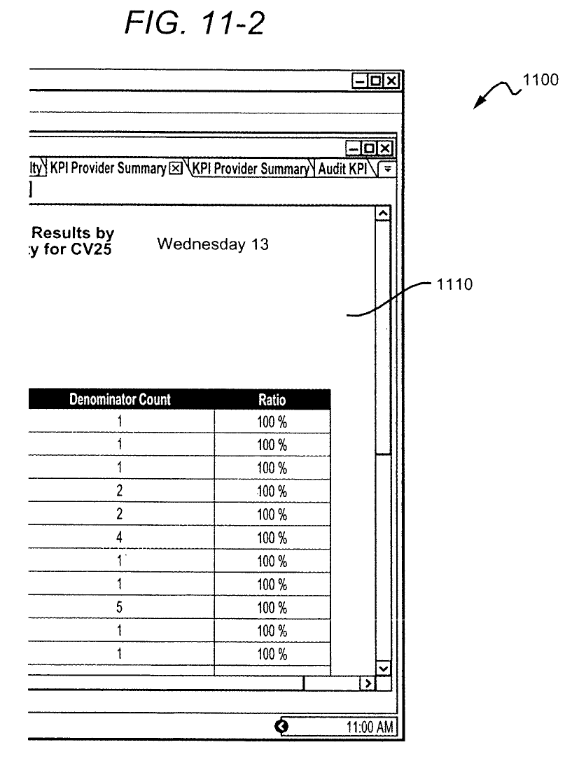

As mentioned earlier, another benefit of the currently disclosed software applications and methods is the ability to print meaningful and useful reports for the user and/or various entities related to the user. FIGS. 9-11 show samples of screen shots (900, 1000 and 1100 respectively) displaying contemplated reports (910, 1010 and 1110, respectively) that can be generated for the KPIs and measures. Table 10 also shows a listing of some of the example reports available to users.

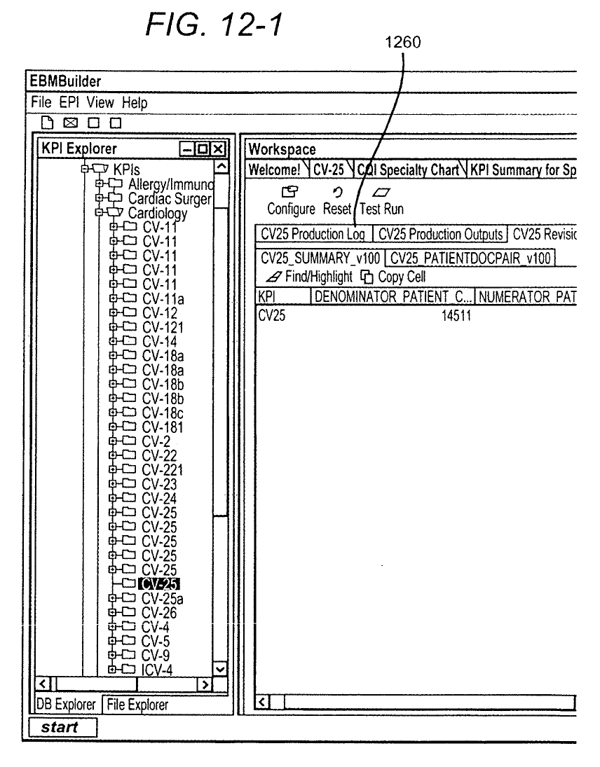

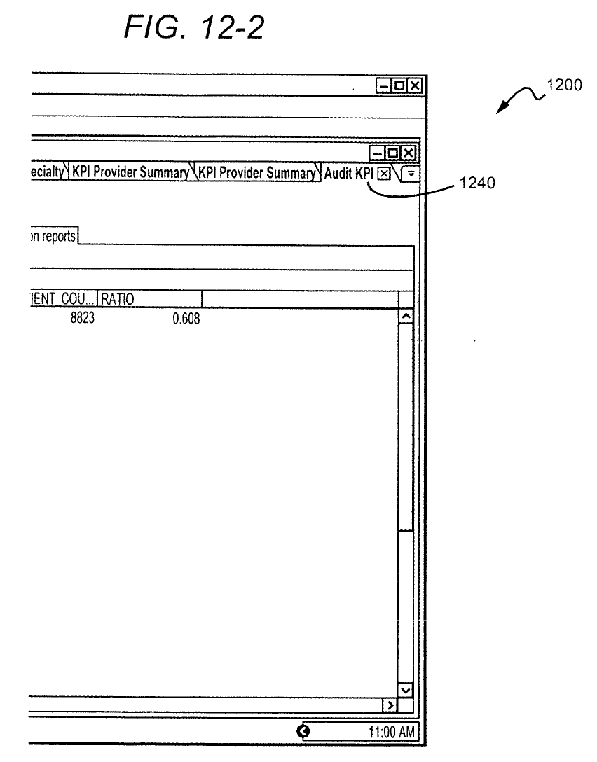

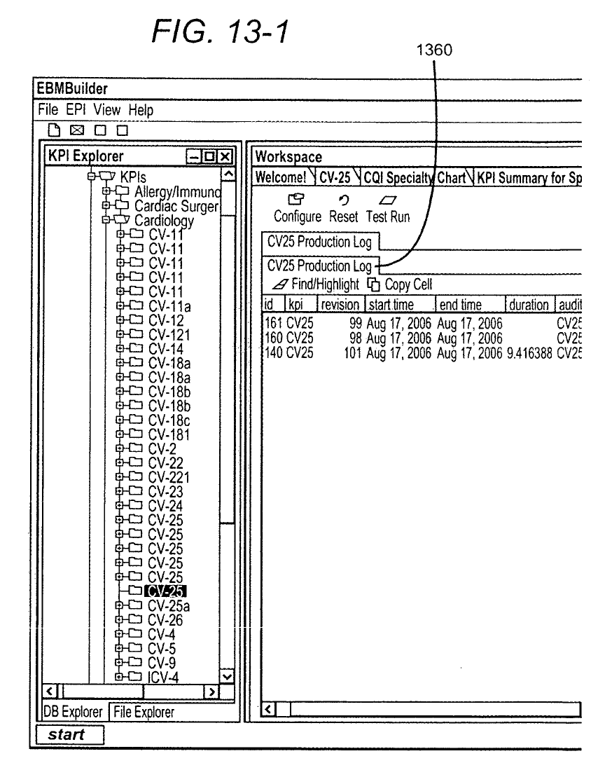

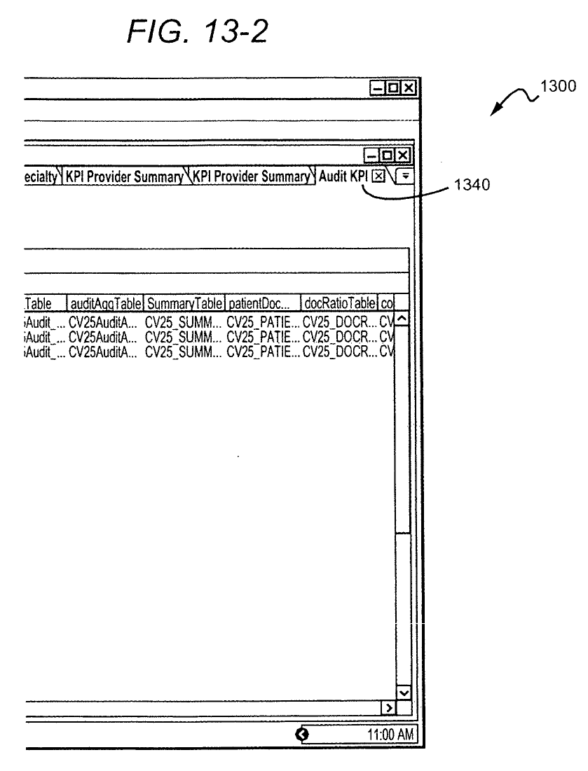

FIGS. 12-13 show a screen shot (1200 and 1300, respectively) where the user (not shown) is working in the “Audit KPI” tab (1240 and 1340, respectively) of contemplated software applications, environments and methods. Note that the audit feature stores a “Production Log” (1260 and 1360, respectively) that allows the user to go back in time and view the actions taken in the measure. The “Audit Detail Dialog” 1400 shown in FIG. 14 allows the user (not shown) to select different types of audit presentations.

### Example 2

### Building a Measure Using Rules

As an introduction, the contents of this Example were produced, in part, by utilizing the “EBBuilder™—KPI Editor Module Provisional User Manual” produced by MedVantage®, which is incorporated herein in its entirety by reference.

Building a measure is all about defining sets. To define a measure denominator you build the set of patients or set of patient events that meet all denominator criteria. To define exclusions you build an exclusion set and then join the exclusion set with the denominator set to create a final denominator set. To define the numerator you build the set of patients who qualify for the numerator. A set may be created by one or more criterion rules. A set may also be created by joining with other already defined sets. In the end, all defined sets are encapsulated within a final global set. The Figures that are associated with this Example are primarily screenshots (unless otherwise noted) showing the individual contemplated steps of the measure building and editing process.

Each measure has three global sets, which has been described earlier in the application:

1. Denominator Set

2. Numerator Set

3. Exclusion Set

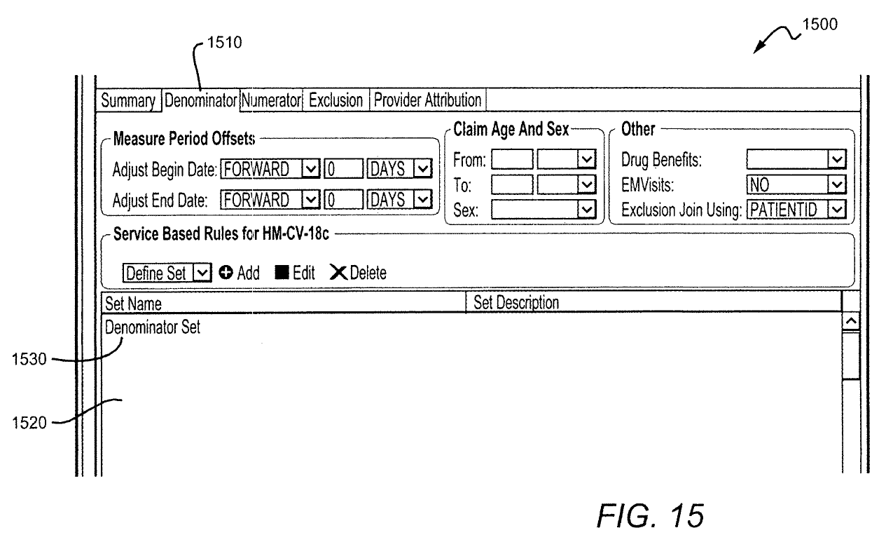

FIG. 15 shows a screen shot 1500 of a denominator specification for a new KPI (not shown) and illustrates the specification panel for the denominator 1510 and shows the empty denominator global set 1520 awaiting definition. To begin the specification process a ‘global set’ is opened by double clicking on the set 1530, which as shown by the screen shot 1600 in FIG. 16, which shows an example set definition dialog, brings up a set definition dialog 1630 and specification can begin.

A measure is defined by adding rules to the measure. The first rule is usually a Define Set rule which will create a set to hold the results of any other rule. To add a new rule:
1. Select a rule type from the drop down list of rule types.
2. Select Add. A dialog box with all parameters for that rule type will automatically appear.
3. Complete the rule specification.
4. Use the Green button at the top of screen to go back to Denominator and define more rules.
   To edit a rule:
1. Double click on the rule in the rule window. The dialog box with all parameters for that rule type will automatically appear. (Or click once on rule to select the rule and then click on Edit).
2. Edit the rule specification.
3. Use the Green button at the top of screen to go back to Denominator and define more rules.
   To delete a rule:
1. Select the rule in the rule window by clicking the mouse on the rule once.
2. The dialog box with all parameters for that rule type will automatically appear
3. Click on the delete button.
4. The rule will disappear from the rule window.

### Measure Specification Database Scheme or “KPI Editor” Rules Overview

Rules are of different types—and the rule type indicates the data source or input set for the rule and the fields available in the output or results set. The following rule types are identified:
1. Claim. The claim rules specify criteria for retrieving claims in the source data and the results set returns all the rows in the source data matching the specified criteria. The returned results contain a subset of the columns in the original claim table.
2. Set. Set rules specify ways to create and act on named sets.
3. Calculation. The calculation rules perform a numerical operation on a target set of data already created. The returned results are not the original claims but the results of the requested calculation.
4. COT. These are all the rules related to course of treatment measures.
5. Member. The Member type rules specify criteria for patients that are independent of actual events. These are the criteria that can be found in the member enrollment source data such as drug benefits, enrollment time frames and also basic demographic criteria such as age or sex.
6. Provider Attribution. These rules specify criteria for providers during provider attribution.
   Contemplated rules were shown earlier in Table 8.

### Claim Rules

Claim rules are rules which find and return a set of claims from the source data set to create a results set which can then be acted on by other rules.

The Claim rules usually use a service code table as the criteria for the set of claims to be retrieved. All Claim rules also use the Measure Period Offsets defined in the global parent set (Denominator Set, Numerator Set or Exclusion Set) to set the date criteria for the events All Claim rules used in the Denominator global set also use the Claim Age and Sex parameters as an additional filter on any claim sets retrieved.

Claim rule results are a set of claim rows with a subset of the columns from the claim row.

### Measure Period Offsets

Rule Description: A global measurement period is defined in the Client Properties File that describes the default measure period or measurement year for the measures. Within each measure component, the measure period to be used for that measure component is defined in terms of an offset from the global measurement period. These offsets define the actual date range that is used when retrieving a claim set. There is a separate Measure Period Offset definition for each of the global sets —Denominator, Numerator and Exclusions.

Parameters:

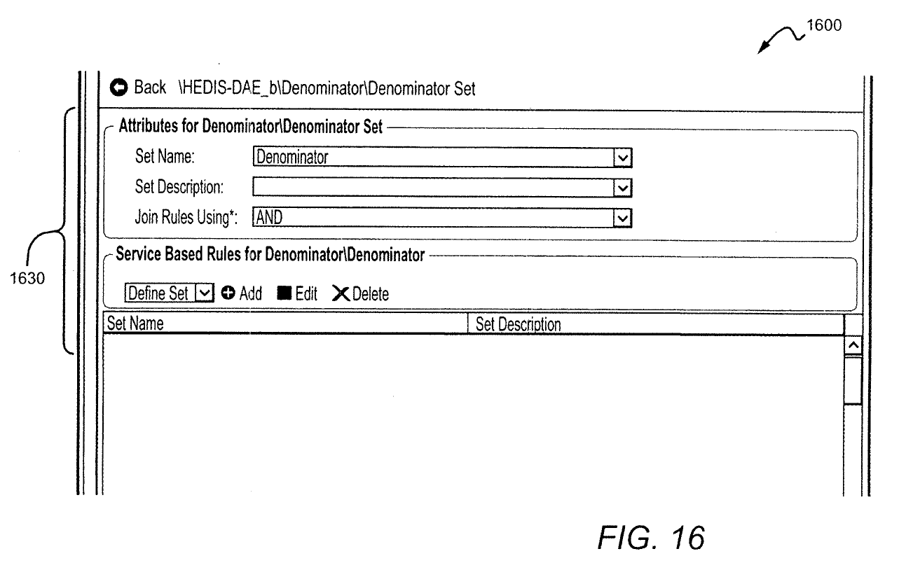

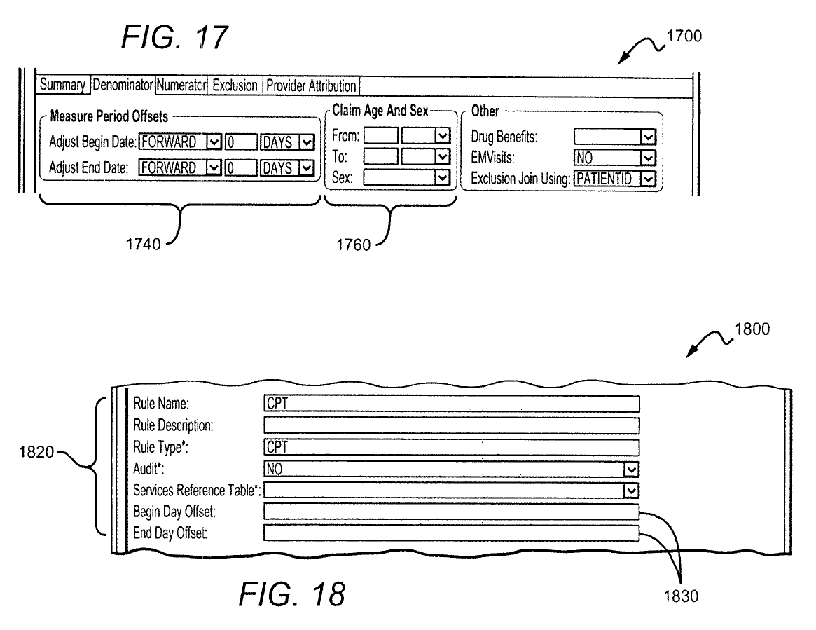

FIG. 17 shows contemplated measure period parameters. If the measure period offsets 1740 are not edited, as shown in the screen shot 1700 of FIG. 17, then the global measurement period will define the date range for any claim sets to be retrieved. Table 11 shows various parameters and their usages.

Results

There are no independent results for this rule. The rule acts as a filter for any claim sets being retrieved.

Measure Period Usage Examples

The global measurement period defined in the Client Properties file is defined one of two ways:
The global measurement period defines the date range for the available data set. For example the source data might be three years worth of claims so the global measure period would be a date range from, for example, Mar. 1, 2004 to Feb. 28, 2007
The global measurement period defines the ‘measurement year’. HEDIS or HEDIS like measures assume a 12 month measurement year and then measure periods are defined with respect to the measurement year. Even if the source data contains three years worth of claims, the measurement year would be defined, for example, as Mar. 1, 2006 to Feb. 28, 2007.

The purpose of the Measure Period Offsets is so that a refresh to the data set does not require an update to the measure. When the data set changes, the global measurement period may be edited to reflect the new data set and then the measures will automatically use new date ranges when retrieving claims.

Measure Period Offsets are needed in both global measurement period scenarios to ensure that there is data available for the measure so we can reliably conclude that the lack of an event is because it didn't happen when it should have rather than because the data set does not include the required event.

For example, in Measure OB-9, the global measurement period is a three year measure period reflecting the data set. The numerator requires:
Patients with evidence of one pap smear during pregnancy or during 1 year [365 days] preceding pregnancy
>/= to 1 pap smear during pregnancy [9 month look back for billed pre-natal codes]
OR >/= to 1 pap smear in preceding year [365 days]

Therefore the measure needs to have the Begin Date of the measure offset by 21 months when looking for the pregnancy claims in order to allow for the lookback through the 9 months of pregnancy and the year prior to the pregnancy.

### Claim Age and Sex

Rule description: This rule defines the required Age Range of the patient at the time of the claim or service event The claims data include patient age and patient sex on the claim record. Age is calculated using Enrollment data birthdate and claim date. (Age is calculated and inserted into the service data.) The Claim Age and Sex criteria may be used as an additional filter on any Event Rule when retrieving claims. Note that there is another rule, the Member Age/Sex rule, which enables the definition of patient age or sex as criteria that are independent of any claims.

Parameters

The Claim Age and Sex parameters 1760 are entirely optional and may be left blank, as also shown in FIG. 17. Table 12 shows several parameters and their usages.

Results

The Claim Age and Sex are additional criteria added to any of the service code type rules. There are no independent result sets.

### Service Code Rules

Rule Description: A service code rule references a set of service codes (shown in Table 13) in a service table 1820 where parameters 1830 for service code rules are shown in the screen shot 1800 of FIG. 18. In simple language terms these rules are of the form: FIND the set of claims where the CODE in the claim is the same as any code in the named service table.

Parameters

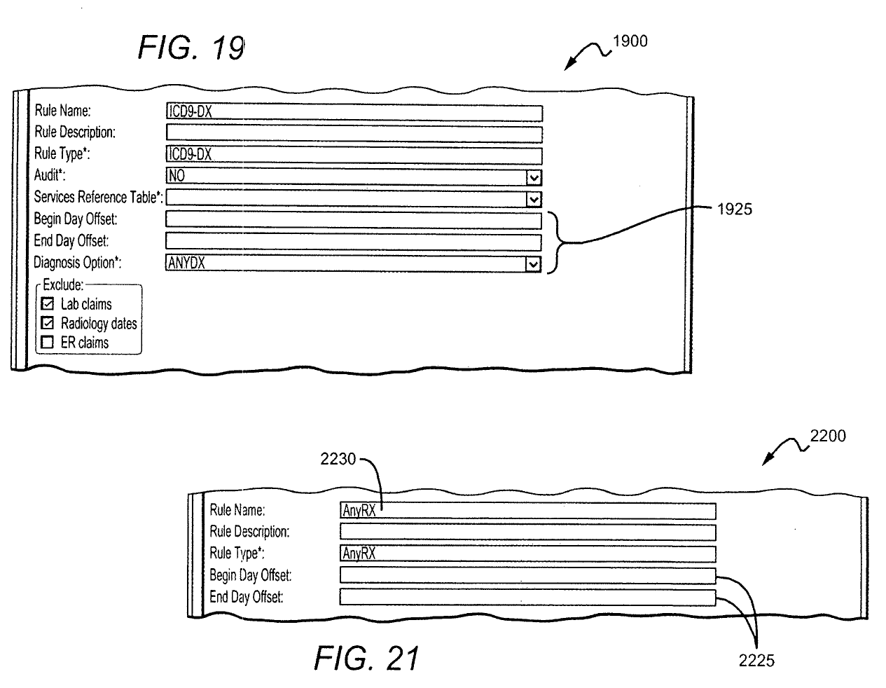

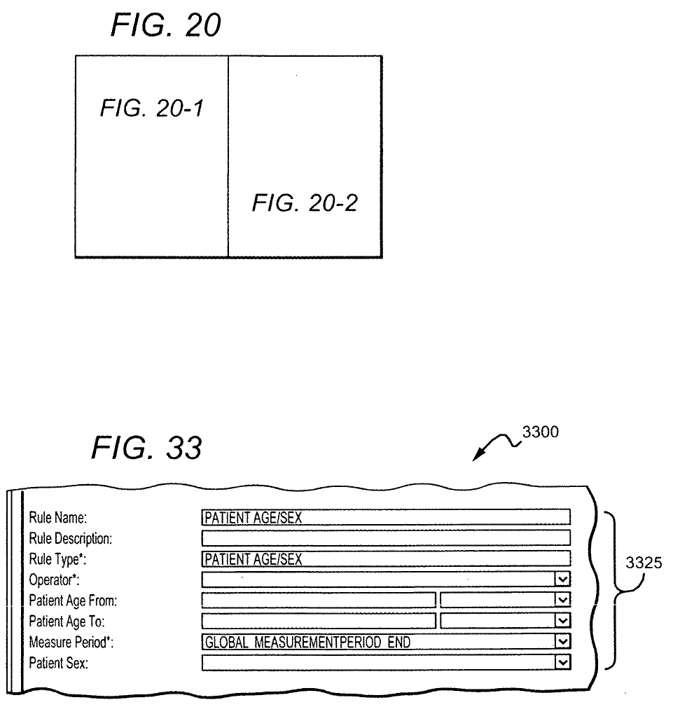

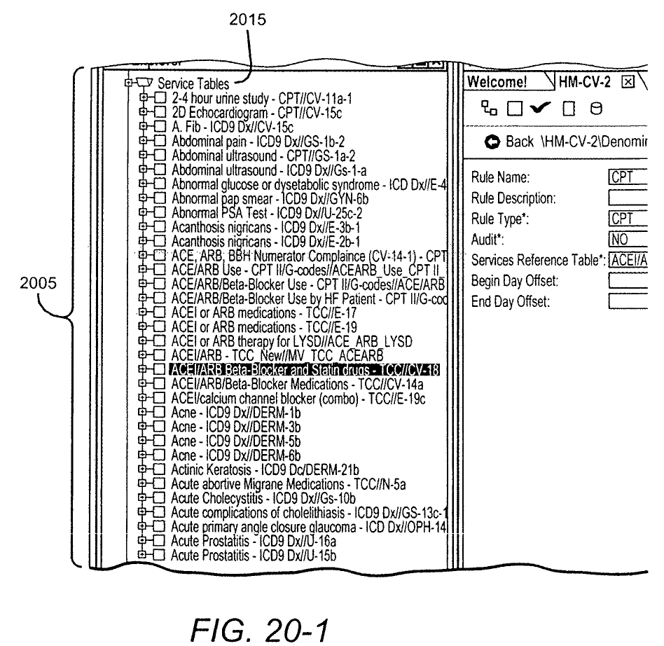

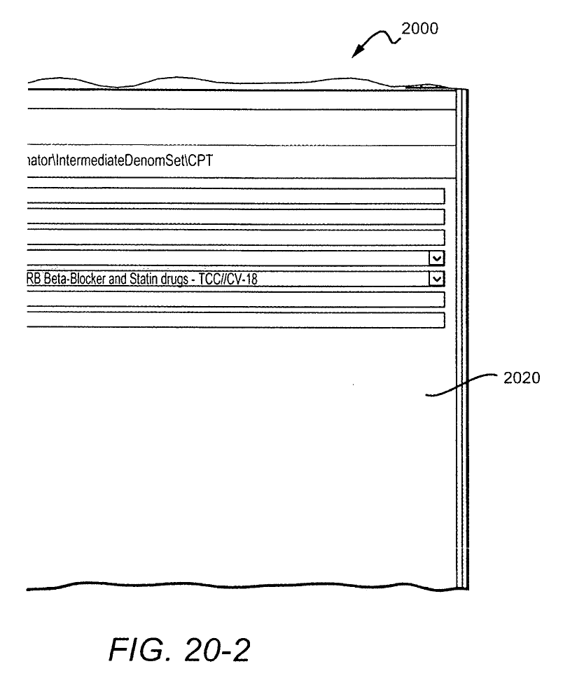

Most of the service code rules have exactly the same parameters as shown in Table 14 and Table 15. The ICD9 DX rule is currently the only exception, as shown in FIG. 19. In this Figure, a screen shot 1900 of the ICD9 DX service code rule parameters 1925 are shown. FIG. 20 shows a screen shot 2000 of an example list 2005 of service tables 2015. The workspace area 2020 is shown on the right of screen shot 2000.

Results

The service code rules bring back claim rows with a subset of the claim columns from the source claims table, as shown in Table 16.

### Rx Claims Rule

Rule Description: The Rx Claims rule finds any prescription claim within the specified time period.

Parameters

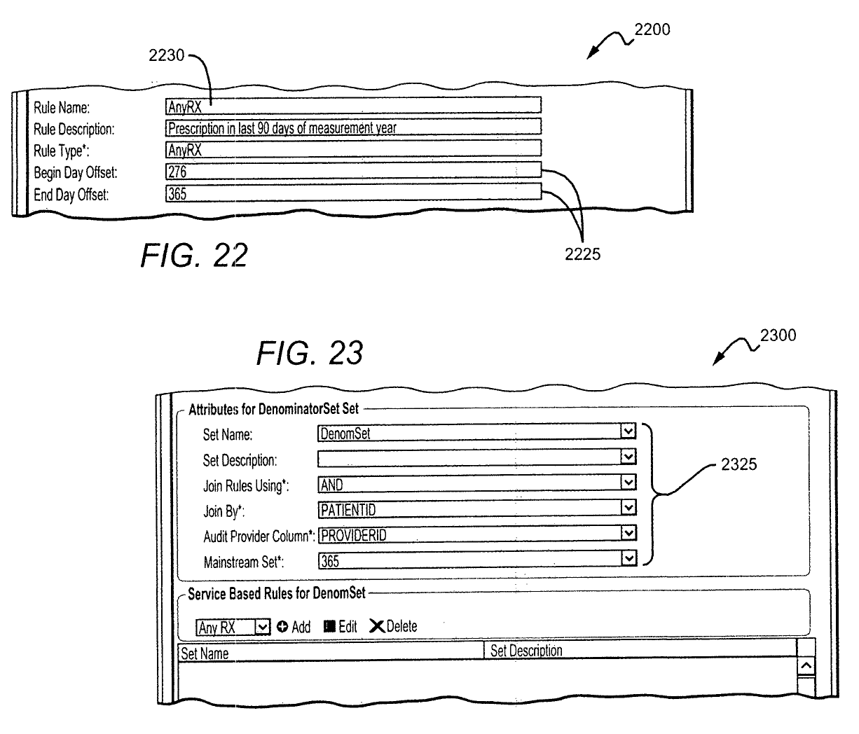

The Rx Claims rule uses the measure period for the measure component. The Begin Day Offset and End Day offset enable the ability to further limit or extend the measure period, as shown in FIG. 21, 22 and Table 17. In FIG. 21, a screen shot 2200 for the parameters 2225 of the Rx Claims rule 2230 is shown. In FIG. 22, the Rule Description 2235 is specified, as discussed below.

Results

The Rx Claims rule brings back all the prescription claim rows for the specified time period with a subset of the claims columns, as shown in Table 18.

Rx Claims Usage Examples

One of the envisaged measures requires that providers are only attributed to a patient in a measure if they have issued 100 scripts or more to patients age 64 or older in the last 90 days of the measurement year.
1. Create the set of patients who are age 64 or older e.g. Patients64
2. Create the set of providers who have issued any claims to patients age 64 or older
   a. Create the set of prescription claims for the last 90 days e.g. Rx90
      i. Use Any Rx rule to find the claims—using the offsets to define the measure period for the last 90 days, as shown in FIG. 22.
   b. Join the results of Rx90 with Patients64—join by PatientId—to create Rx90for64
3. Create set of providers with 100 or more scripts
   a. Use Event Count to count the scripts in Rx90for64, group by prescribing provider id

### Set Rules

Specifying a KPI is all about defining sets and specifying how those sets should be combined to create the final results sets for Denominator, Exclusions and Numerator. The Claim type rules described above can bring back results sets. But those results sets can only be acted upon or manipulated if the results sets are contained with a defined set. The set rules describe how to create, manipulate and combine results set.

Sets are nested within the overall parent set—Denominator, Exclusion or Numerator sets. The following diagram illustrates how a measure is built from a network of defined sets. There is no limit to the level of nesting of sets. The results set contained within a set are the rows from the first declared component set within the set—filtered by any subsequent declared sets or rules.

### Define Set Rule

Rule Description: The Define Set rule enables the specification of a set as a container object. The set will hold the contents of the results from the rules or sets that are contained within the set. If the results from a rule are to be used as input to another rule then the results must first be contained within a defined set. Set contents are created by adding rules to the set—including other Define Set rules to create sets within a set.

Parameters

The parameters 2325 for a set describe the set and describe how the contents of the set should be combined together, as shown in the screen shot 2300 of FIG. 23 and Table 19.

Results

The resulting columns for the set depend on the components of the set. A set will have exactly the same set of columns as in the first declared component set within the set. If the first declared set is a claim set it will have the same columns as the claim rule results.

### Use Set Rule

Rule Description: The Use Set rule simply allows the results of a set already defined within the measure to be used again within the measure. The Use Set rule must target a set that is ‘earlier’ in the measure. Measure processing starts with the denominator set and proceeds through the sets in the order listed in the specification. The Use Set rule can be used within the Exclusion or Numerator or Provider Attribution to target a set already created in the Denominator.

Parameters

The Use Set rule requires the name of the previously declared set, as shown in Table 20.

Results

The columns for the results of the Use Set rule are the same as the columns returned for the input source set. If the input set is a claim set it will have the same columns as for the claim rules. If the input set is an event count set it will have the same columns as for the Event Count rule results set.

### Look Same Claim Rule

Rule Description: The Look Same Claim rule compares two sets, filtering Set A to only include those claim lines where the same claim number is also in Set B. This is similar to the Look Same Claim Line rule but less specific in requirement and the resulting set of claims are only required to actually match on the claim number. (Note that the same result can be achieved by joining two sets with a Join Rule of And, Join By Claim No.)

Parameters

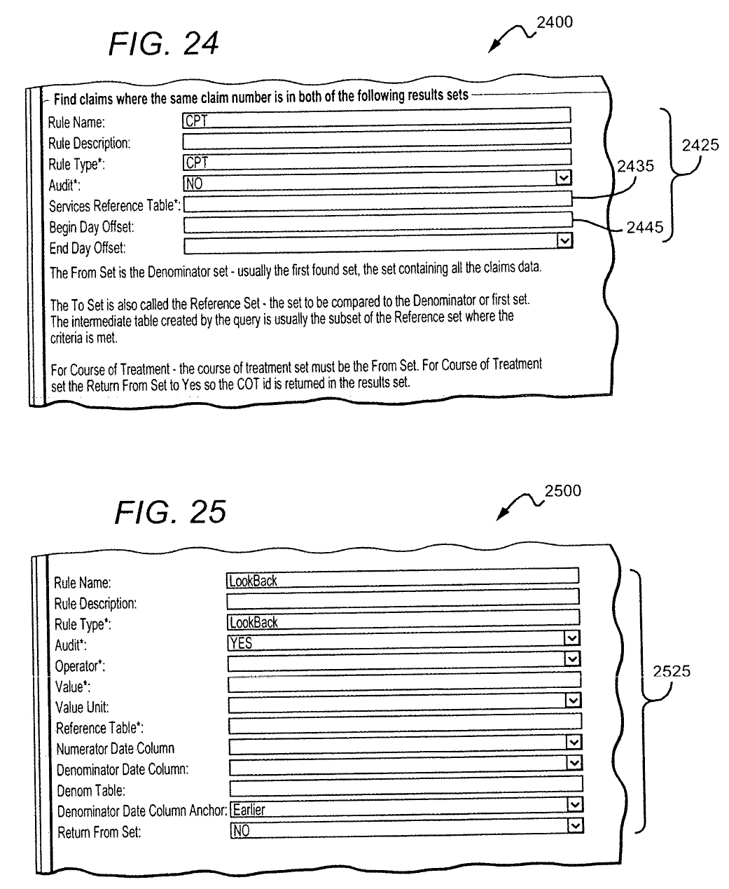

The Look Same Claim rule requires two input sets 2435 and 2445, along with the standard parameters 2425. For the Look Same Claim rule it doesn't matter very much which set is entered as the Set A 2435 set versus the Set B 2445 set, as shown in the screen shot 2400 of FIG. 24 and Table 21.

Results

The results from the Look Same Claim are the claim rows with the subset of claim columns returned as in the input claim sets.

Look Same Claim Usage Examples

A measure requires >/= to 1 PCP OR Specialist office visits for Dx of Chronic Bronchitis or COPD/emphysema, as shown in the following example:
1. Create a set for the office visits e.g OV
2. Create a set for the diagnoses e.g Dx
3. Create a set for the look same claim results
   a. Use Look Same Claim to find the Office Visit claims that have the diagnosis
      Note that in this case the results set will be the office visit claims because they are the reference set or Look To set. If this Look Same Claim results is joined to the other sets it would need to be joined by Claim Line to ensure that the results in the roll up set are the same as the results in the Look Same Claim set.

### Look Same Claim Line Rule

Rule Description The Look Same Claim Line rule compares two sets, filtering one set to only include those claim lines where the exact same claim line is also in a second set. (Note that the same result can be achieved by joining two sets with a Join Rule of And a Join By Claim Line No.)

Parameters

The Look Same Claim Line rule also requires two input sets, as shown in Table 22. It does not matter which set is the declared as the First Set or Look To Set or Top Set and which set is declared as the Second Set or Look From Set or Bottom Set. The resulting set of claim lines is identical.

Results

The results from a Look Same Claim Line rule are claim rows with a subset of the claim columns.

### Look Specialty Rule

Rule Description: The Look Specialty rule can be applied as a filter to a target results set. The rule finds only those rows where the provider specialty is a match to one of a specified list of specialty values.

Parameters

The Look Specialty rule requires an input set as the target set to be filtered by provider specialty, as shown in Table 23. This set can be any set containing an MV_Provider_Id field.

Results

The results of the Specialty rule are the same columns as in the input which must be a claim set containing the subset of claim columns.

Look Specialty Rule Usage Examples

The HEDIS measure for Glaucoma screening requires one or more eye exams by an eye care professional—ophthalmologist of optometrist.
1. Create the set to hold the results e.g SpecialistExam.
   a. Create the set of eye exam claims e.g. EyeExam
      i. Use service codes for eye exams . . . CPT, ICD9Dx and also ICD9PX
   b. Filter the set of eye exams with the specialty rule.

### Look Back Rule

Rule Description: The Look Back rule is a date comparison rule. The rule provides the capability for filtering a set of claims based on whether events in a set happened within a specified time frame of an event in a second set.

Parameters

The parameters 2525 of the Look Back Rule follows the basic syntax of Look Back FROM (Set B, Bottom Set, Denominator Set) TO (Set A, Top Set, Numerator set) to find events in Set A that happened within required timeframe of the Set B event, as shown in the screen shot 2500 of FIG. 25 and Table 24.

Results

The results for the Look Back rule depend on the input sets and the requested return set. If the input reference set is a claim set and the reference set is returned then the results are also claim rows. If the input denominator set is a Patient set, for example, a birthday set, and the return set is also the Patient set then the results set is a patient set.

### Look Forward Rule

Rule Description The Look Forward rule is a date comparison rule. The rule provides the capability for filtering a set of claims based on the whether other events in a second set happened within the specified time frame.

Parameters

The Look Forward Rule, which is similar in form to the Look Back Rule shown in FIG. 25, follows the basic syntax of Look Forward FROM (Set B) TO (Set A) to find events in Set A hat happened within required timeframe of the Set B event, as shown in Table 2S.

Results

The results for the Look Forward rule depend on the input sets and the requested return set. If the input reference set is a claim set and the reference set is returned then the results are also claim rows. If the input denominator set is a Patient set, for example, a birthday set, and the return set is also the Patient set then the results set is a patient set.

### Look Same Day

Rule Description: The Look Same Day rule is a simple date comparison rule that compares events in one set to events in another set to find the events in the first set that occurred on the same day as events in a second set.

Parameters

The Look Same Day Rule follows the same basic syntax as the Look Back and Look Forward rules. Look FROM (Set B) TO (Set A) to find events in Set A hat happened on the same day as the Set B event, as shown in Table 26.

Results

The results for the Look Same Day rule depend on the input sets and the requested return set. If the input reference set is a claim set and the reference set is returned then the results are also claim rows. If the input denominator set is a Patient set, for example, a birthday set, and the return set is also the Patient set then the results set is a patient set.

### Look Between

Rule Description: The Look Between rule finds all events that occur between dates on the same anchoring event. Typically this is used to find events that occurred during an inpatient stay with the admit date and the discharge date for the same inpatient stay claim being the dates to look between.

Parameters

Like other Look rules this rule requires two input sets where the top set are the events being looked for and the bottom set contains the anchor event that defines the dates being looked between, as shown in Table 27

Results

The results for the Look Between rule depend on the input sets and the requested return set. Typically the results will be a claim set since a claim is the input denominator set and claims are usually the target events for the reference set.

### Look Back Active Rx History

Rule Description: The Look Back Active Rx History rule looks back from a set of events to find the prescriptions that are active within a specified time window. An active prescription is a prescription issued during the specified time window or a prescription issued prior to the specified time window but with sufficient days supply that treatment could be continuing into the specified time window.

Parameters

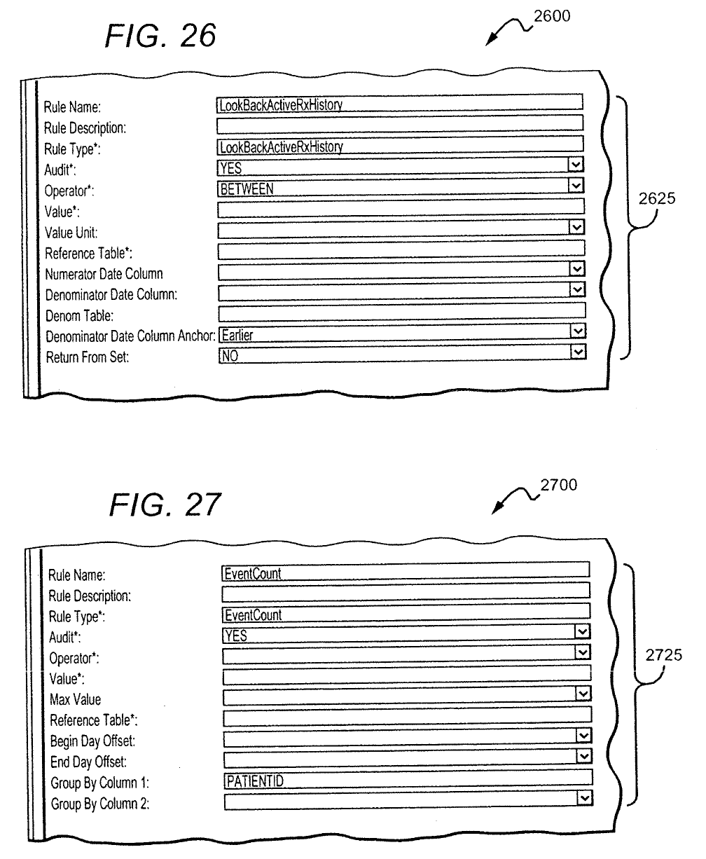

The parameters 2625 of the Look Back Active Rx History rule requires two input sets—both the anchor event set which contains the event to be looked back FROM and also the set containing the prescriptions that is being looked TO, as shown in the screen shot 2600 of FIG. 26 and Table 28.

Results

The results from the Look Back Active Rx History rule depend on the input sets and the requested returned sets. Typically the results will be the prescription claim rows that define the ‘active prescription claims’ together with the Days Supply value.

### First Event Rule

Rule Description: The First Event rule finds the first event for any patient in a target set.

Parameters

This rule requires an input or target set which is typically a claim set, as shown in Table 29.

### Look Same Provider

Rule Description: The Look Same Provider rule compares two sets to find the events in the first set that have the same provider as events in a second set. Only if the provider is also in the second set will the events or rows in the first set be in the results set.

Parameters

The Look Same Provider requires two input sets, as shown in Table 30.

Results

The results of the Look Same Provider rule depend on the contents of the input sets and the selected return set. Usually the results will be the set of claims that meet the required provider criteria.

Look Same Provider Usage Examples

A measure requires that an office visit with a provider in the numerator of the measure be with a prescribing provider who prescribed the medication for the patient in the denominator.
1. Create the set of prescription claims for the denominator drug e.g. RxADM
1. Create the set of follow up office visits e.g. OVFollowUP
2. To confirm that one of the follow up visits was with a provider who prescribed in RxADM

### Calculation Rules

The Calculation rules count events or perform calculations on input values

### Event Count

Rule Description This rule is used to count all the rows for a particular grouping in a target set. This rule can be used to count the claims for a particular patient e.g to find patients who have more than 2 office visits. This rule can also be used to ensure that the count is for different dates of service.

Parameters

The parameters 2725 of the Event Count rule requires a single input set or target table as it is going to count the designated rows in the input set, as shown in the screen shot 2700 of FIG. 27 and Table 31.

Results

The Event Count rule results set has the following fields and values available for joining with other results sets, as shown in Table 32.

Event Count Usage Examples

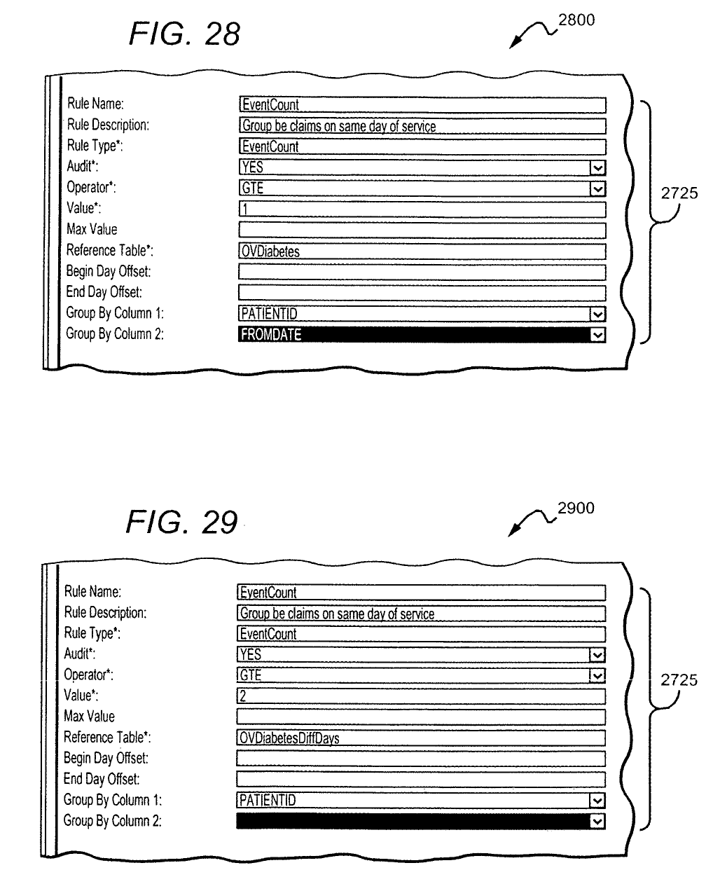

Measure calls for >=2 office visits for diabetes Dx on different dates of service in an outpatient setting.
1. Create the set for the office visits e.g. OV
2. Create the set for diabetes diagnosis e.g. Diabetes
3. Create the set for LookSameClaimLine for office visits with diabetes e.g. OVDiabetes.
   The OVDiabetes set is the set of claims for the Event Count. Since the requirement is to count the claims on different days of service the first step is to collapse the claims to ensure the count will be counting different dates of service.
1. Create set for OVDiabetes on different dates of service e.g. OVDiabetesDiffDays, as shown in the screen shot 2800 of FIG. 28.
   a. Use Event Count rule with a grouping by patient id and from date.
2. Create set to count the office visits with diabetes that occurred on different days e.g. Patients>2Visits, as shown in the screen shot 2900 of FIG. 29.
3. Join the original OVDiabetes set using AND with the Patients>0.2Visits set. This will filter the OVDiabetes set to only include those patients who had the requisite 2 visits.
   In another embodiment, a measure calls for the elimination of providers who have prescribed less than 100 scripts in the last 90 days of the measurement year.
1. Create the set for the scripts in the last 90 days of the year e.g. Rx90
   a. Use AnyRx event to find the scripts
2. Create set for providers who have more than 100 scripts, as shown in the screen shot 3000 of FIG. 30.
   a. Use Event Count to find providers with more than 100 scripts.

### Number of Prescriptions

Rule Description: The Number of Prescriptions is very similar to Event Count in that it simply counts the number of prescription claims in a target set.

Parameters

Number of Prescriptions requires a single input set or target table as it is going to count the rows for each patient in the claims in the input set.

Results

The Number of Prescriptions rule results set has the following fields and values available for joining with other results sets, as shown in Table 34. Note that only patients meeting any required value criteria will be in the results set.

Number of Prescriptions Usage Examples

A measure calls for >=2 prescriptions for a particular drug.
1. Create the set of claims for the prescriptions e.g Rx
   a. Use NDC rule type to find the prescription claims
2. Create the set to find patients with more than 2 Rx claims
   a. Use Number of Prescriptions

### Prescription Quantity

Rule Description This rule is used to sum the days supply from multiple prescriptions claims. The rule can be used to calculate the sum value or can be used to find patients who meet a specific total days supply criterion. Note that this rule only counts days supply—and does not count any other type of value unit such as # of pills or # of refills.

Parameters:

Prescription Quantity requires a single input set or target table as it is going to sum all the days supply for each patient in the claims in the input set, as shown in Table 35.

Results

The Prescription Quantity rule results set has the following fields and values available for joining with other results sets, as shown in Table 36.

### Prescription Quantity Usage Examples

Find patients who have received more than 135 days supply of a statin.
1. Create the set to hold the results—patients with 135 days supply of a statin e.g. Rx135. Join using Patient Id and Join Using AND
   a. Create the set of claims for the statin drug e.g. RxStatins
      i. Use NDC event rule to find the prescription claims
   b. Create set to hold results of prescription quantity e.g. RxQty
      i. Use the Prescription Quantity event rule. This will find the patients whose days supply is greater than or equal to 135 days.
         In another embodiment, the HEDIS 16 specification for asthma medications defines a ‘dispensing event’ as one of the following:
         One prescription lasting 30 days or less. If a prescription is more than 30 days—divide by 30 and round down. For example, a 100 day prescription qualifies as 3 separate ‘dispensing events’
         The first step is to calculate total days supply for patients who have received oral asthma medications in order to then divide by 30.
1. Create the set to hold the results
   a. Create the set for oral asthma claims
      i. Use NDC event rule to find the claims for oral asthma medications e.g RxOrals
   b. Create the set for the prescription quantity results e.g RxOralQty (non mainstream set)
      i. Use Prescription Quantity rule to sum the oral asthma medications.
         The results set from the prescription quantity rule can be used as the input set to the Calc Set rule in order to calculate the ‘dispensed events’
c. Create the set for the Calc Set results (non mainstream set)
   i. Use Calc Set Rule to calculate dispensed events by dividing the total days supply count by 30. The output set includes a value for the dispensed events.
      For a full description of the usage of Calc Set—see the Calc Set rule.

### Calc Set

Rule Description: This rule is used to perform calculations on the results of an event count to create a new ‘count’ value. This rule may be used to combine and count different permutations or combinations of events.

Parameters

Calc Set can be used to operate on and create a new value from a single input or target set. Calc Set can also be used to combine values from two input or target sets. The input sets must have a VALUE column. Typically the input sets would be the results sets from an Event Count rule or from a Prescription Quantity rule, as shown in Table 37.

Results

The Calc Set rule results set has the following fields and values available for joining with other results sets, as shown in Table 38.

### Calc Set Usage Examples

HEDIS 16—Use of Appropriate Medications for People with Asthma is an example measure requiring this functionality. The HEDIS specification for the denominator requires that a patient meet at least one of four criteria in BOTH the measure year and the year prior to the measurement year and they need not meet the same criteria in each year.
The four types of criteria are:
1. At least one ED visit with asthma as the principal diagnosis
2. At least one acute inpatient discharge with asthma as the principal diagnosis
3. At least four outpatient asthma visits with asthma as one of the listed diagnoses AND at least 2 asthma medication dispensing events
4. At least 4 medication dispensing events (unless solely leukotriene modifiers).
   The HEDIS specification also defines a ‘dispensing event’ as one of the following:
One prescription lasting 30 days or less. If a prescription is more than 30 days—divide by 30 and round down. For example, a 100 day prescription qualifies as 3 separate dispensing events'
2 different Rx prescriptions dispensed on the same day are counted as 2 different events. (Which suggest that a total count of days supply across all drugs is OK to calculate the dispensed events)
Inhalers count as a dispensing event but multiple inhalers of the same medication, filled on the same date of service should be counted as one dispensing event (So for inhaled drugs we would need to group by date of service before counting the number of prescriptions.)
   A further complication is that if a member qualifies for persistent asthma because of 4 dispensing events where the dispensing events were solely for leukotriene modifiers then the member must meet any of the other three criteria in the same year as the leukotriene modifiers.
   This example describes how to calculate the “4 dispensing events’ criteria and how to distinguish the leukotriene only dispensed events.
Calc Set is used to turn the days supply into a count of ‘dispensing events’.
Calc Set is also be used to combine the different types of dispensing events into a single total count of dispensed events.
   To calculate the count of dispensed events for the drugs that are not leukotriene modifiers:
Create set for oral asthma claims—non leukotriene modifiers e.g. RxOrals
   Use NDC event rule to find the claims for the non leukotriene oral asthma medications
Create set for the prescription quantity e.g RxOralQty
   Use Prescription Quantity rule to sum the asthma medications days supply
Create set for the Calc Set results e.g. RxOral—Count
   Use Calc Set rule to calculate total dispensed events by dividing the days supply count by 30. The output set includes the value of dispensed events.
      To calculate the count of dispensed events for the leukotriene modifiers
Create set for leukotriene modifiers e.g. RxLM
Create set for the prescription quantity e.g RxLMQty
   Use Prescription Quantity rule to sum the leukotriene modifier days supply
Create set for the Calc Set results e.g RxLM—Count
   Use Calc Set rule to calculate total dispensed events by dividing the days supply count by 30. The output set includes the value of dispensed events.
      To calculate the count of dispensed events for the Inhalers
Create set for the inhaler prescription events e.g. RxInhalers
   Use NDC event rule to find the inhaler prescription claims
Create set to group inhaler counts by same day of service e.g. InhalersDiffDays (non mainstream set)
   Use Event Count rule and group by patient id and from date
Create set to count inhalers on different dates of service e.g. Inhaler-Count
   Use Event Count rule on InhalersDiffDays set to count inhalers prescribed on different days.
      To calculate the total number of dispensed events
Create set to find add all oral dispensed events e.g AllRxOral-Count.
   Use Calc Set to sum the RxOral-Count set and the RxLM—Count set.
Create set to find total dispensed events e.g AllRxEventsCount
   Use Calc Set to sum the AllRxOral-Count with the Inhalers-Count
      To find patients who have dispensed events that are only leukotriene modifier dispensed events
Create set to find patients who are NOT only leukotriene modifier dispensed events.
   Create set to count non-LM events
      Use Calc Set to minus the LM dispensed events from all dispensed events. (If resulting Value is greater than 0 then patient is not purely on leukotriene modifiers)
   Create set to filter patients>0
      Use TotalValue rule to filter patients>0
         For a full description of the usage of the Total Value rule—see Total Value rule.

### Total Value

Rule Description: This rule is used to group rows in a target set and sum the value in the value column. This rule can be used to sum a Value in a claims set, for example to sum the value for treatment days. This rule can be used to sum filter values in event count sets, for example to find patients with 4 or more dispensed events.

Parameters

Total Value requires a single input set or target table as it is going to sum the values in the Value column for the designated grouping, as shown in Table 38.

Results

The Event Count rule results set has the following fields and values available for joining with other results sets, as shown in Table 39.

Total Value Usage Examples

Measure calls for >=135 treatment days. The first step is to calculate the treatment days using the Calc Treatment Days rule. Then the Total Value rule can be used to find the patients who have more than the required 135 treatment days.

Create the set for the Rx claims e.g. Rx

The Rx set is the set of claims for the Treatment Days calculation.

Create the set for the Treatment Days results.

Use Calc Treatment Days to sum the treatment days.

Create set for the value.

In another embodiment, find patients with 4 or more dispensed events.
To calculate the total number of dispensed events
1. Create set to find add all oral dispensed events e.g AllRxOral-Count.
   a. Use Calc Set to sum the RxOral-Count set and the RxLM—Count set
2. Create set to find total dispensed events e.g AllRxEventsCount
   a. Use Calc Set to sum the AllRxOral-Count with the Inhalers-Count
      To find patients who have 4 or more total dispensed events
3. Create set to define patients with 4 events e.g. Dispensed4.
   a. Use Total Value to filter the patients from the results of the Calc Set

### Calc Treatment Days

Rule Description This rule is used to calculate the total sum of treatment days in the claims in the target set. This rule is similar to the Look Back Active Rx History rule which finds all active prescription claims between an anchor event in the denominator set and the specified time window. Instead of finding the claims the rule sums the treatment days on the claims.

Parameters

Calc Treatment Days is going to find the events that are between an anchor event and a specified amount of time and sum the treatment days so the input set is the set containing the anchor event and the set containing the prescription claims, as shown in Table 40.

Results

The Calc Treatment Days rule results set returns the claims with the calculated treatment days and has the following fields available for combining with other sets. If the Earlier or Later options are chosen and Return From Set is set to yes then only one claim per patient is returned, as shown in Table 41.

Calc Treatment Days Usage Examples

The HEDIS AMM measure requires that the patients receive at least 84 ‘treatment days’ for antidepressants during the 114 days following the index prescription date which is itself the first prescription for AMM drugs after the index episode start date. The index episode start date is the first or earliest encounter with a qualifying major depression diagnosis (with a 120 days negative diagnosis history).
1. Create the depression and diagnosis denominator set e.g LSCDepressionOV
   a. Create set for depression diagnosis
   b. Create set for OV diagnosis
   c. Join depression and OV set to create encounter plus diagnosis set
2. Identify patients who filled a prescription for AMM drugs within 30 days before the index episode start date to 14 days after the index episode start date and also find the index prescription event.
   a. Create the set of prescription events e.g. RxAMM for the intake period
   b. Create the set of patients with prescriptions in the required time window
      1. Use the Look Back from LSCDepressionOV 30 days to find prescriptions before the index episode
      2. Use the Look Forward from LSCDepression 14 days to find prescriptions after the index episode
      3. Combine Look Back and Look Forward claim results sets e.g RxStart
3. Create the Calc Treatment Days results set e.g. TreatmentDays.
   a. Use the Calc Treatment Days rule to sum the treatment days in the claims set that occur within 114 days of the index prescription date.
      Now find the patients who met the criteria for total treatment days using the Total Value rule.

### Length of Stay Rule

Rule Description: This rule calculates the length of stay or number of inpatient days as the count of days from admission date to discharge date (Admiffromdate_or_fromdate-admitthrudate_or_thrudate+1) and filters the input set to create a results set of events meeting the length of stay criterion.

Parameters

This rule requires an input or target set which contains the inpatient claims, as shown in Table 42.

Results

The results of the Length of Stay rule are the claim rows in the input set that satisfied the length of stay criteria.

### Course of Treatment Rules

Clinical measures either measure one occurrence or treatment opportunity for a single patient or measure multiple occurrences or treatment opportunities for the same patient. “Course of treatment” is the MV term for a clinical event that may occur more than once to the same patient and a course of treatment measures counts all occurrences in a denominator and tests all occurrences in the denominator for the numerator criteria.

Examples of repeating multiple occurrences or treatment opportunities would be short lived acute conditions such as acute sinusitis or URI (colds) that can occur many times to the same person in a year. Pregnancy is another repeating occurrence that can happen more than once to a person in a three year measurement period. Another type of multiple event would be recommended annual screenings that should happen more than once in a three year measurement period e.g. PAP, mammograms. Even some surgeries could occur more than once—hip replacements, knee replacements, broken bones etc.

Another feature of a ‘course of treatment is that the measure may apply to a specific event in an anticipated sequence. In other words, the appropriate treatment differs at different times during the course of the clinical issue. In the acute sinusitis due to a cold, an antibiotic is not appropriate at onset but may well become appropriate if it continues. This means that a ‘course of treatment’ includes the identification of a specific event within a sequence

If a measure states that the intent of the measure is to measure multiple occurrences for a single patient then the measure is a Course of Treatment measure.

Examples of course of treatment measures:
1. HEDIS FUH which requires follow up for patients after an inpatient stay for mental illness is based in discharges not patients
2. ENT-1 below which measures No antibiotics within first 5 days of an acute sinusitis episode measures episodes defined by a clear window.
3. A measure which requires lab tests for each quarter of warfarin treatment is a course of treatment by time measure.

Course of Treatment measures take a target set of events and divide those events into separate courses of treatment. The target set of events can be divided by either a ‘clear window’ between events of the same type or can be divided into equal time periods.

A Course of Treatment set is different from other sets because it contains the Course of Treatment id and course of treatment flag information. It is vital that the Course of Treatment id information remain tagged to the patient throughout measure processing.

Many rules involve the comparison of sets e.g LookForward and LookBack In these comparison rules there is always a FROM Set and a TO Set. The LookForward and LookBack rules look From one set To the other set. The FROM set is also referred to as the Denominator set and the TO set is also referred to as the Reference set. By default the results of such a comparison are the items in the TO set.

For Course of Treatment measures, the COT set must be the FROM set and when there is a comparison it is necessary to specify that the desired results are in the FROM set.

This is done using the ReturnFromSet parameter.

### COT Event

Rule Description: The COT Event rule divides the input events into separate courses of treatment based on a clear window between events. The COT Event rule tags the claims or events with a Course of Treatment label or ID (COT Id). It is the combination of patient id and course of treatment idea which uniquely identifies the unit of measurement for inclusion in the denominator.

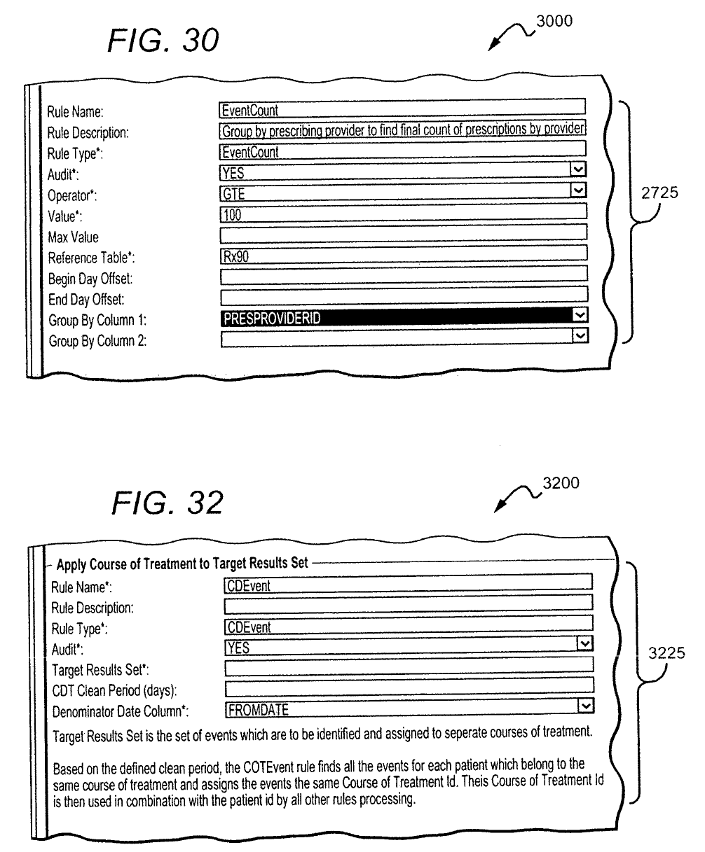

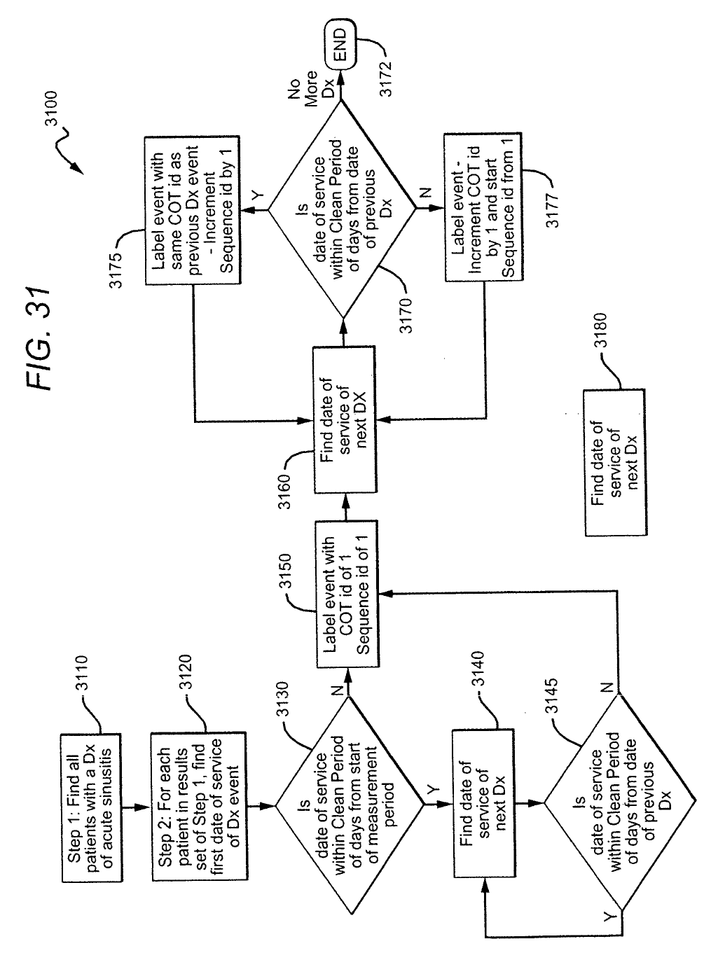

FIG. 31 indicates logically what the COT Event rule is doing through an example 3100. In step 3110, the rule finds all of the patients with DX of acute sinusitis. In step 3120, for each patient in results set of step 3110, find the date of service of the first DX event. Step 3130 asks “is the date of service within Clean Period days from start of measurement period?”. If yes, then Step 3140 finds the date of service of next DX and then asks in Step 3145 “Is the date of service within Clean Period days from date of previous DX?”. If yes, then the rule returns to step 3140. If the answer is no after step 3130 or 3145, then step 3150 labels the event with COT ID of 1, Sequence ID of 1. In step 3160, the date of service of next DX is found, followed by step 3170, where the question is asked “Is the date of service within Clean Period days from date of previous DX?”. If there are no more DXs, then the rule ends 3172. If the answer is yes, then step 3175 labels the event with same COT ID as previous DX event—increment Sequence ID by 1. If the answer is no, then step 3177 labels the event by incrementing the COT ID by 1 and starting the Sequence ID at 1. In step 3180, the date of the service of the next DX is found and the rule continues.

Parameters

The parameters 3225 of the COT Event rule requires a target claim or event set to operate on as it is going to divide the events into separate course of treatment based on the declared clean period, as shown in the screenshot 3200 of FIG. 32, Table 43 and Table 44.

Results

The results set is the set of claims labeled with:
A COT id number.
A COT event flag=1 if the event is the first event and NULL if the event is not the first event in the course of treatment
A GapCnt to show the calculated number of days since the prior event.
   Note: GapCnt calculates the gap between the FromDate of one service event in the diagnosis set to the From Date of the next service event in the diagnosis set
   Note: The COTEvt flag=1 is assigned to the first event found by COTEvent.

### First COT Event

Rule Description: The FirstCOTEvent rule selects only the first events from a previously create Course of Treatment (COT) set.

Parameters

The First COT Event only requires one parameter which is the previously created Course Of Treatment set where the first events were already identified, as shown in Table 45.

Results

The results of First COT Event are the claim rows that correspond to the first events in each course of treatment (one event or row per patient id/COT id combination)

### Most Recent COT Event

Rule Description The Most Recent COT Event rule selects only the last events from a previously create Course of Treatment (COT) set, as shown in Table 46.

Parameters

The Most Recent COT Event only requires the previously created Course Of Treatment set and the date to use in calculating the most recent event.

Results

The results of Most Recent COT Event are the claim rows from the input COT set that correspond to the last events in each course of treatment (one event or row per patient id/COT id combination)

### Member Rules

Patient rules find patients who meet criteria not based on claims or services. These criteria are demographic or enrollment criteria

### Member Age/Sex

Rule Description The MemberAge/Sex rule enables the creation of a results set of patients defined purely by age and/or sex criteria. This rule is needed in measures which create a denominator based on demographics only. Contemplated parameters 3325 are shown in the screen shot 3300 of FIG. 33.

Results

The result of the Patient Age/Sex rule is a set of patients together with the values for age and sex, as shown in Table 47.

### Rx Benefits

Rule Description: The Rx Benefits rule specifies if the denominator patients must be eligible for prescription benefits to qualify for the measure.

Parameters

This rule is a simple Yes No flag. If Drug Benefits are irrelevant then the value can be No.

If the measure does not explicitly require Drug Benefits, the measure specification should be inspected to see if it implicitly requires Drug Benefits. If there is no requirement in Denominator, Exclusions or Numerator that is related to a prescription then this value can be No.

No means that Drug Eligibility is not a requirement, it doesn't mean that patients with Drug Benefits will no longer qualify for the measure.

### EM Visits

Rule Description The EM Visits rule specifies if patients have to have had a global Evaluation and Management visit for the patient to qualify for the measure. Like the Rx Benefits rule, this rule references an external table or permanent set. Most measures have specific office visit criteria within the measure. For some clients this is not a requirement—see Business Rules to see if a global E&M visit is required in addition to other measure criteria.

Parameters

This rule is a simple Yes No flag. If global E&M visits are not a requirement then the value can be No.

EM Visits: [YES/NO] (Defaults to N if left blank)

### Continuous Enrollment

Rule Description The Continuous Enrollment rule specifies the member enrollment requirements for qualification of the member in the Denominator of the measure. More than one continuous enrollment rule can be used in combination—for example if the gap allowed is different before the anchor event compared to after the event.

Parameters

Continuous enrollment specifies the anchor event, the required time for enrollment from the anchor event and any allowed gaps, as shown in Table 48.

### Continuous Enrollment Usage Examples

It is essential to specify the measure in such a way that there is a set of claims that define the continuous enrollment requirements. For example, the continuous enrollment requirements are often an office visit with a specialist with a diagnosis on the same claim. This needs to be coded as follows:
1 Define a set of where the claim is for an office visit—Office Visits. Since this is the first set defined this will be the set of claims held within the Global Denominator set and the default set used for continuous enrollment.
2 Define a set where the Office Visits are with a particular specialist—OvwithSpecialist. This will find all office visits with a particular specialist and then cross reference the Patients to remove Patients from the Global Denominator Set.
3 Define a set for the required diagnosis—DX
4 Define a set for Look Same Claim—where the FROM (Denom) table is DX and the TO (Reference) table is the Ovwith Specialist. This will filter the OV with Specialist claim set to only those claims which also have the diagnosis attached.
5 The LookSameClaim set will filter the Global Denominator set by removing PATIENTS who do not have a LookSameClaim of OV with diagnosis.
6 Define Continuous enrollment using the LookSameClaim set as the anchor set. This is the only set where the claims are all for OVwithSpecialist filtered by the diagnosis occurring on the same claim. This will be correct anchor date.

If the LookSameClaim is not created as a set but simply used as a Criteria on the Global Denominator then there is no set that correctly holds the anchor date as the first claim date for the patient. Only the first patient claim is tested for continuous enrollment.

Continuous enrollment requirements of the patient are stated in the CBR either implicitly or explicitly. When it has been stated explicitly, one must code the look back and look forward criteria from the specified starting point.

If not stated explicitly in the CBR one must assume a starting point event. The first Office Visit with diagnosis should be used if there are no other clear instructions. There are scenarios where the “index” event for continuous enrollment is actually not the first event in a single results set. For example, E-13 is looking for patients with a dual diagnosis of diabetes and HTN. The requirement is that there is an office visit for BOTH diagnoses—but not necessarily at the same time. The index event is the later of the two events. Continuous enrollment can be specified using more than one defined set. Simply specify both sets and then the later date is automatically selected.

HEDIS considers each calendar year to be a separate enrollment year, so it allows a 45 day gap in each complete measurement year. A single gap of 90 days that spans the calendar year is actually considered by HEDIS to be two gaps of 45 days each and the gap is allowed because gaps are calculated per calendar year. The HEDIS breast screening measure which allows for a 2 year measurement period can be specified.

### Provider Attribution Rules

KPI Processing first identifies which patients satisfy the denominator or numerator requirements. Once the patients who qualify for denominator and numerator have been identified they are then assigned to providers for reporting clinical quality by provider and by specialty. The Provider Attribution rules define the eligible providers.

Like Patients, the Providers are defined by creating Provider sets and then combining those Provider sets with other sets or other provider rules to define the final Provider set.

Provider sets may be defined using a specific Denominator set as the target set, using All denominator sets as the target set or by using the Global encounter table as the target set for providers.

### Provider Type Rules

There are a couple of basic filters for provider assignment.

Participating Providers only:
If Yes, only providers with a parstatus of Yes will be allocated a measure
If No, then current participation does not matter for purposes of the measure Provider Type:
MD type indicates a doctor
Rx indicates a pharmacy
HS indicates a hospital
IL indicates a Lab or other service facility.
   For provider assignment typically we only support providers of type MD on the service. Note that the actual provider types that are considered to be of type MD are defined in the client properties table.

### Select Set

Rule Description: The Select Set rule enables the selection of a single specific set in the Denominator as the source for the providers to be attributed to the measure. Typically, in a measure requiring an office visit together with a diagnosis, the office visit and diagnosis Look Same Claim Line set would be the source set for provider attribution.

Parameters

The Select Set rule requires the name of the target or input set that contains the desired providers, as shown in Table 49.

Provider Assignment Select Set Usage Example

Many measures require that a patient have a diagnosis and an office visit for the diagnosis. If the provider attribution rules are to assign the patient to the provider who provided the specific set of denominator requirements then the following is required
1. Open Provider set (default is Any Providers)
2. Delete any existing set where definition is Use All Sets
3. Use drop down menu to select the Select Set rule.
4. Open Set
   a. Create name for set
   b. Choose correct field for Provider (ProviderId or Prescribing ProviderId etc)
   c. Enter the target set name e.g SameClaimVisit as the target table for the providers.

### Use All Sets

Rule Description: The Use All Sets uses all the sets created in the denominator as the source for provider attribution. Contemplated parameters are shown in Table 50.

### Use Services

Rule Description: The Use Services set uses the providers in the Global Encounter table that are paired with the patients in the denominator as the source for provider attribution. Contemplated parameters are shown in Table 51.

### Provider Specialty

Rule Description: This rule enables the filtering of a provider set by provider specialty. Unlike the Look Specialty rule which requires a claim set, this rule requires a provider set as the input or target set to be filtered by the specialty values. Contemplated parameters are shown in Table 52.

### Select Provider Set

Rule Description: This rule enables the selection of a provider set for combination with other sets. A provider set can be created using, for example, Count Event.

### MV Specialty Code Values

### A2 Adolescent Medicine

### 03 Allergy/Immunology

### 59 Ambulance

### 49 Ambulatory Surgery Center

### 05 Anesthesiology

### 64 Audiologist

### 78 Cardiac Surgery

### 06 Cardiology

### CHR Chiropractor

### 89 Clinical Nurse Specialists

### 28 Colorectal Surgery

### 81 Critical Care/Intensivists

### 43 CRNA

### 07 Dermatology

### A3 Developmental Pediatrics

### 30 Diagnostic Radiology

### 23 Dialysis Center

### 51 DME

### 93 Emergency Medicine

### 46 Endocrinology

### 08 Family Practice

### 10 Gastroenterology

### 02 General Surgery

### 38 Geriatric Medicine

### 70 Group Practices

### 98 Gynecology/Oncology

### 40 Hand Surgery

### 82 Hematology

### 83 Hematology/Oncology

### IT Home Infusion Therapy

### 99 Hospitals, CORFS, SNFS, HHAS

### 95 Independent Physiological Lab

### 44 Infectious Disease

### IP Infusion Pump Supplier

### 11 Internal Medicine

### 94 Interventional Radiology

### 85 Maxillofacial Surgery

### 90 Medical Oncology

### 09 Miscellaneous Provider

### NE Neonatology/Critical Care

### 39 Nephrology

### 13 Neurology

### 86 Neuropsychiatry

### 14 Neurosurgery

### 36 Nuclear Medicine

### 42 Nurse Midwife

### 50 Nurse Practitioner

### 16 Obstetrics/Gynecology

### OM Occupational Medicine

### 67 Occupational Therapy

### 18 Opthalmology

### OP Optician

### 41 Optometry

### 19 Oral Surgery

### 20 Orthopedic Surgery

### 12 Osteopath Manipulative Therapy

### 04 Otolaryngology

### 72 Pain Management

### 22 Pathology

### 01 PCP

### A4 Pediatric Allergy/Immunology

### A5 Pediatric Cardiology

### A6 Pediatric Dermatology

### A7 Pediatric Emergency Medicine

### A7 Pediatric Emergency Medicine

### A8 Pediatric Endocrinology

### A9 Pediatric Gastroenterology

### PH Pediatric Hematology/Oncology

### B3 Pediatric Infectious Diseases

### 37 Pediatric Medicine

### B4 Pediatric Nephrology

### PN Pediatric Neurology

### B6 Pediatric Pulmonary Medicine

### B8 Pediatric Rheumatology

### B7 Pediatric Surgery

### 25 Physical Med/Rehab

### 97 Physician Assistants

### 24 Plastic/Reconstructive Surgery

### 48 Podiatry

### 63 Portable Xray Supplier

### 84 Preventive Medicine

### PC Professional Counselor

### 26 Psychiatry

### 62 Psychologist

### 29 Pulmonary Medicine

### 92 Radiation Oncology

### 65 Registered Physical Therapy

### 66 Rheumatology

### 80 Social Worker

### SP Speech Pathology

### SM Sports Medicine

### 91 Surgical Oncology

### 33 Thoracic Surgery

### 88 Unknown

### 34 Urology

### 77 Vascular Surgery

### NULL NULL

### Example 3

### Testing and Auditing A Measure

Testing a measure demonstrates that the measure specification is getting correct results. The best demonstration involves running a measure against a test data set with a known target result and ensuring that the actual result matches the target. Test data sets need to be built. The software application described includes a component for generating a test data set with a known target result.

Auditing a measure examines all the steps involved in measure processing.
1. Testing the measure outcome during design and development to confirm the measure clinical logic
2. Explaining measure results for specific patients
   Testing a measure might involve some of the following scenarios or approaches to auditing a measure:
1. Conducting independent queries for a particular criterion and determining if row counts match. For example, if the measure requires that the a member be taking a particular prescription drug the user can run their own query on the services data to count the number of patients taking the drug and can compare the result directly to the audit trail to confirm that the same number of claims and patients were found by the measure during measure execution.
2. Confirming patient assignment to denominator, numerator or exclusion sets.
   a. This can be done in a forward looking way by identifying a patient in the claims data and examining the set of claims and enrollment data to see where they should be assigned and then confirming that the patient is in the correct set in the measure audit
   b. This can be done in a reverse way by selecting a patient in the denominator, exclusion or numerator sets and then examining the audit claims and actual claims to confirm that the measure is correctly assigning the patient.
      Explaining the results for a specific patient, for example a patient in a provider's patient registry, might involve the following scenario:
1. Look up patient in audit trail.
2. Identify the specific services that patient met e.g
   a. Patient has an office visit (CPT code) with a diagnosis of hypertension —ICD9 Dx code of, on date . . . .
      For each measure there are a number of raw output tables which log the measure results:
1. The KPI_Summary table logs the count of patients in the denominator, numerator and exclusions
2. The KPI_PatientDocPair table logs the assignment of patients to providers.
3. The KPI_Audit table is a log of every single event found during the execution of the measure, including all intermediate steps.
4. The KPI_Audit Agg table is a summary of the Audit Detail to show a count of audit events and a count of patients meeting each specific criterion of the measure.

### KPI_Summary Table

For measure CV-1, this table would be called CV1_Summary.

The KPI_Summary Table, one for each measure, logs the patient counts for the measure. These counts can be compared to expected results, for example if a test data set with a known expected result was the target data set.

| Column Name | Description |
|---|---|
| KPI | Unique identifier for the KPI being measured. |
| | This value is the same as the [ ] in the |
| | MV_MEASURE table in the measure library and |
| | is the stripped version of the |
| | Measure_Reference_Num e.g CV1 |
| DENOMINATOR_PATIENT_COUNT | This is the count of patients who qualified for the |
| | denominator of the measure, for example 94589 |
| NUMERATOR_PATIENT_COUNT | This is the count of patients who qualified for the |
| | denominator of the measure, for example 70335 |
| RATIO | This is the ratio of numerator to denominator, for |
| | example 0.7435854 |

### KPI_PatientDocPair Table

For measure CV-1, the table would be called CV1_PatientDocPair, which is the basic output from the patient attribution, one table for each KPI. Each unique patient in the denominator of the KPI is paired with one or more providers based on the patient attribution rules. This table contains a view for each patient/provider pair so there may be multiple rows for a patient depending on the patient attribution rules in place for the KPI. For measure CV-1, the table would be called CV1_Summary.

| Column Name | Description | Data Type |
|---|---|---|
| KPI | Unique identifier for the KPI being measured. This | |
| | value is the same as the [ ] in the MV_MEASURE table | |
| | in the measure library and is the stripped version of the | |
| | Measure_Reference_Num e.g CV1 | |
| MV_PATIENT_ID | The unique identifier for the patient from the Med- | Int |
| | Vantage schema. This is a Med-Vantage identifier and | |
| | not the same as the member id in the source data. | |
| COT | Unique integer value to identify the course of treatment | |
| | for the patient. If the measure is not a Course of | |
| | Treatment measure then this value is 0, the default. | |
| | MV_PATIENT_ID together with the Course of | |
| | Treatment (COT) number uniquely identify the | |
| | treatment opportunity which is the unit of observation | |
| | counted for the measure. | |
| MV_PROVIDER_ID | The unique identifier for the provider from the Med- | |
| | Vantage schema. This is a Med-Vantage identifier and | |
| | not the same as the ProviderId in the source data. | |
| SPECIALTY_CODE | The code value for the specialty of the provider. This is | |
| | a Med-Vantage identifier and not the same as the | |
| | Specialty code value in the source data. | |
| SPECIALTY_DESC | The text description for the specialty of the provider. | |
| | This is a Med-Vantage identifier and not the same as | |
| | the Specialty description value in the source data. | |
| PROVIDER_TYPE | Provider type e.g MD. Current patient attribution rules | |
| | only allow MD type providers to be assigned | |
| PARSTATUS | Parstatus flag where value of Y indicates a participating | |
| | provider. Current patient attribution rules require that | |
| | the provider is participating. | |
| ISNUMERATOR | Flag value Indicates if the patient qualified for the | |
| | numerator. | |

### KPI_Audit Table

Each measure or Key Performance Indicator (KPI) e.g CV-1 produces an audit detail table named [KPI]_Audit e.g CV1_Audit.

Each step of the KPI processing finds a claim or service that qualifies a patient for inclusion or exclusion in the denominator or numerator of the KPI. At each step of KPI processing the entire results set is copied to the audit tablebefore the next step of processing continues.

Each audit detail table has the following contents:

| Column Name | Description | Data Type |
|---|---|---|
| ID | The unique identifier for the audit file row. | int |
| KPI | Unique identifier for the KPI being measured. This value is | Varchar(255) |
| | the same as the [ ] in the MV_MEASURE table in the measure | |
| | library and is the stripped version of the | |
| | Measure_Reference_Num e.g CV1 | |
| CLAIMLINEID | A unique identifier for the row in the Services table which | int |
| Foreign Key: | holds all the claim data. This value is generated by | |
| Services | MedVantage and added to the services table prior to KPI | |
| | processing | |
| CLAIMNO | Copied from the Services Table. This is the claim number of | Varchar(45) |
| | the service claim that matched a specific measure criterion | |
| CLAIMLINENO | Copied from the Services Table. This is the line number of | Int |
| | the service claim that matched a specific measure criterion. | |
| SERVICEID | The unique identifier for the set of service codes being used | Int |
| Foreign key: | as a measure criterion. This is the foreign key to the | |
| Measure_Service | Measure_Service table Cross reference to the service code | |
| | table to get to actual codes used for the event. | |
| | May be null as not all measure criteria or rules are sets of | |
| | service codes. | |
| AUDITREASON | Identifies the type of rule being exercised. | Varchar(30) |
| | If the rule or criterion is based on a service code - the audit | |
| | reason will be one of the service code types e.g. ICD9-DX or | |
| | CPT or TCC. | |
| AUDITCOMPONENT | The measure term that the event applies to - D for | Varchar(30) |
| | Denominator, N for Numerator and E for Exclusions. See | |
| | MV_Measure_Component table. | |
| MV_PATIENT_ID | The unique identifier for the patient from the Med-Vantage | varchar(32) |
| | schema. This is a Med-Vantage identifier and not the same | |
| | as the member id in the source data. | |
| COT | Unique integer value to identify the course of treatment for | |
| | the patient. If the measure is not a Course of Treatment | |
| | measure then this value is 0, the default. MV_PATIENT_ID | |
| | together with the Course of Treatment (COT) number | |
| | uniquely identify the treatment opportunity which is the unit of | |
| | observation counted for the measure. | |
| COTGAP | Count of the number of days gap from the previous service | |
| | event. If the gap is larger than the clear window this will be | |
| | associated with a new Course Of Treatment (COT) number. | |
| SERVICEDATE | Date field for the date of service. | DateTime |
| REFDATE | Date field used when doing a date compare (lookback and | DateTime |
| | lookforward). Shows the value of the date in the reference set | |
| | (LookBack of LookForward from an anchor or index set to the | |
| | Reference) | |
| VALUE | Stores quantity values for service event criteria that are | int |
| | quantity based —for example Rx counts or days supply or | |
| | event counts or number of days enrolled | |

### KPI_AuditAgg Table

Each measure or Key Performance Indicator (KPI) e.g CV-1 produces an audit aggregate table named [KPI]_AuditAgg e.g CV1_AuditAgg.

The audit aggregate table is a count of the number of audit rows and the number of unique patients meeting each rule (or auditreason) in the measure.

| Column Name | Description | Data Type |
|---|---|---|
| ID | The unique identifier for the audit file row. | int |
| AUDITREASON | Identifies the type of rule being exercised. | Varchar(30) |
| | If the rule or criterion is based on a service | |
| | code - the audit reason will be one of the | |
| | service code types e.g. ICD9-DX or CPT or | |
| | TCC. | |
| AUDITCOMPONENT | The measure term that the event applies to - | Varchar(30) |
| | D for Denominator, N for Numerator and E for | |
| | Exclusions. See MV_Measure_Component | |
| | table. | |
| SERVICEID | The unique identifier for the set of service | Int |
| Foreign key: | codes being used as a measure criterion. | |
| Measure_Service | This is the foreign key to the | |
| | Measure_Service table Cross reference to | |
| | the service code table to get to actual codes | |
| | used for the event. | |
| | May be null as not all measure criteria or rules | |
| | are sets of service codes. | |
| AUDITROWCOUNT | Count of the number of rows in the audit table | |
| | meeting the auditreason or rule. | |
| PATIENTCOUNT | Count of the number of unique patients in the | |
| | audit table meeting the auditreason or rule. | |
| PATIENTCOTCOUNT | Count of the number of unique patient. COT | |
| | combinations in the audit table meeting the | |
| | audit reason or rule. For a Course of | |
| | Treatment measure this is the count of the | |
| | unit of observation for the measure. | |
| AUDITDETAIL | A generated text description of the measure | |
| | rule bein audited. | |

### Audit Views

An easy to read audit is enabled through pre-defined views which join the raw audit summary tables described above with the reference tables described above in order to provide an understandable record of measure processing events.

The auditviews available are:

1. KPI_DOCRATIOVW

2. KPI_PATIENTComplianceVW

3. KPI_PATIENTDOCPAIRVW

4. KPI_PATIENTexclusionVW

5. KPI_PATIENTNonComplianceVW

6. KPI_PatientRemoveVW

7. KPIAuditAggVw

### Row Counting Scenarios

In this scenario, it is assumed that the row counts or unique patient counts in the claims data for a particular criteria are known. The goal is to see at a glance if the measure executable is getting the same results for individual measure criteria
1. View the KPIAuditAggVW. This view contains all columns from the KPIAuditAgg table together with columns from the MV_SERVICE_KPI table for services in the audit aggregate table.
2. Sort by ID (in ascending order). This will ensure that the sequence of rows in the aggregate audit view is in the order or sequence of measure execution.
3. The Service Code table description and the AuditRowCount or the PatientCount (or PatientCOTCount if measure is a Course of Treatment Measure) can be viewed to compare to row counts or patient counts achieved through other queries.
4. One can also view the counts for the combined diagnoses set, the counts for the combined office visits set and the counts for the combination of diagnosis and office visits on the same claim line.

### Audit Reasons

Note—this table is for illustration purposes. The auditreasons are a growing set of designations and final accurate documentation for any audit reasons will accompany any audit aggregate table as part of the release package.

| Audit Reasons | Description |
|---|---|
| CPT | All of these audit reasons are service code types. This indicates that the measure is |
| CPT_MOD | looking for claims or services matching the specified service code table. |
| DISCHARGE | In the AuditAgg table this service id identifies the service code table. In the AuditAggVw |
| DRG | the specific Table Number and Table Name and Description are also available. |
| GCN | This allows an easy comparison of row counts for a service code table criterion. |
| ICD9-DX | |
| ICD9-PX | |
| NDC | |
| POS | |
| REVENUE | |
| TCC | |
| Formula | The Formula audit reason indicates that other criteria have been combined into a set and |
| | the row count and the patient count indicate the claims and the patients meeting the set |
| | criteria. |
| | The first Formula indicates the set of patients (and claims) meeting any one of the |
| | diagnosis critieria. The patient count is the sum unique patients meeting any of the |
| | diagnosis criteria. |
| LookSameClaimLine | This audit reason describes the criterion requiring a claim line to match more than one |
| | criteria. The typical use for the rule is to require a diagnosis and an office visit on the |
| | same claim line. |
| | The looksameclaim line is supported with additional information: |
| | Fromdate indicates that the date being used for the service date of the claim is the |
| | FromDate in the service claim. |
| | Refname indicates one of the sets of claims which is labeled PCP-Visit. |
| | DenomName indicates the other set of claims which is labeled CV-2-Denom and this is |
| | identified above as the set for the diagnosis. |
| LookSameClaim | Same as for the LookSameClaim except the rule requires that the different sets of patients |
| | match on claim number only, not exactly on claim line |
| LookSameDay | Same is for the LookSameClaimLine except the rule requires that the different sets of |
| | patients match on day of service. In the office visit and diagnosis example this is a count |
| | of claims and patients where the diagnosis and office visit occurred on the same day of |
| | service but not necessarily on same claim or same claim line. |
| LookBack | There are criteria which require that one service occur, or not occur, within some |
| | timeframe of another service for example, requiring that a lipid panel test occur within |
| | some months of an office visit for high risk diagnoses or requiring that a wrist splint be |
| | used before any surgery. |
| | The LookBack audit reason documents the findings from a LookBack rule which Looks |
| | Back from one specified patient claims set (Denomname set) to another specified patient |
| | set to find the same patient within the specified time frame |
| LookForward | There are criteria which require that one service occur, or not occur, within some |
| | timeframe of another service for example, requiring that a lipid panel test occur within |
| | some months of an office visit for high risk diagnoses or requiring that a wrist splint be |
| | used before any surgery. |
| | The LookForward audit reason documents the findings from a LookForward rule which |
| | Looks Forward from one specified patient claims set (Denomname set) to another |
| | specified patient set to find the same patient within the specified time frame. |
| | The LookForward rule is needed to find numerator criteria within some time frame after |
| | denominator criteria. |
| enrollment data | This audit reason documents the number of patients who were tested for the enrollment |
| | criterion |
| enrollment | This audit reason documents the number of patients who met the continuous enrollment |
| | criterion |
| drugbenefits | This audit reason documents the number of patients who met the drug benefit criterion |
| remove | This audit reason documents the number of patients removed from the denominator. |
| | Patients are removed if they meet exclusion criteria or fail the enrollment or drugbenefit |
| | requirements or do not meet all denominator criteria |
| final | This audit reason documents the number of patients whose ‘final’ designation is either |
| | Denominator, Exclusion or Numerator. |
| countdata | This audit reason documents the patients with any events who are the substrate set for an |
| | event count. |
| Count | This audit reason documents the patients meeting an kind of event count criterion value. |
| prescriptiondata | This audit reason documents the patients with any prescription quantity who are the |
| | substrate set for a count of prescriptions |
| prescription | This audit reason documents the patients meeting a prescription quantity requirement. |
| los | This audit reason documents the patients meeting a length of stay requirement. |
| specialty | This audit reason documents the number of claims and patients where the provider met |
| | any required specialty |
| provider | This audit reason counts the unique providers meeting any provider attribution rules for |
| | the measure. |

### Example 4

### Reporting

Contemplated rules-based software includes a number of predefined reports for analyzing measure results

| Report Name | Report Description |
|---|---|
| KPI Population by (Specialty) | This report provides raw numerator, denominator and KPI ratio results for |
| | each KPI in the specialty set of measures - by all MD specialties. This |
| | report can be used to determine if the measure should be applied to other |
| | specialties |
| Summary KPI Results (for Specialty) | Summarizes the num/den and ratio by KPI within the specialty set across |
| | all specialties at the total patient assignment level without sample size |
| | constraints. |
| KPIs By Providers (for Specialty) | This table lists all the providers who meet the designated sample size |
| | constraints e.g (n => 25) and meet the designated # of KPIs constraint e.g |
| | (=>4) and shows the count of KPIs and shows the numerator, |
| | denominator and ratio for each KPI for each provider. The providers in |
| | this table are providers with the target specialty of the KPI set |
| KPIs By Provider (ALL Specialties) | Same as for specialty except that all providers from any specialty meeting |
| | the sample size constraints are listed. |
| (KPI Id) Results By Provider | This report is created for each KPI in the specialty set and lists all |
| | providers in the target specialty. This report calculates the specialty mean |
| | ratio where the min ratio is the smallest ratio for provider (meeting |
| | minimum sample size requirements) and the max ratio is the largest ratio |
| | for provider (meeting the minimum) sample size requirements. This table |
| | is descriptive only - not used for input to CQI calculations. |
| (KPI Id) Histogram | This report is created for each KPI in the specialty set and uses source |
| | data from QSREP23. Uses n >= 25 for cut off |
| Specialty Score KPI | e.g. CVSpecialty_Score_KPI. This report is created for the KPI specialty |
| | set and shows the distribution of point scores for each KPI including the |
| | number of doctors with the PNR score. Providers are of the same |
| | specialty as the KPI set. |
| CQI by Specialty Provider | Shows the calculation of the CQI for providers in the specialty. |
| Specialty_Score_CQI | e.g. CVSpecialty_Score_CQI shows the MD distribution of point scores by |
| | for all KPIs (CQI). This information is presented for the CQI for a |
| | specialty |
| CQI Specialty Chart | e.g. CV_CQI_Histogram contains descriptive statistics and distribution of |
| | the average KPI score across all KPIs. This information is presented for |
| | the CQI for a specialty |
| CQI Pearson Correlations | The variance-covariance matrix examines whether each pair of KPI |
| | measures are related (move together) - that is, whether large values of |
| | one variable tend to be associated with large values of the other (positive |
| | covariance), whether small values of one variable tend to be associated |
| | with large values of the other (negative covariance), or whether values of |
| | both variables tend to be unrelated (covariance near zero) |

Thus, specific embodiments and applications of rules-based software applications and methods for health care and evaluation applications and their uses have been disclosed. It should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

TABLE 1
Clinical Quality Best Practice - Source Reference Organizations

| Source | |
|---|---|
| Organization | Description |
| HEDIS | The Health Plan Employer Data and Information Set - HEDIS is a set of standardized |
| | performance measures designed to ensure that purchasers and consumers have the information |
| | they need to reliably compare the performance of managed health care plans. The performance |
| | measures in HEDIS are related to many significant public health issues such as cancer, heart |
| | disease, smoking, asthma and diabetes. HEDIS also includes a standardized survey of consumers' |
| | experiences that evaluates plan performance in areas such as customer service, access to care and |
| | claims processing. HEDIS is sponsored, supported and maintained by NCQA. |
| NQF | The National Quality Forum is a private, not-for-profit membership organization created to develop |
| | and implement a national strategy for healthcare quality measurement and reporting. |
| AMA | The American Medical Association (AMA)-convened Physician Consortium for Performance |
| | Improvement ® (Consortium) is committed to enhancing quality of care and patient safety by taking |
| | the lead in the development, testing, and maintenance of evidence-based clinical performance |
| | measures and measurement resources for physicians. The Consortium is comprised of over 100 |
| | national medical specialty and state medical societies; the Council of Medical Specialty Societies; |
| | American Board of Medical Specialties and its member-boards; experts in methodology and data |
| | collection; the Agency for Healthcare Research and Quality; and Centers for Medicare & Medicaid |
| | Services. |
| AQA | The AQA Alliance (a coalition of the American Academy of Family Physicians (AAFP), the American |
| | College of Physicians (ACP), America's Health Insurance Plans (AHIP), and the Agency for |
| | Healthcare Research and Quality (AHRQ)), is a broad based collaborative of physicians, consumers, |
| | purchasers, health insurance plans and others, focused on: |
| | A set of measures for physician performance that stakeholders can use in private health |
| | insurance plan contracts and with government purchasers; |
| | A multi-year strategy to roll-out additional measurement sets and implement measures |
| | into the marketplace; |
| | A model (including framework and governing structure) for aggregating, sharing and |
| | stewarding data; and |
| | Critical steps needed for reporting useful information to providers, consumers and |
| | purchasers. |
| ACC/AHA | American College of Cardiology/American Heart Association clinical practice guidelines |
| DOQIT/CMS | The Doctor's Office Quality - Information Technology (DOQ-IT) project is a national initiative from the |
| | Centers for Medicare & Medicaid Services (CMS) promoting the adoption of electronic health |
| | records (EHRs) and Information Technology (IT) in physician offices. |
| AHRQ | AHRQ is the Agency for Healthcare Research and Quality - the Nation's lead Federal agency for |
| | research on health care quality, costs, outcomes, and patient safety |
| RAND | Several divisions at RAND, including RAND Health, contribute to health and health care research. |
| ACP | The American College of Physicians (ACP) is the nation's largest medical specialty society. Its |
| | mission is to enhance the quality and effectiveness of health care by fostering excellence and |
| | professionalism in the practice of medicine. |
| CMS 2006 P4P | The Centers for Medicare and Medicaid Services (CMS) initiative to pay physicians for the quality of |
| | the care they provide to seniors and disabled beneficiaries with chronic conditions; |

TABLE 2
Clinical Quality Measure Description

| Ref # | KPI Description | Numerator | Denominator | Exclusions |
|---|---|---|---|---|
| CV- | Proportion of average- | Patients with evidence | Males > 35-65 yrs and Females > 45-65 yrs old continuously | HTN, Diabetes, |
| 1_MV | risk members (males | of a lipid profile | enrolled for >=12 months [365 days] with PCP or Cardio | previous |
| | at least 35 and | — | OV visit during the 3 yr [1095 day] measurement period. | CAD/AMI Dx |
| | women at least 45 | >=1 lipid profile | — | |
| | years old) who receive | — | Men aged 35-65 years and Women aged 45-65 years | |
| | lipid profiles. | Anytime during the | — | |
| | | enrolled measurement | AND >= 1 PCP or specialist office or wellness Visit | |
| | | period | — | |
| | | | >=12 months [365 days] continuous enrollment after above | |
| | | | visit | |
| CV- | Proportion of average- | Table CV-1: CPT | Table MV_CPT_OVALL: CPT Codes for Office Visits with | Table CV-1c: |
| 1_MV | risk members (males | Codes for Lipid Profile | PCP or specialists [Shared] | Exclusion: |
| | at least 35 and | lab tests | Table MV_CPT_OVPREVALL: ICD9Dx Codes for PCP or | ICD9 Dx codes |
| | women at least 45 | | specialist Preventive Office Visits [Adult or Pedi] | for HTN |
| | years old) who receive | | Table MV_CPT_OVPREV_ADULTONLY: CPT Codes for | Table CV-1d: |
| | lipid profiles. | | PCP or specialist Preventive Office Visit [ADULT Only] | Exclusion: |
| | | | Table MV_ICD9DX_OVPREVALL: CPT Codes for PCP or | ICD9 Dx codes |
| | | | specialist Preventive Office Visits [Shared] | for CAD/AMI |
| | | | Table MV_REV_OVALL: REV Codes for PCP or specialist | Table CV-1e: |
| | | | Office Clinic Visit | Exclusion: |
| | | | | ICD9 Dx codes |
| | | | | for Diabetes |

TABLE 3
CV_1_MV Proportion of average-risk members
who receive lipid profiles

| | |
|---|---|
| Denominator | 7880 patient count |
| Men aged 35-65 and Women aged 45-65 | |
| with an office visit to PCP Or specialist | |
| and continuously enrolled for at least | |
| 12 months after the office visit | |
| Numerator | 5068 patient count |
| Patients receiving the lipid Profile test | |
| Measure Ratio | 0.68 |
| Measure Percentage | 68% of eligible patients |

TABLE 4
Measure Specification Components

| Panel Label | Description |
|---|---|
| Summary | Displays the Measure Reference Number and stores text |
| | comments which can be notes or work in progress during |
| | measure development. This is how the measure is cross |
| | referenced to a measure description in the Measure Library |
| | and how the measure is identified in a measure run |
| | and reports |
| Denominator | Allows for the specification of rules to define the |
| | Denominator set of patients or patient courses of treatment |
| Numerator | Allows for the specification of rules to define the |
| | Numerator set of patients or patient courses of treatment |
| Exclusions | Allows for the specification of rules to define patients or |
| | patient courses of treatment who should be Excluded from |
| | the measure |
| Provider | Allows for the specification of rules to define the |
| Attribution | assignment of Patients or patient courses of treatment |
| | to Providers so that the measure can be attributed to |
| | a provider |

TABLE 5

| Attribute Name | Description |
|---|---|
| MV_measure_id | Numeric integer value used within |
| | the Measure Library database as the measure key |
| MV_measure_ref_num | This is the simple alphanumeric reference |
| | for the measure in documentation as shown in the first |
| | row of the Ref# column in Table 2. |
| MV_measure_desc | Short text description of the measure |
| Mv_measure_num | Text description of the measure |
| | numerator logic as shown in the first |
| | row of the Numerator column in Table 2. |
| Mv_measure_den | Text description of the measure |
| | denominator logic as shown in the |
| | first row of the Denominator column in Table 2. |
| Mv_measure_excl | Text description of the measure |
| | exclusion logic as shown in the first |
| | row of the Exclusions column in Table 2. |
| MV_measure_short_desc | This is the standardized physician |
| | version of the measure description |
| | as shown in the first row of the Brief |
| | Description column in Table 2 |
| MV_measure_consumer_short_description | This is a consumer version of the |
| | short description of the measure for |
| | use in consumer transparency reporting applications. |
| MV_measure_consumer_long_description | This is a long version of the |
| | measure description for use in |
| | consumer transparency reporting applications. |

TABLE 6
Example Publish Format for Service Code Table
Table CV-5.1b: Hypotension - Multiple Diagnoses

| | |
|---|---|
| Table No | CV-5.1b |
| Ratio | Exclusions (DE) |
| Brief Desc. | Hypotension |
| ICD-9-DX Code | Description |
| 458.00 | Orthostatic hypotension |
| 458.10 | Chronic hypotension |
| 458.21 | Hypotension of hemodialysis |
| 458.29 | Other iatrogenic hypotension |
| 458.80 | Other specified hypotension |
| 458.90 | Hypotension, unspec |
| 796.30 | Non-specific low blood pressure reading; |
| | transient hypotension |

TABLE 7
Example Service Code Table Types

| Service Code | |
|---|---|
| Type | Description |
| CPT | Procedure codes defined in the AMA CPT-4 standard. Also |
| | supports the Medicaid specific HCPCS codes |
| GCN | Drug classification code. GCN is a First Data Bank classification number |
| | for drugs with the same ingredients |
| NDC | Drug identification code. NDC uniquely identifies a specific drug |
| | product registered with the FDA. |
| REVENUE | Revenue codes identify specific accommodations, ancillary services |
| | and billing calculations as determined by the National Uniform |
| | Billing Committee |
| ICD9-DX | Diagnosis codes as defined in the ICD9-DX taxonomy. |
| ICD10-DX | Diagnosis codes as defined in the ICD10-DX taxonomy. |
| ICD9-PX | Procedure codes as defined in the ICD9-PX taxonomy. |
| TCC | Drug classification code. TCC refers to the HIC3 classification from |
| | First Data Bank. |
| POS | Place of Service code. |
| DRG | Diagnosis-related groups (DRGs) are a classification of hospital |
| | case types into groups expected to have similar hospital resource |
| | use based on the DRG grouper |
| DISCHARGE | Discharge codes describe a patient status on discharge and |
| | indicate where a patient is being discharged to. |
| LOINC | Logical Observation Identifiers Names and Codes (LOINC ®) are |
| | universal identifiers for laboratory and other clinical observations. |
| | The laboratory portion of the LOINC database contains the usual |
| | categories of chemistry, hematology, serology, microbiology |
| | (including parasitology and virology), and toxicology; as well as |
| | categories for drugs and the cell counts you would find reported on |
| | a complete blood count or a cerebrospinal fluid cell count. Antibiotic |
| | susceptibilities are a separate category. The clinical portion of the |
| | LOINC database includes entries for vital signs, hemodynamics, |
| | intake/output, EKG, obstetric ultrasound, cardiac echo, urologic |
| | imaging, gastroendoscopic procedures, pulmonary ventilator |
| | management, selected survey instruments, and other clinical |
| | observations. |
| | The Regenstrief Institute (www.regenstrief.org) maintains the |
| | LOINC database and its supporting documentation. |

TABLE 8
Example Rule Types

| Rule | | Rule | | | |
|---|---|---|---|---|---|
| Name | Description | Type | D | E | N |
| Claim Rules | | | | | |
| Claim Age and | Used to define an age range as an | Claim | X | | |
| Sex | additional criterion for any claim retrieved | | | | |
| | by a claim rule. | | | | |
| Measure Period | Used to adjust the date range criteria for a | Claim | X | X | X |
| Offsets | measure component. | | | | |
| Service Code | All these rule types compare a set of code | Claim | X | X | X |
| Rules: | values in a service code table to the | | | | |
| CPT | service codes in the claims. The result set | | | | |
| CPT_MOD | is the set of claims that match the service | | | | |
| DISCHARGE | codes in the specified service code table. | | | | |
| DRG | Service Code tables are referenced by a | | | | |
| GCN | service code table name. The service | | | | |
| ICD9-DX | code tables to be used by a measure are | | | | |
| ICD9-PX | usually specified in the CBR version of the | | | | |
| NDC | measure and available for selection within | | | | |
| POS | the KPI version of the same measure. | | | | |
| REVENUE | | | | | |
| TCC | | | | | |
| LOINC | | | | | |
| RX Claims | This rule finds any prescription event | Claim | X | X | X |
| | regardless of drug type. A prescription | | | | |
| | claim can be identified by an | | | | |
| | MV_PHARMACY_SERVICES_ID. This | | | | |
| | rule finds any claims where the | | | | |
| | MV_PHARMACY_SERVICES_ID is not | | | | |
| | null. | | | | |
| Set Rules | | | | | |
| Define Set | A set is a container for results from any | Set | X | X | X |
| | other rule. The results must be in a | | | | |
| | defined set if they are to be acted upon by | | | | |
| | any other rule. | | | | |
| First Event | This rule finds the first or earliest event for | Set | X | X | X |
| | a patient in the target set. If there are two | | | | |
| | events on the same day then both events | | | | |
| | are considered to be the first events. | | | | |
| Last Event | This rule finds the last or latest events for a | Set | X | X | X |
| | patient in the target set. If there are two | | | | |
| | events on the same day then both events | | | | |
| | are considered to be the last events | | | | |
| Look Back | A date comparison rule to compare two | Set | X | X | X |
| | defined sets to find claims in one set that | | | | |
| | occurred with some defined date | | | | |
| | relationship earlier than claims in another | | | | |
| | set. | | | | |
| Look Back Active | This rule finds ‘active prescriptions’ within | Set | X | X | X |
| Rx | the specified time window. These may | | | | |
| | include prescriptions issued before the | | | | |
| | specified time window but with days supply | | | | |
| | sufficient to provide treatment within the | | | | |
| | time window. | | | | |
| Look Between | This rule finds claims in one set that fall | Set | X | X | X |
| | between a date range specified on the | | | | |
| | anchor event in a different set, for | | | | |
| | example, to find prescriptions that | | | | |
| | occurred during an inpatient stay defined | | | | |
| | by the admit-discharge date range on the | | | | |
| | inpatient claim. | | | | |
| Look Forward | A date comparison rule to compare two | Set | X | X | X |
| | defined sets to find claims in one set that | | | | |
| | occurred with some defined date | | | | |
| | relationship later than claims in another | | | | |
| | set. | | | | |
| Look Same | Used to compare two defined sets to find | Set | X | X | X |
| Claim | the claims in both sets. For example to | | | | |
| | find all claims for office visits that are also | | | | |
| | claims for a specific diagnosis code. | | | | |
| Look Same | Used to compare two defined sets to find | Set | X | X | X |
| Claim Line | the exact claim lines that are in both sets. | | | | |
| | For example to find the claim lines for an | | | | |
| | office visit with the desired diagnosis on | | | | |
| | the same claim line. | | | | |
| Look Same Day | A date comparison rule to compare two | Set | X | X | X |
| | defined sets to find claims on one set that | | | | |
| | have a corresponding claim in the other | | | | |
| | set that occurred on the same day. | | | | |
| Look Same | A comparison rule to find events in a target | Set | X | X | X |
| Provider | set that match with another defined | | | | |
| | provider set. This rule can be used to | | | | |
| | ensure that the practitioners providing an | | | | |
| | office visit in one set match with the | | | | |
| | prescribing providers who prescribed | | | | |
| | drugs for the patient in another set. | | | | |
| Look Specialty | Used to define the specialty of the provider | Set | X | X | X |
| | as a criterion value. Used to qualify office | | | | |
| | visits with a particular type of specialist. | | | | |
| Use Set | The Use Set rule makes it possible to re- | Set | X | X | X |
| | use any set already created within the | | | | |
| | measure. This means that the results do | | | | |
| | not have to be generated all over again. | | | | |
| Calculation | | | | | |
| Rules | | | | | |
| Calc Days | A calculation rule to sum all the Days | Calculation | X | X | X |
| Supply | Supply for the prescriptions in the target | | | | |
| | set. | | | | |
| Calc Length of | A counting rule to count the number of | Calculation | X | X | X |
| Stay | days in hospital and use length of stay as | | | | |
| | a criterion. | | | | |
| Calc Treatment | This rule calculates the number of | Calculation | X | X | X |
| Days | treatment days provided by active | | | | |
| | prescriptions within a time window. This is | | | | |
| | distinct from days supply since a | | | | |
| | prescription issued toward the end of the | | | | |
| | treatment window is only counted based | | | | |
| | on the number of days that fall within the | | | | |
| | treatment window | | | | |
| Calc Value | A calculation rule to sum all the Values in | Calculation | X | X | X |
| | the Value column of the target set. Can be | | | | |
| | used to sum the value for the treatment | | | | |
| | days calculated in Calc Treatment Days. | | | | |
| Count Events | A counting rule to define the number of | Calculation | X | X | X |
| | events as a criterion. | | | | |
| Count | A counting rule to count the number of | Calculation | X | X | X |
| Prescriptions | prescriptions. | | | | |
| Define Calc | This rule may be used to combine and | Calculation | X | X | X |
| | count different permutations or | | | | |
| | combinations of events. This is a | | | | |
| | CALCULATION type rule since it is | | | | |
| | performing a numerical operation, either | | | | |
| | on two sets or on a single set. | | | | |
| Course of | | | | | |
| Treatment Rules | | | | | |
| Define COT | This rule operates on set to label the | COT | X | | |
| | events with a Course of Treatment Id, a | | | | |
| | flag to indicate if the event is the first event | | | | |
| | in a Course of Treatment and calculates | | | | |
| | the value of the gap between events. | | | | |
| Define COT By | This rule divides a measure up into time | COT | X | | |
| Time | periods and treats each time period as a | | | | |
| | course of treatment. | | | | |
| First COT Event | This rule operates on a COTEvent set to | COT | X | X | X |
| | find just the first events for each course of | | | | |
| | treatment. | | | | |
| Last COT Event | This rule operates on a COTEvent set to | COT | X | X | X |
| | find just the last events for each patient in | | | | |
| | each course of treatment | | | | |
| Look Same COT | This rule operates on two sets to find | COT | X | X | X |
| | events that include the same patient and | | | | |
| | COT id combination. When COT events | | | | |
| | are qualified or tested by other criteria, the | | | | |
| | results set returned should be the COT | | | | |
| | events. This rule allows for a COT event | | | | |
| | to be qualified by multiple successive | | | | |
| | criteria | | | | |
| Member Rules | | | | | |
| Continuous | Used to define the eligibility requirements | Member | X | | |
| Enrollment | for a measure. | | | | |
| EM Visits | Yes/No flag to specify an additional global | Member | X | | |
| | requirement for an office visit. Available as | | | | |
| | a criterion if office visits are not an explicit | | | | |
| | part of a measure. Default is NO. | | | | |
| Member | This rule finds a set of patients that match | Member | X | X | X |
| Age/Sex | on the age and sex criteria only. This is a | | | | |
| | patient set using the enrollment data as a | | | | |
| | source and not the claim set. This rule is | | | | |
| | needed for demographic type measures | | | | |
| | where the only denominator criteria are | | | | |
| | age and sex. | | | | |
| Rx Benefits | Yes/No flag to specify eligibility for Drug | Member | X | | |
| | benefits as a criterion. Default is Yes. | | | | |
| Provider | | | | | |
| Attribution Rules | | | | | |
| SelectSet | Enables specification of a specific | Provider | X | | |
| | denominator set to use as source for | | | | |
| | providers | | | | |
| UseAllSets | Uses any provider treating the patient in | Provider | X | | |
| | any denominator set | | | | |
| UseServices | Uses a global encounter table as the | Provider | X | | |
| | source for providers to be attributed to the | | | | |
| | patient | | | | |

TABLE 9
Table CV-1: CPT Codes for Lipid Profile lab tests

| Table | CV-1 |
|---|---|
| No. | |
| Ratio: | N |
| Brief | Lipid Profile lab tests - CPT |
| Desc. | |
| CPT | |
| CODE | Description |
| 80061 | LIPID PANEL |
| 83695 | Lipoprotein (a) |
| 83700 | Lipoprotein, blood; electrophoretic separation and quantitation |
| 83701 | Lipoprotein, blood; high resolution fractionation and |
| | quantitation of lipoproteins including lipoprotein subclasses |
| | when performed (eg, electrophoresis, ultracentrifugation) |
| 83704 | Lipoprotein, blood; quantitation of lipoprotein particle numbers |
| | and lipoprotein particle subclasses (eg, by nuclear magnetic |
| | resonance spectroscopy) |
| 83715 | Lipoprotein, Blood; Electrophoretic Separation And |
| | Quantitation |
| 83716 | Lipoprotein, Blood; High Resolution Fractionation And |
| | Quantitation Of Lipoprotein Cholesterols (Eg, Electrophoresis, |
| | Nuclear Magnetic Resonance, Ultracentrifugation) |
| 83718 | Lipoprotein, direct measurement; high density cholesterol (hdl |
| | cholesterol) |
| 83719 | Lipoprotein, direct measurement; ldl cholesterol |
| 83721 | LIPOPROTEIN, DIRECT MEASUREMENT; DIRECT |
| | MEASUREMENT, LDL CHOLESTEROL |

TABLE 10

| Report Name | Report Description |
|---|---|
| KPI Population by (Specialty) | This report provides raw numerator, denominator and KPI ratio results for each |
| | KPI in the specialty set of measures - by all MD specialties. This report can be |
| | used to determine if the measure should be applied to other specialties |
| Summary KPI Results (for Specialty) | Summarizes the num/den and ratio by KPI within the specialty set across all |
| | specialties at the total patient assignment level without sample size constraints. |
| KPIs By Providers (for Specialty) | This table lists all the providers who meet the designated sample size |
| | constraints e.g (n => 25) and meet the designated # of KPIs constraint e.g (=>4) |
| | and shows the count of KPIs and shows the numerator, denominator and ratio |
| | for each KPI for each provider. The providers in this table are providers with |
| | the target specialty of the KPI set |
| KPIs By Provider (ALL Specialties) | Same as for specialty except that all providers from any specialty meeting the |
| | sample size constraints are listed. |
| (KPI Id) Results By Provider | This report is created for each KPI in the specialty set and lists all providers in |
| | the target specialty. This report calculates the specialty mean ratio where the |
| | min ratio is the smallest ratio for provider (meeting minimum sample size |
| | requirements) and the max ratio is the largest ratio for provider (meeting the |
| | minimum) sample size requirements. This table is descriptive only - not used |
| | for input to CQI calculations. |
| (KPI Id) Histogram | This report is created for each KPI in the specialty set and uses source data |
| | from QSREP23. Uses n >= 25 for cut off |
| Specialty Score KPI | e.g. CvSpecialty_Score_KPI. This report is created for the KPI specialty set |
| | and shows the distribution of point scores for each KPI including the number of |
| | doctors with the PNR score. Providers are of the same specialty as the KPI set. |
| CQI by Specialty Provider | Shows the calculation of the CQI for providers in the specialty. |
| Specialty_Score_CQI | e.g. CVSpecialty_Score_CQI shows the MD distribution of point scores by for all |
| | KPIs (CQI). This information is presented for the CQI for a specialty |
| CQI Specialty Chart | e.g. CV_CQI_Histogram contains descriptive statistics and distribution of the |
| | average KPI score across all KPIs. This information is presented for the CQI |
| | for a specialty |
| CQI Pearson Correlations | The variance-covariance matrix examines whether each pair of KPI measures |
| | are related (move together) - that is, whether large values of one variable tend |
| | to be associated with large values of The other (positive covariance), whether |
| | small values of one variable tend to be associated with large values of the other |
| | (negative covariance), or whether values of both variables tend to be unrelated |
| | (covariance near zero) |

TABLE 11

| Parameter | |
|---|---|
| Field | |
| Label | Usage |
| Adjust | The Adjust Begin Date parameters define the adjustment from |
| Begin | the beginning of the measure period. There are three |
| Date | parameters: |
| | The direction of the adjustment |
| | A value for the adjustment |
| | A value unit for the adjustment |
| | Adjust Forward will move the beginning date later in time. |
| | This may be needed in the Denominator when the global |
| | measurement period defines the entire data set and there needs |
| | to be time for a LookBack or Exclusion criteria. |
| | Adjust Backward will move the beginning date earlier in time. |
| | This is often needed in the Denominator for HEDIS type |
| | measures as the ‘intake period’ is offset backward from the |
| | measurement year. |
| | Units may be Days. Months or Years. If Months are chosen, |
| | months are converted to 30 days unless 12 months or an exact |
| | multiple of 12 months is chosen, in which case the 12 month |
| | period is converted to 365 days. |
| Adjust | The Adjust End Date parameters define the adjustment from |
| End Date: | the end of the measure period. There are three parameters: |
| | The direction of the adjustment |
| | A value for the adjustment |
| | A value unit for the adjustment |
| | Adjust Forward will move the end date later in time. This is |
| | usually not a viable option since the global measurement end |
| | date usually matches the date for the end of the available data |
| | set. |
| | Adjust Backward will move the beginning date earlier in time. |
| | This is often necessary in the Denominator in order to allow |
| | for time for the required Numerator service. |
| | Units may be Days. Months or Years. If Months are chosen, |
| | months are converted to 30 days unless 12 months or an exact |
| | multiple of 12 months is chosen, in which case the 12 month |
| | period is converted to 365 days. |

TABLE 12

| Parameter Field | |
|---|---|
| Label | Usage |
| From: | Use the first field to specify a Value and the second |
| | field to choose the units for the beginning age of the |
| | desired age range. Claims retrieved will be where the |
| | age on the claim is greater than or equal to the age |
| | specified. |
| | Units may be Months or Years |
| To: | Use the first field to specify a Value and the second |
| | field to choose the units for the upper age of the |
| | desired age range. |
| | Claims retrieved will be where the age on the claim is |
| | less than or equal to the age specified. |
| | Units may be Months or Years. |
| Sex | This is a drop down selection box. Select Male, |
| | Female or leave blank to select both. |

TABLE 13
List of types of service codes

| Rule Type | Description |
|---|---|
| CPT | Looks for codes in the CPT-4 field of the claim to match |
| | to required service codes. |
| CPT_MOD | Looks for codes in both the CPT-4 field and also the |
| | CPT-MOD field of the claim to match to required |
| | service codes in the claims. |
| DISCHARGE | Looks for codes in the DISCHARGE field of the claim |
| | to match to required service codes. |
| DRG | Looks for codes in the DRG field of the claim to match |
| | to required service codes. |
| GCN | Looks for codes in the GCN field of the claim to match |
| | to required service codes. |
| ICD9-DX | Looks for codes in the ICD9-DX field of the claim to |
| | match to required service codes. |
| ICD9-PX | Looks for codes in the ICD9-PX field of the claim to |
| | match to required service codes. |
| NDC | Looks for codes in the NDC field of the claim to |
| | match to required service codes. |
| POS | Looks for codes in the POS field of the claim to match |
| | to required service codes. |
| REVENUE | Looks for codes in the REVENUE field of the claim to |
| | match to required service codes. |
| TCC | Looks for codes in the TCC field of the claim to match |
| | to required service codes. |
| LOINC | Future - do not use |
| TOB | Future - do not use |

TABLE 14

| Parameter Field Label | Usage |
|---|---|
| Rule Description | Use this field to comment the measure and describe the intended |
| | use of the results set within the measure. |
| Audit | Set AUDIT to YES if this event should be audited. |
| Service Code Table | This parameter names the service code table to be used. |
| | This field is both a text entry and a drop down selection. If the |
| | service table is defined in the CBR for the measure then the service |
| | table will be available for selection. |
| | If the desired service table is not yet provided in the CBR then you |
| | can type in the name of the desired service table. Also note that |
| | the navigator pane also includes a full list of available service code |
| | tables as shown in FIG. 7 below and you can cut and paste from |
| | the list. |
| | To create a new service code table that does not yet exist you |
| | would right click on an existing service code table, clone it and then |
| | edit it. |
| Begin Day Offset | Use this field to specify an offset from the measure period of the |
| | parent set. This field assumes a value unit of Days. A positive |
| | value sets the measure period forward in time from the parent set |
| | measure period. A negative value sets the measure period |
| | backward in time from the parent set measured period. |
| End Day Offset | If a Begin Day Offset is specified than an End Day Offset will |
| | nearly always need to be specified. The End Day Offset is the |
| | offset for the end of the measure period - from the beginning of |
| | the measure period. (Note: NOT an offset from the end of the |
| | measure period.) |
| Service Date Column | This parameter defines the service date column to be used when |
| | comparing service date to the defined measure period. |
| | FROMDATE |
| | THRUDATE |
| | ADMITFROMDATE |
| | DISCHARGE |
| | ADMIT_OR_FROM |
| | DISCHARGE_OR_THRU |

TABLE 15

| Parameter Field | |
|---|---|
| Label | Usage |
| Diagnosis | There are four diagnosis code fields on a claim. This |
| Option | parameter is to specify which if the diagnosis code |
| | fields are to be used for matching to the required |
| | service codes. |
| | ANYDX - means that any of the diagnosis fields may |
| | be matched |
| | PRIMARYDX - means that only the first diagnosis field |
| | (DX1) will be used for matching |
| | SECONDARYDX - means that all diagnosis fields |
| | except the first (DX1) will be used for matching |
| | SOLEDX - means that the diagnosis must both be |
| | primary and also there must be no other diagnoses on |
| | the same claim |
| Exclude | The Exclude options enable the exclusion of certain |
| options | types of claims that might be considered not to |
| | represent a confirmed diagnosis. A check mark against |
| | the claim type will exclude those types of claims. |
| | Business Rules define whether a diagnosis needs to be |
| | a strict diagnosis rather than a suspected diagnosis. |
| | The MV default is to exclude Lab and Radiology claims |
| | and include ER claims when looking for a diagnosis |
| | claim. |

TABLE 16

| Returned Field | Value |
|---|---|
| MV_CLAIM_ID | MV generated id for the claim. |
| CLAIMNO | Client claim number |
| CLAIMLINENO | Client claim line number |
| MV_PATIENT_ID | MV generated id for the patient |
| COT | 0 by default in a non-course of treatment |
| | measure |
| AGE | Patient age on the claim - calculated based |
| | on DOB in enrollment |
| SEX | Patient sex on the claim. |
| MV_PROVIDER_ID | MV generated id for the provider who is |
| | delivering the service |
| MV_MGMTPROVIDER_ID | MV generated id for the management |
| | provider - the provider who ordered |
| | the service. |
| MV_PRESPROVIDER_ID | MV generated id for the prescribing |
| | provider - only populated if the claim is an |
| | Rx claim. |
| FROMDATE | Date of service - from date or start date |
| THRUDATE | Date of service - thru date or end date |
| PATIENT_DOB | Patient date of birth from the member |
| | enrollment table. |
| ADMITFROMDATE | Admit date |
| ADMITTHRUDATE | Discharge date |
| QUANTITY | Days supply for pharmacy claims - |
| | otherwise null |
| VALUE | Null |

TABLE 17

| Parameter Field | |
|---|---|
| Label | Usage |
| Rule | Use this field to comment the measure and describe the |
| Description | intended use of the results set within the measure. |
| Begin Day | Use this field to specify an offset from the measure |
| Offset | period of the parent set. This field assumes a value |
| | unit of Days. A positive value sets the measure period |
| | forward in time from the parent set measure period. A |
| | negative value sets the measure period backward in |
| | time from the parent set measure period. |
| End Day Offset | If a Begin Day Offset is specified than an End Day |
| | Offset will nearly always need to be specified. The End |
| | Day Offset is the offset for the end of the measure |
| | period - from the beginning of the measure period. |
| | (Note: NOT an offset from the end of the measure |
| | period.) |

TABLE 18

| Returned Field | Value |
|---|---|
| MV_CLAIM_ID | MV generated id for the claim. |
| COT | 0 by default for a non-course of treatment |
| | measure |
| CLAIMNO | Client claim number |
| CLAIMLINENO | Client claim line number |
| MV_PATIENT_ID | MV generated id for the patient |
| AGE | Patient age on the claim - calculated based |
| | on DOB in enrollment |
| SEX | Patient sex on the claim. |
| MV_PROVIDER_ID | MV generated id for the provider who is |
| | delivering the service |
| MV_MGMTPROVIDER_ID | MV generated id for the management |
| | provider - the provider who ordered the |
| | service. |
| MV_PRESPROVIDER_ID | MV generated id for the prescribing |
| | provider - only populated if the claim is an |
| | Rx claim. |
| FROMDATE | Date of service - from date or start date |
| THRUDATE | Date of service - thru date or end date |
| PATIENT_DOB | Patient date of birth from the member |
| | enrollment table. |
| ADMITFROMDATE | Admit date |
| ADMITTHRUDATE | Discharge date |
| QUANTITY | Days Supply for Rx claims |
| VALUE | Null |

TABLE 19

| Parameter Field Label | Usage |
|---|---|
| Set Name | This is the name of the set being defined. This is the name that will be used to reference the |
| | set in order to manipulate the contents. |
| | For ease of use this name should be sufficiently descriptive of the set contents to easily |
| | communicate what is being reference but short enough to make it easy to remember or read. |
| Set Description | This parameter is optional but provides a place to comment and describe the set contents in |
| | detail or the purpose of the set. |
| Join Rules Using: | This parameter describes how the rule results or sets within the set being defined should be |
| | combined. |
| | AND - specifies that results sets within the set should be combined with a Boolean AND |
| | OR - specifies that results sets within the set should be combined with a Boolean OR |
| | MINUS - specifies that the results set should be the first set minus the second set. Requires |
| | that only two result sets are within the defined set. |
| | When the results set within a set are combined, the very first defined set is the ‘candidate’ |
| | set of results and this candidate set is filtered or edited based on the join. |
| | For example, the set contains two diagnosis criteria rules. The first rule finds claims with a |
| | diagnosis of Diabetes and the second rule finds claims with a diagnosis of Hypertension. |
| | If the join rule is AND - then the final contents of the set being defined will be the set of claims |
| | for Diabetes where the patient (or claim see later) is also in the Hypertension set. |
| | If the join rule is OR - then the final contents of the set being defined will be the set of claims |
| | for Diabetes plus the set of claims for Hypertension. |
| | If the join rule is MINUS - then the final contents of the set being defined will be the set of |
| | claims for Diabetes minus those patients (or claims) that are also in the Hypertension set. |
| | As can be seen in the examples - no matter what the join rule, the final set contains the |
| | Diabetes claims since these were the first results, filtered by the resuts created by the second |
| | rule. |
| Join By | This parameter describes the field to use as the filter when using the AND or MINUS join rules |
| | on results or sets within the set. |
| | PATIENTID - Filters the results by patient |
| | PATIENTID₋ AND₋ COT - Filters the results by patient and also course of treatment id. This |
| | should be used in course of treatment measures instead of PATIENTID |
| | CLAIMLINE - Filters the results by specific claim line. |
| | CLAIMNO - Filters the results by claim number |
| | PROVIDER ID - Filters the results by provider |
| | MGMTPROVIDERID - Filters the results by management provider |
| | PRESPROVIDERID - Filters the results by prescribing provider |
| AuditProviderColumn | This parameter describes which provider field should be used when recording results into the |
| | patient audit digest. Only one row in entered into the patient digest for each anchoring event |
| | by provider |
| | PROVIDER ID - Uses the provider id field to select unique providers per patient |
| | MGMTPROVIDERID - Uses the mgmtprovider id field to select unique providers per patient |
| | PRESPROVIDERID - Uses the presprovider id field to select unique providers per patient |
| Mainstream Set | This parameter provides the capability for defining a set without combining it into the rollup. |
| | By turning off the roll up the set can be created and used by another set without having to |
| | figure out how the set might impact the results. This can simplify the overall measure logic. |
| | YES - means that the set will be combined as described by the Join rules and rolled up to |
| | impact the results of the parent set. |
| | NO - means that the set will be skipped in any roll up. Effectively the set becomes something |
| | that is ‘outside’ the measure but available as a resource. |

TABLE 20

| Parameter Field | |
|---|---|
| Label | Usage |
| Rule Description | Use this field to comment the measure and describe |
| | the intended use of the results set within the measure. |
| Audit | Set AUDIT to YES if this event should be audited. |
| Input set | This is the name of the set to be used. This allows a |
| | set to be re-used without recreating the query during |
| | measure processing. |
| | To reduce measure complexity a set can be created as |
| | a Mainstream = No set and then used in the |
| | appropriate part of the measure logic later. |

TABLE 21

| Parameter Field | |
|---|---|
| Label | Usage |
| Rule Description | Use this field to comment the measure and describe |
| | the intended use of the results set within the measure. |
| Audit | Set AUDIT to YES if this event should be audited. |
| Set A | This is the top set or first set for the comparison and |
| | by default this is the set from which the final results |
| | are drawn. |
| Set B | This is the bottom set or second set for the |
| | comparison. This is the set that is used to filter the |
| | first set. If the claim number for any given patient is |
| | not in the Look From Set then it will be filtered from |
| | the first set. |
| Return Set | By default the rows or events in Set A set are the rows |
| | that are considered and filtered for the results set. |
| | If Return From Set is turned to YES then it is the rows |
| | in the Look From set that are compared and filtered |
| | based on the first set. |

TABLE 22

| Parameter Field | |
|---|---|
| Label | Usage |
| Rule | Use this field to comment the measure and describe |
| Description | the intended use of the results set within the measure. |
| Audit | Set AUDIT to YES if this event should be audited. |
| Look To Set | This is the top set or first set for the comparison and by |
| | default this is the set from which the results are drawn |
| Look From Set | This is the bottom set or second set for the comparison. |
| | This is the set that is used to filter the first set. If the |
| | claim number for any given patient is not in the Look |
| | From Set then it will be filtered from the first set. |
| Return From | By default the rows or events in the Look To set are the |
| Set | rows that are considered and filtered for the results set. |
| | If Return From Set is turned to YES then it is the rows |
| | in the Look From set that are compared and filtered |
| | based on the first set. |

TABLE 23

| Parameter Field | |
|---|---|
| Label | Usage |
| Rule Description | Use this field to comment the measure and describe |
| | the intended use of the results set within the measure. |
| Audit | Set AUDIT to YES if this event should be audited. |
| Value | This is a text entry field for the numerical value of the |
| | target specialty. More than one specialty can be |
| | entered separated by commas. |
| | The specialty values are the MV values and they are |
| | declared in the MV_Specialty_Mapping table. The |
| | available values are in Appendix 1 of this document. |
| Target Set | This is the parameter to name the input or target set |
| | which is the set to be filtered by provider specialty. |

TABLE 24

| Parameter Field Label | Usage |
|---|---|
| Rule Description | Use this field to comment the measure and describe the intended use of the results |
| | set within the measure. |
| Audit | Set AUDIT to YES if this event should be audited. |
| Anchor From | Select source for the anchor event. Options are: |
| | Select Set - to specify the set that contains the anchor events |
| | Global_Measurement_Period_End - to anchor from the end of the global |
| | measurement period |
| | Global_Measurement_Period_Begin - to anchor from the beginning of the global |
| | measurement period |
| | Measurement_Period_End - to anchor from the end of the measurement period |
| | established for the measure component |
| | Measurement_Period_Begin- to anchor from the beginning of the measurement |
| | period established for the measure component |
| Operator | The Look Back rule can leverage the following operators: |
| | BETWEEN - Looks back from the anchor event of the FROM set to events in the TO |
| | set that happened Between the anchor event and the specified time period. Finds |
| | claims in the reference set that fall on dates that are within a required time period |
| | defined by the date of the initial anchor claim and an end date calculated using the |
| | VALUE and VALUE UNIT. The BETWEEN operator includes the day of the anchor |
| | event in the FROM table (DENOM) as one end point of the time period. If this day is |
| | to be excluded from the time period then use the BETWEEN_EXCLUSIVE operator |
| | BETWEEN EXCLUSIVE - Looks back from the anchor event of the FROM set to |
| | events in the TO set that happened Between the anchor event and the specified time |
| | period but does not include the date of the anchor event. Effectively this moves the |
| | inspected time period back in time one day |
| | LT - This operator uses the specified time period as a window to skip and then looks |
| | for events in the TO set that happened any time before the specified time period. For |
| | example, if a time window of 30 DAYS is specified, then the events looked for will |
| | the events that happened more than 30 days before the anchor event. |
| | LTE - This operator uses the specified time period as a window to skip and then |
| | looks for events in the TO set that happened any time before the specified time |
| | period. For example, if a time window of 30 DAYS is specified, then the events |
| | looked for will the events that happened more than 30 days before the anchor event. |
| | This event includes the day that is exactly 30 days before the anchor event in the |
| | inspected time period. |
| | If a measurement period is the anchor then the following operators are available. |
| | Note that these operators do not need a Value for the look back as they look back to |
| | the anchor date. |
| | LOOK_UNTIL_MEASUREMENT_END |
| | LOOK_EXCLUSIVE_UNTIL_MEASUREMENT_END |
| | LOOK_UNTIL_MEASUREMENT_BEGIN |
| | LOOK_EXCLUSIVE_UNTIL_MEASUREMENT_BEGIN |
| Value | This is the value of time for the look back. |
| | For example, to Look Back 3 days specify a value of 3 and choose a Value Unit of |
| | DAYS. |
| Value Unit | This is the unit of time. DAYS or MONTHS may be selected. |
| | If MONTHS are selected this is calculated as 30 days pre month unless the Value is |
| | 12 or a multiplier of 12 in which case 365 days is calculated. |
| Reference Table | This is the name of the set that is to be Looked Back to. Also described as the Top |
| | Set or Numerator set. This is the set of events to be qualified. |
| Numerator Date Column | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDAY - this is the birthday date for a patient |
| Anchor Date | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDATE - this is the birthday date for a patient |
| | ADMIT_OR_FROMDATE - uses the admit date but if it is null uses the from date |
| | DISCHARGE_OR_THRUDATE - uses the discharge date but if it null uses the thru |
| | date |
| Anchor set | This is the name of the set that is to be Looked Back from. |
| Anchor event | This defines the anchor event in the denominator set to be looked back from. |
| | First Event- only looks back from the first event in the denominator or look back from |
| | set per patient |
| | Last Event - only looks back from the last event in the denominator or look back |
| | from set per patient |
| | Any Event - looks back from each patient event to find events that meet the criterion |
| | value. |
| Return From Set | This parameter describes the set of claims to return as the results set. By default |
| | the To set or reference set contains the set of claims that are being tested for the |
| | criteria and the events which pass the test are returned. |
| | If RETURN FROM SET is set to YES then it is the denominator or FROM set that |
| | contains the claims to be returned and these are the claims that meet the criterion of |
| | an event in the reference set occurring during the specified time frame. |

TABLE 25

| Parameter Field Label | Usage |
|---|---|
| Rule Description | Use this field to comment the measure and describe the intended use of the results |
| | set within the measure. |
| Audit | Set AUDIT to YES if this event should be audited. |
| Operator | The Look Forward rule can leverage the following operators: |
| | BETWEEN - Looks back from the anchor event of the FROM set to events in the |
| | TO set that happened Between the anchor event and the specified time period. |
| | BETWEEN EXCLUSIVE - Looks back from the anchor event of the FROM set to |
| | events in the TO set that happened Between the anchor event and the specified |
| | time period but does not include the date of the anchor event. Effectively this |
| | moves the inspected time period back in time one day |
| | GT - This operator uses the specified time period as a window to skip and then |
| | looks for events in the TO set that happened any time after the specified time |
| | period. For example, if a time window of 30 DAYS is specified, then the events |
| | looked for will be the events that happened more than 30 days after the anchor |
| | event. |
| | GTE - This operator uses the specified time period as a window to skip and then |
| | looks for events in the TO set that happened any time before the specified time |
| | period. For example, if a time window of 30 DAYS is specified, then the events |
| | looked for will the events that happened more than 30 days after the anchor event. |
| | This event includes the day that is exactly 30 days after the anchor event in the |
| | inspected time period. |
| Value | This is the value of time for the look forward. |
| | For example, to Look Forward 3 days specify a value of 3 and choose a Value Unit |
| | of DAYS. |
| Value Unit | This is the unit of time. DAYS or MONTHS may be selected. |
| | If MONTHS are selected this is calculated as 30 days per month unless the Value |
| | is 12 or a multiplier of 12 in which case 365 days is calculated. |
| Reference Table | This is the name of the set that is to be Looked Forward to. Also described as the |
| | Top Set or Numerator set. This is the set of events to be qualified. |
| Numerator Date Column | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDAY - this is the birthday date for a patient |
| Denominator Date Column | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDATE - this is the birthday date for a patient |
| | ADMIT_OR_FROMDATE - uses the admit date but if it is null uses the from date |
| | DISCHARGE_OR_THRUDATE - uses the discharge date but if it null uses the |
| | thru date |
| Denom Table | This is the name of the set that is to be Looked Forward from. |
| Denominator Date Column | This defines the anchor event in the denominator set to be looked back from. |
| Anchor | EARLIER - only looks forward from the first event in the denominator or look back |
| | from set per patient |
| | LATER - only looks forward from the last event in the denominator or look back |
| | from set per patient |
| | ANY EVENT - looks forward from each patient event to find events that meet the |
| | criterion value. |
| Return From Set | This parameter describes the set of claims to return as the results set. By default |
| | the To set or reference set contains the set of claims that are being tested for the |
| | criteria and the events which pass the test are returned. |
| | If RETURN FROM SET is set to YES then it is the denominator or FROM set that |
| | contains the claims to be returned and these are the claims that meet the criterion |
| | of an event in the reference set occurring during the specified time frame. |

TABLE 26

| Parameter Field Label | Usage |
|---|---|
| Rule Description | Use this field to comment the measure and describe the intended use of the results |
| | set within the measure. |
| Audit | Set AUDIT to YES if this event should be audited. |
| Operator | The Look Same Day rule can leverage the following operator: |
| | EQ |
| Value | Not valid for this rule |
| Value Unit | Not valid for this rule |
| Reference Table | This is the name of the set that is to be Looked Forward to. Also described as the |
| | Top Set or Numerator set. This is the set of events to be qualified. |
| Numerator Date Column | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDAY - this is the birthday date for a patient |
| Denominator Date Column | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDATE - this is the birthday date for a patient |
| | ADMIT_OR_FROMDATE - uses the admit date but if it is null uses the from date |
| | DISCHARGE_OR_THRUDATE - uses the discharge date but if it null uses the |
| | thru date |
| Denom Table | This is the name of the set that is to be Looked Forward from. |
| Denominator Date Column | This defines the anchor event in the denominator set to be looked back from. |
| Anchor | EARLIER - only looks forward from the first event in the denominator or look back |
| | from set per patient |
| | LATER - only looks forward from the last event in the denominator or look back |
| | from set per patient |
| | ANY EVENT - looks forward from each patient event to find events that meet the |
| | criterion value. |
| Return From Set | This parameter describes the set of claims to return as the results set. By default |
| | the To set or reference set contains the set of claims that are being tested for the |
| | criteria and the events which pass the test are returned. |
| | If RETURN FROM SET is set to YES then it is the denominator or FROM set that |
| | contains the claims to be returned and these are the claims that meet the criterion |
| | of an event in the reference set occurring during the specified time frame. |

TABLE 27

| | Usage |
|---|---|
| Rule Description | Use this field to comment the measure and describe the intended use of the |
| | results set within the measure. |
| Audit | Set AUDIT to YES if this event should be audited. |
| Operator | Only the BETWEEN operator is valid. |
| Reference Table | This is the name of the set that is to be Looked Between to. Also described as |
| | the Top Set or Numerator set. This is the set of events to be qualified or tested. |
| Numerator Date Column | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDAY - this is the birthday date for a patient |
| Denominator Date Column | This is the date column to use in the bottom set, denominator set or from set as |
| | the anchoring dates for the look between. |
| | The following date ranges are available. |
| | ADMIT-DISCHARGE - Uses the admitfrom date through the admitthru date on the |
| | anchoring claim as the date range for the Look Between |
| | FROMDATE-THRUDATE - Uses the Fromdate through the Thrudate as the date |
| | range for the Look Between |
| Denom Table | This is the name of the set that contains the anchoring event for the Look |
| | Between. |
| Denominator Date Column | This defines the anchor event in the denominator set to be looked back from. |
| Anchor | EARLIER - only looks forward from the first event in the denominator or look back |
| | from set per patient |
| | LATER - only looks forward from the last event in the denominator or look back |
| | from set per patient |
| | ANY EVENT - looks forward from each patient event to find events that meet the |
| | criterion value. |
| Return From Set | This parameter describes the set of claims to return as the results set. By default |
| | the To set or reference set contains the set of claims that are being tested for the |
| | criteria and the events which pass the test are returned. |
| | If RETURN FROM SET is set to YES then it is the denominator or FROM set that |
| | contains the claims to be returned and these are the claims that meet the criterion |
| | of an event in the reference set ccurring during the specified time frame. |

TABLE 28

| Parameter Field Label | Usage |
|---|---|
| Rule Description | Use this field to comment the measure and describe the intended use of the results |
| | set within the measure. |
| Audit | Set AUDIT to YES if this event should be audited. |
| Operator | The valid operators for the rule are BETWEEN and BETWEEN_EXCLUSIVE |
| Value | This parameter specifies the value for the time period of the LookBack. |
| | For example if looking for any prescription in a 60 day negative medication history |
| | requirement the value would be 60 and the unit DAYS |
| Value Unit | This parameter specifies the units for the time period - DAYS or MONTHS. |
| | If MONTHS are specified this is calculated as 30 days per month unless 12 months |
| | or a multiplier of 12 is specified in which case the 12 months are counted as 365 |
| | days. |
| Reference Table | This is the name of the set that is to be Looked Back to. Also described as the Top |
| | Set or Numerator set. This is the set of events containing the prescriptions. Note |
| | that for an active Rx history to be calculated the measure period for the |
| | prescriptions must be set to include prescriptions earlier than the denominator or |
| | anchor events. |
| Numerator Date Column | This is the date column to use in the reference set or To set as the date for the |
| | event. |
| | The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDAY - this is the birthday date for a patient |
| Denominator Date Column | This is the date column to use in the reference set or To set as the date for the |
| | event. The following date columns are available. |
| | FROMDATE - this is the From date on the claim date of service |
| | THRUDATE - this is the Thru date on the claim date of service |
| | ADMIT - this is the AdmitFRom date on the claim date of service |
| | DISCHARGE - this is the AdmitThru date on the claim date of service |
| | BIRTHDATE - this is the birthday date for a patient |
| | ADMIT_OR_FROMDATE - uses the admit date but if it is null uses the from date |
| | DISCHARGE_OR_THRUDATE - uses the discharge date but if it null uses the |
| | thru date |
| Denom Table | This is the name of the set that is to be Looked Back from. |
| Denominator Date Column | This defines the anchor event in the denominator set to be looked back from. |
| Anchor | EARLIER - only looks forward from the first event in the denominator or look back |
| | from set per patient |
| | LATER - only looks forward from the last event in the denominator or look back |
| | from set per patient |
| | ANY EVENT - looks forward from each patient event to find events that meet the |
| | criterion value. |
| Return From Set | This parameter describes the set of claims to return as the results set. By default |
| | the To set or reference set contains the set of claims that are being tested for the |
| | criteria and the events which pass the test are returned. |
| | If RETURN FROM SET is set to YES then it is the denominator or FROM set that |
| | contains the claims to be returned and these are the claims that meet the criterion |
| | of an event in the reference set occurring during the specified time frame. |

TABLE 29

| Parameter Field Label | Usage |
|---|---|
| Rule Description | Use this field to comment the measure and describe the |
| | intended use of the results set within the measure. |
| Audit | Set AUDIT to YES if this event should be audited. |
| Target Set | This is the name of the set that contains the claims to be |
| | filtered for first events only |
| Denominator Date | This parameter specifies which date column is to be used to |
| Column | determine the date of the claim or date of service. |
| | FROMDATE - this is the From date on the claim date of |
| | service |
| | THRUDATE - this is the Thru date on the claim date of |
| | service |
| | ADMIT - this is the AdmitFRom date on the claim date of |
| | service |
| | DISCHARGE - this is the AdmitThru date on the claim date |
| | of service |
| | BIRTHDATE - this is the birthday date for a patient |
| | ADMIT_OR_FROMDATE - uses the admit date but if it is null |
| | uses the from date |
| | DISCHARGE_OR_THRUDATE - uses the discharge date |
| | but if it null uses the thru date |

TABLE 30

| Parameter Field Label | Usage |
|---|---|
| Rule Description | Use this field to comment the measure and describe the |
| | intended use of the results set within the measure. |
| Audit | Set AUDIT to YES if this event should be audited. |
| Reference Table | This is the name of the set that contains the set of claims or rows |
| | to be filtered. |
| Denom Table | This is the name of the set that contains the set that defines |
| | the providers that need to be in the first set. |
| Numerator Provider | This is the provider column to use in the Reference Table to |
| Column | select the providers. |
| Denominator Provider | This is the provider column to use in the Denom Table as the |
| Column | filter or required criteria for the reference table |
| Return From Set | This value determines the set of claims or rows to be |
| | returned as the results set. By default the reference set is |
| | the set to return and the value of Return From Set is NO. If |
| | Return From Set is changed to YES then the denominator |
| | set (FROM set) is the set that is returned based on |
| | comparison with the reference set. |

TABLE 31

| Parameter Field Label | Usage |
|---|---|
| Rule Description | Use this field to comment the measure and describe the intended use of the results set within |
| | the measure. |
| Audit | Set AUDIT to YES if this event should be audited. |
| Operator | The Operator provides a way to pre-filter on the Event Count results set. Essentially the rule |
| | finds and sums at the rows for a designated grouping but the results set only includes those |
| | groupings which meet any required criteria as specified by the Operator and the Value. |
| | The Operators provided are |
| | EQ—Equal To |
| | GT—Greater Than |
| | GTE—Greater Than or Equal To |
| | LT—Less Than |
| | LTE—Less Than or Equal To |
| | BETWEEN |
| | BETWEEN_EXCLUSIVE |
| | Note that BETWEEN_EXCLUSIVE is not a valid option for this rule. |
| Value | The Value determines the filter or criteria for the results set. |
| | To simply count events set the value GTE to 1 |
| Max Value | If BETWEEN is used as the operator then Max Value is the parameter for the upper end of the |
| | target range. |
| Reference Table | This is the input set or target set for the rule. The input set can be any type of set that supports |
| | the designated grouping to count the rows. |
| Begin Day Offset | Use this field to specify an offset from the measure period of the parent set. This field assumes |
| | a value unit of Days. A positive value sets the measure period forward in time from the parent |
| | set measure period. A negative value sets the measure period backward in time from the parent |
| | set measure period. |
| End Day Offset | If a Begin Day Offset is specified than an End Day Offset will nearly always need to be |
| | specified. The End Day Offset is the offset for the end of the measure period - from the |
| | beginning of the measure period. (Note: NOT an offset from the end of the measure period.) |
| Group by Column 1 | The default grouping for the counting is the patient. The possible groupings also include |
| | providers in order to count events by distinct providers and also dates in order to count events by |
| | distinct dates. |
| | PATIENT ID |
| | COT |
| | PROVIDER ID |
| | MGMTPROVIDER ID |
| | PRESPROVIDER ID |
| | FROM DATE |
| | THRU DATE |
| | ADMIT |
| | DISCHARGE |
| Group by Column 2 | The possible groupings also include providers in order to count events by distinct providers and |
| | also dates in order to count events by distinct dates. |
| | PATIENT ID |
| | COT |
| | PROVIDER ID |
| | MGMTPROVIDER ID |
| | PRESPROVIDER ID |
| | FROM DATE |
| | THRU DATE |
| | ADMIT |
| | DISCHARGE |

TABLE 32

| Returned Field | Value |
|---|---|
| Desired Column 1 e.g | Value in the target table for the desired grouping |
| MV_Patient_Id | |
| Desired Column 2 e.g. | Value in the target table for the desired grouping |
| FromDate | |
| VALUE | The resulting value calculated by the operation |
| | which is the sum of days supply for all |
| | claims in the input set. |
| Units | |

TABLE 33

| Parameter Field Label | Usage |
|---|---|
| Rule Description | Use this field to comment the measure and describe the intended |
| | use of the results set within the measure. |
| Audit | Set AUDIT to YES if this event should be audited. |
| Operator | The Operator provides a way to filter on the results set. Essentially |
| | the rule finds and sums all the days supply but the results set only |
| | includes those patients which meet any required criteria as |
| | specified by the Operator and the Value. |
| | The Operators provided are |
| | EQ—Equal To |
| | GT—Greater Than |
| | GTE—Greater Than or Equal To |
| | LT—Less Than |
| | LTE—Less Than or Equal To |
| | BETWEEN |
| | BETWEEN_EXCLUSIVE |
| | Note that BETWEEN and BETWEEN_EXCLUSIVE are not valid |
| | options for this rule. |
| Value | The Value determines the filter or criteria for the results set. |
| | If the Operator is set to GTE and the Value is set to 1 then all the |
| | patients will be included in the results set together with a count of |
| | total prescriptions. |
| | If the Operator is set to GTE and the Value is set to 2 then only |
| | patients with at least 2 prescriptions will be included in the results |
| | set. |
| Reference Table | This is the input set or target set for the rule. The target set must |
| | be a set of prescription claims created using a service table criteria |
| | and the target claims must be prescription claims. |
| Value Units | This field is ignored. The rule is counting rows and is not looking at |
| | any quantity or value field |

TABLE 34

| Returned Field | Value |
|---|---|
| MV_PATIENT_ID | MV generated id for the patient |
| COT | Generated ID for the course of treatment - |
| | 0 if measure is not a course of |
| | treatment measure |
| VALUE | The resulting value calculated by the |
| | operation which is the count of all |
| | prescription claims in the input set. |
| UNITS | |

TABLE 35

| Parameter Field Label | Usage |
|---|---|
| Rule Description | Use this field to comment the measure and describe the intended |
| | use of the results set within the measure. |
| Audit | Set AUDIT to YES if this event should be audited. |
| Operator | The Operator provides a way to filter on the results set. Essentially |
| | the rule finds and sums all the days supply but the results set only |
| | includes those patients which meet any required criteria as |
| | specified by the Operator and the Value. |
| | The Operators provided are |
| | EQ—Equal To |
| | GT—Greater Than |
| | GTE—Greater Than or Equal To |
| | LT—Less Than |
| | LTE—Less Than or Equal To |
| | BETWEEN |
| | BETWEEN_EXCLUSIVE |
| | Note that BETWEEN and BETWEEN_EXCLUSIVE are not valid |
| | options for this rule. |
| Value | The Value determines the filter or criteria for the results set. |
| | If the Operator is set to GTE and the Value is set to 1 then all the |
| | patients will be included in the results set together with a sum of |
| | total days supply. |
| | If the Operator is set to GTE and the Value is set to 90 then only |
| | patients with a total days supply greater than or equal to 90 days |
| | will be included in the results set. |
| Reference Table | This is the input set or target set for the rule. The target set must |
| | be a set of prescription claims created using a service table criteria |
| | and the target claims must be prescription claims. |
| Value Units | This field is ignored. Days Supply is assumed to be the value unit. |

TABLE 36

| Returned Field | Value |
|---|---|
| MV_PATIENT_ID | MV generated id for the patient |
| COT | Generated ID for the course of treatment - |
| | 0 if measure is not a course of |
| | treatment measure |
| VALUE | The resulting value calculated by the |
| | operation which is the sum of days |
| | supply for all claims in the input set. |
| UNITS | Days Supply is always the Unit returned |
| | for Prescription Quantity. |

TABLE 37

| Parameter Field Label | Usage |
|---|---|
| Rule Description | Use this field to comment the measure and describe the intended use of the results |
| | set within the measure. |
| Audit | Set AUDIT to YES if this event should be audited. |
| Look To Set | This is the top set or first set. If only one set is to be specified as the target set then |
| | use this field. |
| | For example - to calculate the number of ‘dispensing events’ based on prescriptions |
| | for drugs you would: |
| | 1. Create the Rx set(s) - find all prescriptions for the specified drugs |
| | 2. Use Prescription Quantity rule to create a new results set - RxQty - with a |
| | sum value for days supply. |
| | 3. Use the RxQty set as the Look To Set or top set for the event. |
| | 4. Use the divide operator and a value of 30 to divide the RxQty value by 30 |
| | and return a count of dispensed events. This results set is the |
| | RxDispensedEvents set. |
| Look From Set | This is the denominator set or bottom set. This set is used if two sets are being |
| | combined. |
| | For example, you can add the count of RxDispensedEvents to a count of inhaler |
| | prescription events. |
| Operator | There are four operators: |
| | PLUS - is used to add counts from two input target sets |
| | MINUS - Top set or Look To set count minus the bottom set or Look |
| | From Set count |
| | MULTIPLY - used to operate on a single input set and requires a VALUE |
| | DIVIDE - used to operate on a single input set and requires a VALUE |
| Value | If a single target set is chosen, this parameter is the value to be applied to the |
| | multiple or divide operators. |
| | For example, to calculate the number of dispensed Rx events as multiples of 30 |
| | days supply, you would use the DIVIDE operator on the target set and specify a |
| | VALUE of 30 as the divisor. The result count is the number of dispensed events. |
| | If two target sets are specified this parameter must be null |

TABLE 38

| Returned Field | Value |
|---|---|
| MV_PATIENT_ID | MV generated id for the patient |
| COT | Generated ID for the course of treatment - null if |
| | measure is not a course of treatment measure |
| VALUE | The resulting value calculated by the operation. |

TABLE 38A

| Parameter Field Label | Usage |
|---|---|
| Rule Description | Use this field to comment the measure and describe the intended use of the results |
| | set within the measure. |
| Audit | Set AUDIT to YES if this event should be audited. |
| Operator | The Operator provides a way to filter on the results set. Essentially the rule finds |
| | and sums all the days supply but the results set only includes those patients which |
| | meet any required criteria as specified by the Operator and the Value. |
| | The Operators provided are |
| | EQ - Equal To |
| | GT - Greater Than |
| | GTE - Greater Than or Equal To |
| | LT - Less Than |
| | LTE - Less Than or Equal To |
| | BETWEEN |
| | BETWEEN_EXCLUSIVE |
| | Note that BETWEEN_EXCLUSIVE is not a valid option for this rule. |
| Value | The Value determines the filter or criteria for the results set. |
| Max Value | If BETWEEN is used as the operator then Max Value is the parameter for the upper |
| | end of the target range. |
| Reference Table | This is the input set or target set for the rule. The input set can be any type of set |
| | that supports the designated grouping to count the rows. |
| Begin Day Offset | Use this field to specify an offset from the measure period of the parent set. This |
| | field assumes a value unit of Days. A positive value sets the measure period |
| | forward in time from the parent set measure period. A negative value sets the |
| | measure period backward in time from the parent set measure period. |
| End Day Offset | If a Begin Day Offset is specified than an End Day Offset will nearly always need to |
| | be specified. The End Day Offset is the offset for the end of the measure period - |
| | from the beginning of the measure period. (Note: NOT an offset from the end of the |
| | measure period.) |
| Group by Column 1 | The default grouping for the counting is the patient. The possible groupings also |
| | include providers in order to count events by distinct providers and also dates in |
| | order to count events by distinct dates. |
| | PATIENT ID |
| | COT |
| | PROVIDER ID |
| | MGMTPROVIDER ID |
| | PRESPROVIDER ID |
| | FROM DATE |
| | THRU DATE |
| | ADMIT |
| | DISCHARGE |
| Group by Column 2 | The possible groupings also include providers in order to count events by distinct |
| | providers and also dates in order to count events by distinct dates. |
| | PATIENT ID |
| | COT |
| | PROVIDER ID |
| | MGMTPROVIDER ID |
| | PRESPROVIDER ID |
| | FROM DATE |
| | THRU DATE |
| | ADMIT |
| | DISCHARGE |

TABLE 39

| Returned Field | Value |
|---|---|
| Desired Column 1 e.g | Value in the target table for the desired grouping |
| MV_Patient_Id | |
| Desired Column 2 e.g. | Value in the target table for the desired grouping |
| FromDate | |
| VALUE | The resulting value calculated by the operation |
| | which is the sum of values for all rows in the |
| | target grouping in the input set. |
| Units | |

TABLE 40

| Parameter Field Label | Usage |
|---|---|
| Rule Description | Use this field to comment the measure and describe the intended use of the results |
| | set within the measure. |
| Audit | Set AUDIT to YES if this event should be audited. |
| Operator | The Operator provides a way to filter on the results set. Essentially the rule finds |
| | and sums all the days supply but the results set only includes those patients which |
| | meet any required criteria as specified by the Operator and the Value. |
| | The Operators provided are |
| | EQ - Equal To |
| | GT - Greater Than |
| | GTE - Greater Than or Equal To |
| | LT - Less Than |
| | LTE - Less Than or Equal To |
| | BETWEEN |
| | BETWEEN_EXCLUSIVE |
| | Note that BETWEEN or BETWEEN_EXCLUSIVE are the only legal for this rule as it |
| | is going to calculate the treatment days between the denominator anchor event and |
| | a specified time window. |
| Value | The Value determines the boundary for calculating the treatment days. |
| Value Unit | The Value Unit describes the unit. |
| | Options are Days or Months. |
| | If months are selected, months are converted to 30 days unless 12 months is |
| | chosen in which case it is converted to 365 days. |
| Reference Table | This is the input set or target set for the rule. This is the set of Rx claims |
| Numerator Date Column | Use this field to specify the relevant date column in the Reference Table set. For Rx |
| | Claims this is the From Date |
| Denominator Date Column | Use this field to specify the relevant date column in the Denominator Table set. This |
| | date is the index event or anchor event for which the treatment days are being |
| | calculated. |
| Denom Table | This is the table that contains the anchor events or index events. The anchor event |
| | is either the episode index event such as an encounter with diagnosis or an index |
| | prescription event. |
| Denominator Date Column | This specifies the exact event in the denominator set to create the calculations for. |
| Anchor | The options are |
| | EARLIER |
| | LATER |
| | ANY |
| | If Earlier is selected then treatment days are only calculated for the first event in the |
| | denominator set. If Later is selected then treatment days are only calculated for the |
| | last event in the denominator set. If Any is selected then the treatment days are |
| | calculated for each event in the denominator set. |
| Return From Set | The treatment days are calculated and stored in the Value column of the Rx claims. |
| | If Return From Set is selected (value of YES) then all the treatment days are |
| | summed and the sum is stored in the Value column of the denominator event. |
| | Most of the time the Return From Set is the desired option because the intent is to |
| | get a total value for the treatment days associated with the denominator event. |

TABLE 41

| Returned Field | Value |
|---|---|
| MV_CLAIM_ID | MV generated id for the claim. |
| CLAIMNO | Client claim number |
| CLAIMLINENO | Client claim line number |
| MV_PATIENT_ID | MV generated id for the patient |
| AGE | Patient age on the claim - calculated |
| | based on DOB in enrollment |
| SEX | Patient sex on the claim. |
| MV_PROVIDER_ID | MV generated id for the provider who |
| | is delivering the service |
| MV_MGMTPROVIDER_ID | MV generated id for the management |
| | provider - the provider who ordered the |
| | service. |
| MV_PRESPROVIDER_ID | MV generated id for the prescribing |
| | provider - only populated if the claim is an |
| | Rx claim. |
| FROMDATE | Date of service - from date or start date |
| THRUDATE | Date of service - thru date or end date |
| PATIENT_DOB | Patient date of birth from the member |
| | enrollment table. |
| ADMITFROMDATE | Admit date |
| ADMITTHRUDATE | Discharge date |
| QUANTITY | Quantity from claim. |
| VALUE | Calculated Treatment Days Value |

TABLE 42

| Parameter Field | |
|---|---|
| Label | Usage |
| Rule Description | Use this field to comment the measure and describe the |
| | intended use of the results set within the measure. |
| Audit | Set AUDIT to YES if this event should be audited. |
| Operator | Valid operators for this rule are: |
| | EQ = Equal to the specified value |
| | GT - Greater than the specified value |
| | GTE - Greater than or equal to the specified value |
| | LT - Less than the specified value |
| | LTE - Less than or equal to the specified value |
| Value | This is the criterion value for the length of stay |
| Value Units | This is the units for the value of the length of stay and |
| | can be DAYS or MONTHS. |
| | Months are calculated as 30 days unless 12 months or |
| | a multiplier of 12 months is specified in which case |
| | each 12 months is counted as 365 days. |
| Reference Table | This parameter is a text entry field for the name of the |
| | input or target set |

TABLE 43

| Parameter Field Label | Usage |
|---|---|
| Rule Description | Use this field to comment the measure and describe the intended |
| | use of the results set within the measure. |
| Audit | Set AUDIT to YES if this event should be audited. |
| Target Results Set | The is the reference set or target set containing the claims of |
| | interest that are to be divided into the separate courses of |
| | treatment. This could be set of events for a specific diagnosis or |
| | could be the set of discharge events for inpatient stays. |
| COT Clean Period (days): | This is the value - in days - for the clean window that defines the |
| | end of one course of treatment and the beginning of the next. For |
| | example, in a diagnosis based course of treatment the measure |
| | might require 90 days to qualify a diagnosis as a New diagnosis or |
| | new course of treatment. In another measure a 30 day window |
| | between discharge dates identifies the discharge as a separate |
| | discharge. |
| Denominator Date | This is the date column to be used to compare the time span |
| Column | between events to qualify for the clean window. The date choices |
| | are |
| | FROM DATE |
| | THRU DATE |
| | ADMIT |
| | DISCHARGE |
| | BIRTHDATE |
| | ADMIT or FROM DATE |
| | DISCHARGE OR THRU DATE |
| | The From Date is the date to use for diagnosis based course of |
| | treatment measures. The Discharge or Thrudate would be the |
| | date to use to identify distinct discharge events. |

TABLE 44

| Returned Field | Value |
|---|---|
| MV_CLAIM_ID | MV generated id for the claim. |
| CLAIMNO | Client claim number |
| CLAIMLINENO | Client claim line number |
| MV_PATIENT_ID | generated id for the patient |
| AGE | Patient age on the claim - calculated based on DOB in enrollment |
| SEX | Patient sex on the claim. |
| MV_PROVIDER_ID | MV generated id for the provider who is delivering the service |
| MV_MGMTPROVIDER_ID | MV generated id for the management provider - the provider who ordered the |
| | service. |
| MV_PRESPROVIDER_ID | MV generated id for the prescribing provider - only populated if the claim is an Rx |
| | claim. |
| FROMDATE | Date of service - from date or start date |
| THRUDATE | Date of service - thru date or end date |
| PATIENT_DOB | Patient date of birth from the member enrollment table. |
| ADMITFROMDATE | Admit date |
| ADMITTHRUDATE | Discharge date |
| QUANTITY | Quantity from claim. |
| COTID | 0 if measure is not a COT Event but contains a COT Id for CDT events. The |
| | Patient Id and COT Id combination uniquely identify the episode to be measured. |
| COTEvt flag | Flag to identify the first event in a course of treatment |
| VALUE | Gap count or Count of days between events. |

TABLE 45

| Parameter Field | |
|---|---|
| Label | Usage |
| Rule Description | Use this field to comment the measure and describe the |
| | intended use of the results set within the measure. |
| Audit | Set AUDIT to YES if this event should be audited. |
| Target COT Set | The is the name of the previously created COT set |
| | where all the events have been tagged with the COT |
| | Id. |

TABLE 46

| Parameter Field | |
|---|---|
| Label | Usage |
| Rule Description | Use this field to comment the measure and |
| | describe the intended use of the results set within the |
| | measure. |
| Audit | Set AUDIT to YES if this event should be audited. |
| Target Set | The is the name of the previously created COT set |
| | where all the events have been tagged with the |
| | COT Id. |
| Denominator Date | This is the date column to be used to compare the |
| Column | events in order to find the most recent. The date |
| | choices are |
| | FROM DATE |
| | THRU DATE |
| | ADMIT |
| | DISCHARGE |
| | BIRTHDATE |
| | ADMIT or FROM DATE |
| | DISCHARGE OR THRU DATE |

TABLE 47

| Returned Field | Value |
|---|---|
| MV_PATIENT_ID | MV generated id for the patient |
| PATIENT_DOB | Birthdate of patient - used to calculate a birthday |
| AGE | Age of the patient as of the |
| SEX | Sex |

TABLE 48

| Parameter Field Label | Usage |
|---|---|
| Anchor From | Continuous enrollment is always calculated from some anchor date. |
| | SELECT_SET - Use this option to indicate that the selected anchor event is one or more sets already |
| | created in the denominator |
| | GLOBAL_MEASUREMENTPERIOD_END - Use this option to test continuous enrollment from the end of |
| | the measurement year. This is needed in demographic type measures where there is no defining event or |
| | claim to anchor from. |
| | DENOMINATOR_MEASUREMENTPERIOD_END - Use this option to test continuous enrollment from the |
| | end of the denominator intake period. This is sometimes the required anchor point in HEDIS measures. |
| Service Sets | Use this field to type in the names of the set or sets to use as the source input set for the anchor event. |
| | Separate sets by commas. |
| Within Set | This parameter specifies the target candidate event within the specified set. |
| | FIRST EVENT - specifies that the event(s) which occur on the earliest day for a patient (or patient/cot)are |
| | the events to be tested for continuous enrollment |
| | LAST EVENT - specifies that the event(s) which occur on the latest date for a patient (or patient/cot) are |
| | the events to be tested for continuous enrollment |
| | ANY EVENT - specifies that all events for a patient (or patient/COT) are to be tested |
| Between Set | This parameter specifies which event is the target event if there are multiple sets specified. The target |
| | candidate events are first selected within set and then the Between Set option is used to select between |
| | those candidate events. |
| | FIRST EVENT - specifies that the event(s) which occur on the earlier date for a patient (or patient/cot) in |
| | either set is the event to be tested for continuous enrollment |
| | LAST EVENT - specifies that the event(s) which occur on thelater date for a patient (or patient/cot) in |
| | either set is the event to be tested for continuous enrollment |
| | ANY EVENT - specifies that all events for a patient (or patient/COT) in all sets are to be tested |
| | To specify the earliest date at which two things are true for example two different diagnoses you would |
| | specify WITHIN SET first event and BETWEEN sets LAST event |
| Use Date | The Use Date parameter is used to specify which date field to use from the claim. The default date used is |
| | the FromDate field. Other potential dates could be the Admit Date, Discharge Date or the patient's |
| | Birthdate. |
| | Birthdate is a special case for continuous enrollment. In this case the Birthdate is actually the Anchor |
| | Event. Since Birthdate does not appear on the Claim, another qualifying event is first used to identify the |
| | patients who would have had the required Birthday during the measurement period and then Birthdate of |
| | those patients is looked up using the enrollment data. |
| Audit | |
| Enrolled Before For | To specify the required enrollment period before the selected anchor claim. This is often needed to allow |
| | for Exclusions, |
| | Enrolled Before For: [Value e.g 12] [DAYS, MONTHS] |
| | If months are selected these are converted to days using 30 days a month unless 12 months is specified in |
| | which case it is converted to 365 days. 24 months is converted to 730 days. |
| Enrolled After For | To specify the required enrollment period after the selected anchor claim. This is often needed to look for |
| | required Numerator service after the qualifying Denominator event. |
| | Enrolled After For: [Value e.g 12] [DAYS, MONTHS] |
| | If months are selected these are converted to days using 30 days a month unless 12 months is specified in |
| | which case it is converted to 365 days. 24 months is converted to 730 days. |
| Gap Allowed | There are three types of Gap Calculation: |
| | No Gaps means that no gap is allowed any time - strict enrollment is enforced no matter what |
| | the continuous enrollment period. No gap calculation is done if this is selected. |
| | In Each One Year Span means that the gap is calculated based on each complete 365 days of |
| | enrollment. |
| | If enrollment period is >365 days then no gap calculation is done. |
| | If enrollment is 365 days or more e.g. 14 months then gap calculation is done to |
| | count gaps and days unenrolled. One gap is allowed for each complete year span |
| | of 365 days. |
| | If enrollment is 24 months or 730 days then gap allowance is 2x the one year gap |
| | allowance |
| | In Enrollment Period means the gap allowance is for the enrollment period, no matter how |
| | short or long. This is needed to allow a gap in 365 days or less |
| | HEDIS allows for a single gap in each complete ‘calendar’ measurement year. The In Each One Year |
| | Span method allows for a HEDIS type specification. HEDIS considers that the enrollment period is divided |
| | up into separate measurement year periods. A gap in enrollment that extends over multiple years of a |
| | continuous enrollment period may exceed 45 days. For example, in the Breast Cancer Screening measure |
| | (which requires 2 years of continuous enrollment), a member who disenrolls November 30 of the year prior |
| | to the measurement year and who reenrolls February 1 of the measurement year is considered |
| | continuously enrolled as long as there are no other gaps in enrollment during either year. The member is |
| | considered to have one gap of 31 days (December 1-31) in the year prior to the measurement year and |
| | one gap of 31 days (January 1-31) in the measurement year. |
| | In Each One Year Span divides the enrollment period up into the one year blocks and calculates gaps per |
| | year as in the HEDIS example. A continuous 60 day gap with 30 days in each calendar year will be |
| | counted as 2 gaps of 30 days. But if In Enrollment Period is selected then the gap will be counted as a |
| | single 60 day gap and subject to Maximum Gap Size rules. |
| # of Gaps | Essentially there is an implicit attribute of Gap allowed versus No Gap Allowed (or strict enrollment). This |
| | parameter both specifies if a gap is allowed and lets one enter the number of gaps allowable. The 0 value |
| | is No Gaps allowed. |
| | Default Value is 0 - this is strict enrollment. |
| | Numerical value for gaps can be: |
| | 0 strict enrollment, no gaps allowed |
| | 1 (most common case where only a single gap is allowed) |
| | 2 (occurs where continuous enrollment is over multiple enrollment years) |
| | 3 (in a 3 year measurement period it might be possible) |
| Maximum Gap Size | If a gap is allowed, then one must set a value for the gap allowed. |
| | A 45-day gap is the most common but the Medicaid HEDIS value specifies 1 month. Medicaid enrollment |
| | is calendar month by calendar month. |
| | Maximum Gap Size: [Value e.g 1] [DAYS, MONTHS] |
| | If months are selected these are converted to days using 30 days a month unless 12 months is specified in |
| | which case it is converted to 365 days. 24 months is converted to 730 days |
| Single Continuous Period | Client A has stated the requirement to combine the Enrolled Before and Enrolled After time periods as a |
| | single continuous enrollment time span. Currently we compute them as two separate enrollment periods. |
| | Default is “NO” because this is the most strict application |
| | Specify logic to combine both previous and forward enrollment requirements and treat as one |
| | continuous requirement |
| | This logic will (1) move event date back PreviousValue days and then (2) calculate forward |
| | continuous enrollment for PreviousValue + Value days long |

TABLE 49

| Parameter Field | |
|---|---|
| Label | Usage |
| Rule Description | |
| Use provider from | This parameter provides for the selection of the |
| provider column | provider column to use on the designated target set. |
| | The available provider columns on a claim are |
| | ProviderId - the provider delivering the service |
| | MgmtProviderId - the management provider |
| | PresProviderId - the prescribing provider |
| Target Set | This parameter names the target or input set that |
| | contains the desired providers. This set should be a |
| | claim set. |

TABLE 50

| Parameter Field | |
|---|---|
| Label | Usage |
| Rule Description | |
| Use provider from | This parameter provides for the selection of the |
| provider column | provider column to use on the designated |
| | target set. |
| | The available provider columns on a claim are |
| | ProviderId - the provider delivering the service |
| | MgmtProviderId - the management provider |
| | PresProviderId - the prescribing provider |

TABLE 51

| Parameter Field | |
|---|---|
| Label | Usage |
| Rule Description | Use this field to comment the purpose of the rule in the |
| | measure |
| Attribute Condition | This parameter describes the set of providers to return from |
| | the global encounter services table. |
| | ANY_PROVIDER_SEEN - brings back all providers who saw |
| | the patient who qualified for the measure |
| | ONE_PROVIDER_PER_SPECIALTY_SEEN - returns one |
| | provider per specialty seen. Further parameters describe how |
| | to select the provider |
| | RESPONSIBLE_PROVIDER_SEEN - returns a single |
| | provider selected based on parameters defined below |
| Select Providers First | Select Frequency or Recency to determine how to select |
| On | providers |
| Select Providers | In the event of a tie on the first selection criteria, select |
| Second ON | frequency or recency to determine how to select among |
| | providers |
| Look From Set | |

TABLE 52

| Parameter Field | |
|---|---|
| Label | Usage |
| Rule Description | Use this field to comment the purpose of the rule in the |
| | measure |
| Value | Numerical values for the desired specialties - see |
| | Appendix 1 |
| Target Set | The name of the set containing the list of providers to |
| | be filtered be specialty |

We claim:

1. A rules based software user interface application and environment, comprising:
a clinical quality measure library database schema,
a clinical quality measure specification database schema,
a rules library,
a clinical quality configuration module,
a cost of care configuration module,
a clinical business rule (CBR) editor,
a key performance indicator (KPI) editor; and
a manager module.

2. The rules based software user interface application and environment of claim 1, wherein the application further comprises a measure testing module.

3. The rules based software user interface application and environment of claim 1, wherein the clinical quality measure library is pre-populated with clinical quality measure data.

4. The rules based software user interface application and environment of claim 1, wherein the clinical quality measure library comprises a plurality of attributes that describe the clinical logic of a measure, a plurality of attributes that classify a measure, a plurality of service code tables that define a set of clinical criteria for a measure, or a combination thereof.

5. The rules based software user interface application and environment of claim 1, wherein the measure specification database scheme stores a definition of each measure as a parameter value for a selected rule.

6. The rules based software user interface application and environment of claim 1, wherein the rules library comprises a plurality of measure rules.

7. The rules based software user interface application and environment of claim 6, wherein each of the rules in the plurality of rules comprises a procedure.

8. The rules based software user interface application and environment of claim 1, wherein the clinical quality configuration module is utilized to view and edit at least one parameter for a clinical quality index.

9. The rules based software user interface application and environment of claim 1, wherein the cost of care configuration module is utilized to view and edit at least one parameter for a cost of care index.

10. The rules based software user interface application and environment of claim 9, wherein the cost of care configuration module is further utilized to view and edit at least one cost of care measure.

11. The rules based software user interface application and environment of claim 1, wherein the clinical business rule editor is used to view, edit, create or a combination thereof at least one clinical quality measure description.

12. The rules based software user interface application and environment of claim 11, wherein the at least one clinical quality measure description are consolidated into the clinical quality measure library database schema.

13. The rules based software user interface application and environment of claim 1, wherein the key performance indicator editor is used to view, edit, create or a combination thereof at least one clinical quality measure specification.

14. The rules based software user interface application and environment of claim 13, wherein the at least one clinical quality measure specification are consolidated into the clinical quality measure specification database schema.

15. The rules based software user interface application and environment of claim 1, wherein the manager module performs a plurality of functions.

16. The rules based software user interface application and environment of claim 15, wherein the plurality of functions comprises selecting at least one measure to run, selecting at least one target source data set for the measure, specifying at least one global parameter or a combination thereof.

17. The rules based software user interface application and environment of claim 1, wherein the application further comprises a measure rules engine.

18. The rules based software user interface application and environment of claim 17, wherein the measure rules engine comprises a set of executable software for a set of care measures.

19. The rules based software user interface application and environment of claim 18, wherein the set of care measures comprises quality of care measures, care of cost measures or combinations thereof.

20. The rules based software user interface application and environment of claim 1, further comprising a component or module for delivery of clinical measure libraries as a web or Internet application.

21. The rules based software user interface application and environment of claim 1, further comprising an audit detail component.

22. The rules based software user interface application and environment of claim 1, further comprising both a component for delivery of clinical measure libraries as a web or Internet application and an audit detail component.

23. A method of converting health-based input source data into clinical business rules documents, comprising:
providing a source code application,
providing a collection of source data that comprises health-related source data; and
transforming the source data into at least one evidence-based care measure using the source code.

24. The method of claim 23, wherein care measures comprise quality of care measures, care of cost measures or combinations thereof.
